(19) United States
(12) Patent Application Publication
(10) Pub. No.: US 2025/0220391 A1
(43) Pub. Date: Jul. 3, 2025

(54) SYSTEMS AND METHODS FOR TIME SYNCHRONIZATION OF SENSING MEASUREMENTS MADE OUT OF BSS

(71) Applicant: COGNITIVE SYSTEMS CORP., Waterloo (CA)

(72) Inventors: Chris BEG, Waterloo, Ontario (CA); Mohammad OMER, Waterloo, Ontario (CA)

(21) Appl. No.: 18/850,417

(22) PCT Filed: Apr. 4, 2023
(86) PCT No.: PCT/IB2023/053436

§ 371 Date: Sep. 24, 2024

Related U.S. Application Data
(60) Provisional application No. 63/345,613, filed on May 25, 2022.
(60) Provisional application No. 63/330,937, filed on Apr. 14, 2022.

(51) Int. Cl. H04W 4/029; G01S 7/00; G01S 13/86; H04W 56/00; H04W 84/12

(52) U.S. Cl. CPC H04W 4/029; G01S 7/006; G01S 13/86; H04W 56/001; H04W 84/12

(57) ABSTRACT

Systems and methods for Wi-Fi sensing is provided. A networking device configured to operate as a sensing receiver and including at least one processor may operate as a system to carry out the Wi-Fi sensing method. The sensing receiver may obtain timing information from an unassociated access point not associated with the sensing receiver and operating as a sensing transmitter. The sensing receiver may generate local timing information according to the timing information. The sensing receiver may receive a sensing transmission from the unassociated access point. The sensing receiver may perform a sensing measurement on the sensing transmission and may associated the sensing measurement with a timestamp based on the local timing information. The sensing receiver may transmit the sensing measurement and the timestamp to the unassociated access point.

### TECHNICAL FIELD

The present disclosure generally relates to systems and methods for Wi-Fi sensing. In particular, the present disclosure relates to systems and methods for time synchronization of sensing measurements made out of basic service set (OBSS).

### BACKGROUND OF THE DISCLOSURE

A Wi-Fi sensing system may be configured to detect features of interest in a sensing space. The Wi-Fi sensing system may be a network of Wi-Fi-enabled devices which are part of an IEEE 802.11 network (sometimes referred to as a basic service set (BSS) or extended service set (ESS)). The features of interest may include motion of objects and motion tracking, presence detection, intrusion detection, gesture recognition, fall detection, breathing rate detection, and other applications. The sensing space may refer to any physical space in which a Wi-Fi sensing system may operate and may include a place of abode, a place of work, a shopping mall, a sports hall or sports stadium, a garden, or any other physical space.

### BRIEF SUMMARY OF THE DISCLOSURE

The present disclosure generally relates to systems and methods for Wi-Fi sensing. In particular, the present disclosure relates to systems and methods for time synchronization of sensing measurements made out of basic service set (OBSS).

Systems and methods are provided for Wi-Fi sensing. In an example embodiment, a method for Wi-Fi sensing is described. The method is carried out by a networking device configured to operate as a sensing receiver. The networking device operating as a sensing receiver includes at least one processor configured to execute instructions. The method includes obtaining, by the sensing receiver, timing information from an unassociated access point not associated with the sensing receiver and operating as a sensing transmitter. In some embodiments, the method further includes generating, by the sensing receiver, local timing information according to the timing information and receiving, by the sensing receiver, a sensing transmission from the unassociated access point. In some embodiments, the method further includes performing, by the sensing receiver, a sensing measurement on the sensing transmission, and associating, by the sensing receiver, the sensing measurement with a timestamp based on the local timing information. In some embodiments, the method further includes transmitting, by the sensing receiver, the sensing measurement and the timestamp to the unassociated access point.

In some embodiments, the timing information is an access point timing synchronization function (TSF) timer of the unassociated access point.

In some embodiments, the timing information is stored as the local timing information.

In some embodiments, the local timing information is a timer offset value determined according to a difference between the timing information and a sensing receiver TSF timer and the timestamp is determined by combining the sensing receiver TSF timer value with the timer offset value.

In some embodiments, the unassociated access point is a first unassociated access point.

In some embodiments, the method further includes obtaining, by the sensing receiver, additional timing information from a plurality of additional unassociated access points, and generating, by the sensing receiver, additional local timing information according to the additional timing information.

In some embodiments, the timing information is received in a beacon frame broadcast by the unassociated access point.

In some embodiments, receiving the sensing transmission further includes tuning the sensing receiver to a channel on which the beacon frame was received.

In some embodiments, the sensing receiver is associated with an associated access point operating on the same channel on which the beacon frame was received from the unassociated access point.

In some embodiments, the method further includes transmitting an idle message to the associated access point.

In some embodiments, the method further includes transmitting, by the sensing receiver, a probe request, and receiving, by the sensing receiver, a probe response containing the timing information responsive to the probe request.

In some embodiments, the probe request includes at least one access point identification and the probe response includes at least one response from an access point associated with the at least one access point identification.

In some embodiments, the probe request includes an access point identification wildcard and the probe response includes at least one response from an access point.

In some embodiments, the local timing information is maintained and incremented at the sensing receiver.

In some embodiments, the local timing information is incremented at the sensing receiver according to a local clock.

In some embodiments, prior to receiving the sensing transmission, the sensing receiver initiates a pre-association security negotiation (PASN) procedure with the sensing transmitter.

In some embodiments, the sensing receiver transmits the sensing measurement in response to receiving a sensing report trigger.

In some embodiments, the method further includes resynchronizing the local timing information through receipt of second timing information from the unassociated access point.

In some embodiments, resynchronizing the local timing information is performed after expiration of a resynchronization timer.

In some embodiments, a time interval of the resynchronization timer is determined according to a measurement of timing drift between the unassociated access point and the sensing receiver.

Other aspects and advantages of the disclosure will become apparent from the following detailed description, taken in conjunction with the accompanying drawings, which illustrate by way of example, the principles of the disclosure.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a diagram showing an example wireless communication system;

FIG. 2A and FIG. 2B are diagrams showing example wireless signals communicated between wireless communication devices;

FIG. 3A and FIG. 3B are plots showing examples of channel responses computed from the wireless signals communicated between wireless communication devices in FIG. 2A and FIG. 2B;

FIG. 4A and FIG. 4B are diagrams showing example channel responses associated with motion of an object in distinct regions of a space;

FIG. 4C and FIG. 4D are plots showing the example channel responses of FIG. 4A and FIG. 4B overlaid on an example channel response associated with no motion occurring in the space;

FIG. 5 depicts some of an architecture of an implementation of a system for Wi-Fi sensing, according to some embodiments;

FIG. 6 depicts an example representation of a typical Wi-Fi sensing system, according to some embodiments;

FIG. 7 depicts a process for pre-association security negotiation (PASN) authentication, according to some embodiments;

FIG. 8 depicts an example of a timing synchronization function (TSF) timer unsynchronized situation, according to some embodiments;

FIG. 9 depicts an example of communications between a station, an associated access point, and unassociated access point, according to some embodiments;

FIG. 10A and FIG. 10B depict a trigger based measurement instance of a Wi-Fi sensing procedure, according to some embodiments;

FIG. 11 depicts an example of a trigger based sensing measurement exchange, according to some embodiments;

FIG. 12 depicts a format of a sensing measurement report frame, according to some embodiments;

FIG. 13 depicts SENS NDPA STA info field showing a partial TSF, according to some embodiments;

FIG. 14 depicts an example of SENS NDPA STA info field with a partial TSF in a sensing measurement exchange, according to some embodiments;

FIG. 15 depicts an example of a trigger based sensing measurement exchange, according to some embodiments;

FIG. 16 depicts an example of full TSF timer synchronization using partial TSF fields, according to some embodiments;

FIG. 17 depicts a flowchart for transmitting, by a sensing receiver, a sensing measurement and a timestamp to an unassociated access point, according to some embodiments;

FIG. 18A and FIG. 18B depict a flowchart for resynchronizing local timing information through receipt of second timing information from an unassociated access point, according to some embodiments; and

FIG. 19A and FIG. 19B depict another flowchart for transmitting, by a sensing receiver, a sensing measurement and a timestamp to an unassociated access point, according to some embodiments.

### DETAILED DESCRIPTION

In some aspects of what is described herein, a wireless sensing system may be used for a variety of wireless sensing applications by processing wireless signals (e.g., radio frequency (RF) signals) transmitted through a space between wireless communication devices. Example wireless sensing applications include motion detection, which can include the following: detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications. Other examples of wireless sensing applications include object recognition, speaking recognition, keystroke detection and recognition, tamper detection, touch detection, attack detection, user authentication, driver fatigue detection, traffic monitoring, smoking detection, school violence detection, human counting, human recognition, bike localization, human queue estimation, Wi-Fi imaging, and other types of wireless sensing applications. For instance, the wireless sensing system may operate as a motion detection system to detect the existence and location of motion based on Wi-Fi signals or other types of wireless signals. As described in more detail below, a wireless sensing system may be configured to control measurement rates, wireless connections, and device participation, for example, to improve system operation or to achieve other technical advantages. The system improvements and technical advantages achieved when the wireless sensing system is used for motion detection are also achieved in examples where the wireless sensing system is used for another type of wireless sensing application.

In some example wireless sensing systems, a wireless signal includes a component (e.g., a synchronization preamble in a Wi-Fi PHY frame, or another type of component) that wireless devices can use to estimate a channel response or other channel information, and the wireless sensing system can detect motion (or another characteristic depending on the wireless sensing application) by analyzing changes in the channel information collected over time. In some examples, a wireless sensing system can operate similar to a bistatic radar system, where a Wi-Fi access point (AP) assumes the receiver role, and each Wi-Fi device (station (STA), node, or peer) connected to the AP assumes the transmitter role. The wireless sensing system may trigger a connected device to generate a transmission and produce a channel response measurement at a receiver device. This triggering process can be repeated periodically to obtain a sequence of time variant measurements. A wireless sensing algorithm may then receive the generated time-series of channel response measurements (e.g., computed by Wi-Fi receivers) as input, and through a correlation or filtering process, may then make a determination (e.g., determine if there is motion or no motion within the environment represented by the channel response, for example, based on changes or patterns in the channel estimations). In examples where the wireless sensing system detects motion, it may also be possible to identify a location of the motion within the environment based on motion detection results among a number of wireless devices.

Accordingly, wireless signals received at each of the wireless communication devices in a wireless communication network may be analyzed to determine channel information for the various communication links (between respective pairs of wireless communication devices) in the network. The channel information may be representative of a physical medium that applies a transfer function to wireless signals that traverse a space. In some instances, the channel information includes a channel response. Channel responses can characterize a physical communication path, representing the combined effect of, for example, scattering, fading, and power decay within the space between the transmitter and receiver. In some instances, the channel information includes beamforming state information (e.g., a feedback matrix, a steering matrix, channel state information, etc.) provided by a beamforming system. Beamforming is a signal processing technique often used in multi-antenna (multiple-input/multiple-output (MIMO)) radio systems for directional signal transmission or reception. Beamforming can be achieved by operating elements in an antenna array in such a way that signals at some angles experience constructive interference while others experience destructive interference.

The channel information for each of the communication links may be analyzed (e.g., by a hub device or other device in a wireless communication network, or a sensing transmitter, sensing receiver, or sensing initiator communicably coupled to the network) to, for example, detect whether motion has occurred in the space, to determine a relative location of the detected motion, or both. In some aspects, the channel information for each of the communication links may be analyzed to detect whether an object is present or absent, e.g., when no motion is detected in the space.

In some cases, a wireless sensing system can control a node measurement rate. For instance, a Wi-Fi motion system may configure variable measurement rates (e.g., channel estimation/environment measurement/sampling rates) based on criteria given by a current wireless sensing application (e.g., motion detection). In some implementations, when no motion is present or detected for a period of time, for example, the wireless sensing system can reduce the rate that the environment is measured, such that the connected device will be triggered or caused to make sensing transmissions or sensing measurements less frequently. In some implementations, when motion is present, for example, the wireless sensing system can increase the triggering rate or sensing transmission rate or sensing measurement rate to produce a time-series of measurements with finer time resolution. Controlling the variable sensing measurement rate can allow energy conservation (through the device triggering), reduce processing (less data to correlate or filter), and improve resolution during specified times.

In some cases, a wireless sensing system can perform band steering or client steering of nodes throughout a wireless network, for example, in a Wi-Fi multi-AP or extended service set (ESS) topology, multiple coordinating wireless APs each provide a basic service set (BSS) which may occupy different frequency bands and allow devices to transparently move between from one participating AP to another (e.g., mesh). For instance, within a home mesh network, Wi-Fi devices can connect to any of the APs, but typically select one with good signal strength. The coverage footprint of the mesh APs typically overlap, often putting each device within communication range or more than one AP. If the AP supports multi-bands (e.g., 2.4 GHz and 5 GHz), the wireless sensing system may keep a device connected to the same physical AP but instruct it to use a different frequency band to obtain more diverse information to help improve the accuracy or results of the wireless sensing algorithm (e.g., motion detection algorithm). In some implementations, the wireless sensing system can change a device from being connected to one mesh AP to being connected to another mesh AP. Such device steering can be performed, for example, during wireless sensing (e.g., motion detection), based on criteria detected in a specific area to improve detection coverage, or to better localize motion within an area.

In some cases, beamforming may be performed between wireless communication devices based on some knowledge of the communication channel (e.g., through feedback properties generated by a receiver), which can be used to generate one or more steering properties (e.g., a steering matrix) that are applied by a transmitter device to shape the transmitted beam/signal in a particular direction or directions. Thus, changes to the steering or feedback properties used in the beamforming process indicate changes, which may be caused by moving objects, in the space accessed by the wireless communication system. For example, a motion may be detected by substantial changes in the communication channel, e.g., as indicated by a channel response, or steering or feedback properties, or any combination thereof, over a period of time.

In some implementations, for example, a steering matrix may be generated at a transmitter device (beamformer) based on a feedback matrix provided by a receiver device (beamformee) based on channel sounding. Because the steering and feedback matrices are related to propagation characteristics of the channel, these matrices change as objects move within the channel. Changes in the channel characteristics are accordingly reflected in these matrices, and by analyzing the matrices, motion can be detected, and different characteristics of the detected motion can be determined. In some implementations, a spatial map may be generated based on one or more beamforming matrices. The spatial map may indicate a general direction of an object in a space relative to a wireless communication device. In some cases, many beamforming matrices (e.g., feedback matrices or steering matrices) may be generated to represent a multitude of directions that an object may be located relative to a wireless communication device. These many beamforming matrices may be used to generate the spatial map. The spatial map may be used to detect the presence of motion in the space or to detect a location of the detected motion.

In some instances, a motion detection system can control a variable device measurement rate in a motion detection process. For example, a feedback control system for a multi-node wireless motion detection system may adaptively change the sample rate based on the environmental conditions. In some cases, such controls can improve operation of the motion detection system or provide other technical advantages. For example, the measurement rate may be controlled in a manner that optimizes or otherwise improves air-time usage versus detection ability suitable for a wide range of different environments and different motion detection applications. The measurement rate may be controlled in a manner that reduces redundant measurement data to be processed, thereby reducing processor load/power requirements. In some cases, the measurement rate is controlled in a manner that is adaptive, for instance, an adaptive sample can be controlled individually for each participating device. An adaptive sample rate can be used with a tuning control loop for different use cases, or device characteristics.

In some cases, a wireless sensing system can allow devices to dynamically indicate and communicate their wireless sensing capability or wireless sensing willingness to the wireless sensing system. For example, there may be times when a device does not want to be periodically interrupted or triggered to transmit a wireless signal that would allow the AP to produce a channel measurement. For instance, if a device is sleeping, frequently waking the device up to transmit or receive wireless sensing signals could consume resources (e.g., causing a cell phone battery to discharge faster). These and other events could make a device willing or not willing to participate in wireless sensing system operations. In some cases, a cell phone running on its battery may not want to participate, but when the cell phone is plugged into the charger, it may be willing to participate. Accordingly, if the cell phone is unplugged, it may indicate to the wireless sensing system to exclude the cell phone from participating; whereas if the cell phone is plugged in, it may indicate to the wireless sensing system to include the cell phone in wireless sensing system operations. In some cases, if a device is under load (e.g., a device streaming audio or video) or busy performing a primary function, the device may not want to participate; whereas when the same device's load is reduced and participating will not interfere with a primary function, the device may indicate to the wireless sensing system that it is willing to participate.

Example wireless sensing systems are described below in the context of motion detection (detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications). However, the operation, system improvements, and technical advantages achieved when the wireless sensing system is operating as a motion detection system are also applicable in examples where the wireless sensing system is used for another type of wireless sensing application.

In various embodiments of the disclosure, non-limiting definitions of one or more terms that will be used in the document are provided below.

A term “measurement campaign” may refer to a bi-directional series of one or more sensing transmissions between a sensing receiver and a sensing transmitter that allows a series of one or more sensing measurements to be computed.

A wireless access point (WAP) or simply an access point (AP) is a networking device in a WLAN network that allows other networking devices in a WLAN network to connect to a wired network. In examples, an AP creates a wireless local area network.

A station (STA) is any device that is connected to a WLAN network and which contains 802.11 compliant MAC and PHY interface to the wireless medium. A STA may be a laptop, desktop, smartphone, or a smart appliance. A STA may be fixed, mobile or portable. A STA that does not take on the roles of an AP may be referred to as a non-AP STA.

A term “transmission opportunity (TXOP)” may refer to a negotiated interval of time during which a particular quality of service (QOS) station (e.g., a STA, an AP, or either a STA or an AP, for example in the role of a sensing initiator, a sensing responder, a sensing transmitter or a sensing receiver) may have the right to initiate a frame exchange onto a wireless medium. A QOS access category (AC) of the transmission opportunity may be requested as part of a service or session negotiation.

A term “Quality of Service (QOS) access category (AC)” may refer to an identifier for a frame which classifies a priority of transmission that the frame requires. In an example, four QoS access categories are defined namely AC_VI: Video, AC_VO: Voice, AC_BE: Best-Effort, and AC_BK: Background. Further, each QoS access category may have different TXOP parameters defined for it.

A term “short interframe space (SIFS)” may refer to a period within which a processing element (for example, a microprocessor, dedicated hardware, or any such element) within a device of a Wi-Fi sensing system is able to process data presented to it in a frame. In an example, a short interframe space may be 10 μs.

A term “PHY-layer Protocol Data Unit (PPDU)” may refer to a data unit that includes preamble and data fields. The preamble field may include transmission vector format information and the data field may include payload and higher layer headers.

A term “null data PPDU (NDP)” may refer to a PPDU that does not include a data field. In an example, a null data PPDU may be used for a sensing transmission, where a MAC header of the NDP includes information required for a sensing receiver to make a sensing measurement on the sensing transmission.

A term “transmission parameters” may refer to a set of IEEE 802.11 PHY transmitter configuration parameters which are defined as a part of transmission vector (TXVECTOR) corresponding to a specific PHY and which may be configurable for each PHY-layer PPDU transmission or each null data PPDU (NDP) transmission.

A term “resource unit (RU)” may refer to an allocation of orthogonal frequency division multiplexing (OFDM) channels which may be used to carry a modulated signal. An RU may include a variable number of carriers depending on the mode of the modem.

A term “tone” may refer to an individual subcarrier in an OFDM signal. A tone may be represented in time domain or frequency domain. In time domain, a tone may also be referred to as a symbol. In frequency domain, a tone may also be referred to as a subcarrier.

A term “time domain pulse” may refer to a complex number that represents amplitude and phase of discretized energy in time domain. When frequency domain channel state information values are obtained for each tone from a baseband receiver, time domain pulses may be obtained by performing an IFFT on the channel state information values.

A term “sensing goal” may refer to a goal of a sensing activity at a time. A sensing goal is not static and may change at any time. In an example, a sensing goal may require sensing measurements of a specific type, a specific format, or a specific precision, resolution, or accuracy to be available to a sensing algorithm.

A term “sensing space” may refer to any physical space in which a Wi-Fi sensing system may operate.

A term “wireless local area network (WLAN) sensing session” or “Wi-Fi sensing session” may refer to a period during which objects in a physical space may be probed, detected and/or characterized. In an example, during a WLAN sensing session, several devices participate in, and thereby contribute to the generation of sensing measurements. A WLAN sensing session may be referred to as a “measurement campaign.”

A term “non-sensing message” may refer to a message which is not primarily related to sensing. In an example, non-sensing messages may include data, management, and control messages.

A term “sensing measurement” may refer to a measurement of a state of a wireless channel between a transmitter device (for example, a sensing transmitter) and a receiver device (for example, a sensing receiver) derived from a sensing transmission. In an example, sensing measurement may also be referred to as channel response measurement.

A term “sensing algorithm” may refer to a computational algorithm that achieves a sensing goal. A sensing algorithm may be executed on any device in a Wi-Fi sensing system.

Wireless network management (WNM) may provide information on network conditions and may also provide a means to obtain and exchange WLAN sensing information.

A sensing receiver is a station (STA) that receives sensing transmissions (for example, PPDUs or any other transmission including a data transmission which may be opportunistically used as a sensing transmission) sent by a sensing transmitter and performs sensing measurements as part of a WLAN sensing procedure. An AP is an example of a sensing receiver. In some examples, a STA may also be a sensing receiver.

A sensing transmitter is a station (STA) that transmits a sensing transmission (for example, PPDUs or any other transmission) used for sensing measurements (for example, channel state information) in a WLAN sensing procedure. In an example, a STA is an example of a sensing transmitter. In some examples, an AP may be a sensing transmitter for Wi-Fi sensing purposes, for example where a STA acts as a sensing receiver.

A sensing initiator is a station (STA) that initiates a WLAN sensing procedure. The role of sensing initiator may be taken on by a sensing receiver, a sensing transmitter, or a separate device which includes a sensing algorithm (for example, a remote processing device).

A sensing responder is a station (STA) that participates in a WLAN sensing procedure initiated by a sensing initiator. The role of sensing responder may be taken on by a sensing receiver or a sensing transmitter. In examples, multiple sensing responders may take part in a Wi-Fi sensing session.

A sensing by proxy (SBP) initiator is defined as a non-AP STA acting as a sensing initiator that transmits a SBP Request frame. In examples, sensing by proxy (SBP) enables a non-AP STA to obtain sensing measurements of the channel between an AP and one or more non-AP STAs or between a receive antenna and a transmit antenna of an AP. With the execution of the SBP procedure, it is possible for a non-AP STA to obtain sensing measurements necessary for detecting and tracking changes in the environment. A sensing by proxy (SBP) responder is an AP that receives or is the intended recipient of an SBP Request frame.

A term “sensing transmission” may refer to any transmission made from a sensing transmitter to a sensing receiver that may be used to make a sensing measurement. In an example, sensing transmission may also be referred to as wireless sensing signal or wireless signal.

A term “sensing trigger message” may refer to a message sent from a sensing initiator to a sensing transmitter to initiate or trigger one or more sensing transmissions.

A term “sensing response message” may refer to a message which is included within a sensing transmission from a sensing transmitter to a sensing receiver. A sensing transmission that includes a sensing response message may be used by a sensing receiver to perform a sensing measurement.

A term “sensing response announcement” may refer to a message that is included within a sensing transmission from a sensing transmitter to a sensing receiver that announces that a sensing response NDP will follow within a short interframe space (SIFS). An example of a sensing response announcement is an NDP announcement, or NDPA. In examples, a sensing response NDP may be transmitted using a requested transmission configuration.

A term “sensing response NDP” may refer to a response transmitted by a sensing transmitter and used for a sensing measurement at a sensing receiver. In examples, a sensing response NDP may be used when a requested transmission configuration is incompatible with transmission parameters required for successful non-sensing message reception. A sensing response NDP may be announced by a sensing response announcement. In an example, a sensing response NDP may be implemented with a null data PPDU. In some examples, a sensing response NDP may be implemented with a frame that does not contain any data.

A “transmission channel” may refer to a tunable channel on which the sensing receiver performs a sensing measurement and/or on which the sensing transmitter performs a sensing transmission.

A term “feature of interest” may refer to an item or state of an item which is positively detected and/or identified by a sensing algorithm.

A term “clear to send (CTS)” may refer to a function that may be used to let the AP know that the STA is ready (or is clear without channel conflicts) to send or receive data.

A term “timing synchronization function (TSF) timer” may refer to a timer that may be used as a local timer in a Wi-Fi sensing system. A TSF timer may be based on a 1-MHz clock and may tick in microseconds. In examples, the TSF timer is represented by a 64 bit register [63:0] which is incremented every microsecond.

A term “OBSS STA” may refer to a STA which is in an unassociated state with an AP.

A term “OBSS AP” may refer to an AP which is in an unassociated state with a STA.

A term “timestamp” may refer to a value associated with a sensing measurement which indicates a time reference for the sensing measurement. In an example, a sensing algorithm may use timestamp for calculating a sensing result.

A term “OBSS STA TSF timer” may refer to a local TSF timer (according to IEEE 802.11 standards) that the STA maintains, which is incremented in time units (TU) based on the STA voltage controlled oscillator (VCO).

A term “OBSS AP TSF timer” may refer to a local TSF timer (according to IEEE 802.11 standards) that the AP maintains, which is incremented in TU based on the AP VCO.

A term “OBSS STA-AP TSF timer” may refer to a local version of a TSF timer maintained and incremented at a STA, which is periodically resynchronized to an OBSS AP TSF timer.

A term “timer offset” may refer to a difference in TU between an OBSS AP TSF timer and an OBSS STA TSF timer at a point in time.

A term “adjusted OBSS STA TSF timer” may refer to a timer that has a value equal to the OBSS STA TSF timer combined with a timer offset.

A term “resynchronization timer” may refer to a timer associated with an OBSS STA and OBSS AP which represents the amount of time before the OBSS STA-AP TSF timer should be considered to be unsynchronized with the OBSS AP TSF timer.

A term “synchronization flag” may refer to a bit flag indication of whether or not the OBSS STA-AP TSF timer is synchronized with the OBSS AP TSF timer.

A term “Wi-Fi sensing session” may refer to a period during which objects in a sensing space may be probed, detected and/or characterized. In an example, during a Wi-Fi sensing session, several devices participate in, and thereby contribute to the generation of sensing measurements. A Wi-Fi sensing session may also be referred to as a WLAN sensing session or simply a sensing session.

For purposes of reading the description of the various embodiments below, the following descriptions of the sections of the specifications and their respective contents may be helpful:

Section A describes a wireless communications system, wireless transmissions and sensing measurements which may be useful for practicing embodiments described herein.

Section B describes systems and methods that are useful for a Wi-Fi sensing system configured to send sensing transmissions and make sensing measurements.

Section C describes embodiments of systems and methods for time synchronization of sensing measurements made out of basic service set (OBSS).

### A. Wireless Communications System, Wireless Transmissions, and Sensing Measurements

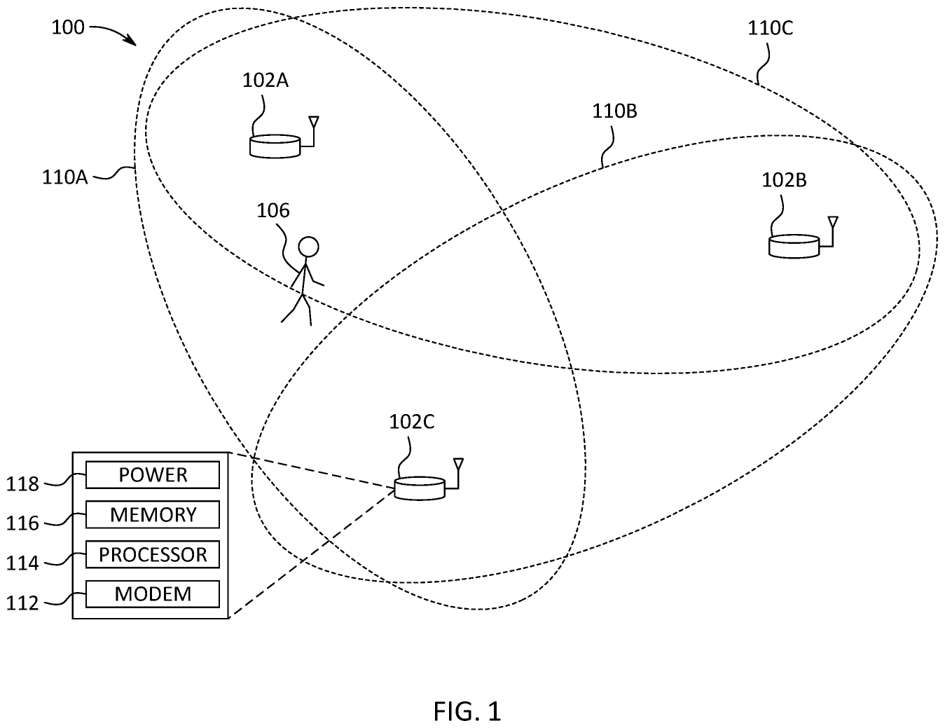

FIG. 1 illustrates wireless communication system 100. Wireless communication system 100 includes three wireless communication devices: first wireless communication device 102A, second wireless communication device 102B, and third wireless communication device 102C. Wireless communication system 100 may include additional wireless communication devices and other components (e.g., additional wireless communication devices, one or more network servers, network routers, network switches, cables, or other communication links, etc.).

Wireless communication devices 102A, 102B, 102C can operate in a wireless network, for example, according to a wireless network standard or another type of wireless communication protocol. For example, the wireless network may be configured to operate as a wireless local area network (WLAN), a personal area network (PAN), a metropolitan area network (MAN), or another type of wireless network. Examples of WLANs include networks configured to operate according to one or more of the 802.11 family of standards developed by IEEE (e.g., Wi-Fi networks), and others. Examples of PANs include networks that operate according to short-range communication standards (e.g., Bluetooth®, Near Field Communication (NFC), ZigBee), millimeter wave communications, and others.

In some implementations, wireless communication devices 102A, 102B, 102C may be configured to communicate in a cellular network, for example, according to a cellular network standard. Examples of cellular networks include networks configured according to 2G standards such as Global System for Mobile (GSM) and Enhanced Data rates for GSM Evolution (EDGE) or EGPRS; 3G standards such as code division multiple access (CDMA), wideband code division multiple access (WCDMA), Universal Mobile Telecommunications System (UMTS), and time division synchronous code division multiple access (TD-SCDMA); 4G standards such as Long-Term Evolution (LTE) and LTE-Advanced (LTE-A); 5G standards, and others.

In the example shown in FIG. 1, wireless communication devices 102A, 102B, 102C can be, or they may include standard wireless network components. For example, wireless communication devices 102A, 102B, 102C may be commercially-available Wi-Fi APs or another type of wireless access point (WAP) performing one or more operations as described herein that are embedded as instructions (e.g., software or firmware) on the modem of the WAP. In some cases, wireless communication devices 102A, 102B, 102C may be nodes of a wireless mesh network, such as, for example, a commercially-available mesh network system (e.g., Plume Wi-Fi, Google Wi-Fi, Qualcomm Wi-Fi SON, etc.). In some cases, another type of standard or conventional Wi-Fi transmitter device may be used. In some instances, one or more of wireless communication devices 102A, 102B, 102C may be implemented as WAPs in a mesh network, while other wireless communication device(s) 102A, 102B, 102C are implemented as leaf devices (e.g., mobile devices, smart devices, etc.) that access the mesh network through one of the WAPs. In some cases, one or more of wireless communication devices 102A, 102B, 102C is a mobile device (e.g., a smartphone, a smart watch, a tablet, a laptop computer, etc.), a wireless-enabled device (e.g., a smart thermostat, a Wi-Fi enabled camera, a smart TV), or another type of device that communicates in a wireless network.

Wireless communication devices 102A, 102B, 102C may be implemented without Wi-Fi components; for example, other types of standard or non-standard wireless communication may be used for motion detection. In some cases, wireless communication devices 102A, 102B, 102C can be, or they may be part of, a dedicated motion detection system. For example, the dedicated motion detection system can include a hub device and one or more beacon devices (as remote sensor devices), and wireless communication devices 102A, 102B, 102C can be either a hub device or a beacon device in the motion detection system.

As shown in FIG. 1, wireless communication device 102C includes modem 112, processor 114, memory 116, and power unit 118; any of wireless communication devices 102A, 102B, 102C in wireless communication system 100 may include the same, additional, or different components, and the components may be configured to operate as shown in FIG. 1 or in another manner. In some implementations, modem 112, processor 114, memory 116, and power unit 118 of a wireless communication device are housed together in a common housing or other assembly. In some implementations, one or more of the components of a wireless communication device can be housed separately, for example, in a separate housing or other assembly.

Modem 112 can communicate (receive, transmit, or both) wireless signals. For example, modem 112 may be configured to communicate RF signals formatted according to a wireless communication standard (e.g., Wi-Fi or Bluetooth). Modem 112 may be implemented as the example wireless network modem 112 shown in FIG. 1, or may be implemented in another manner, for example, with other types of components or subsystems. In some implementations, modem 112 includes a radio subsystem and a baseband subsystem. In some cases, the baseband subsystem and radio subsystem can be implemented on a common chip or chipset, or they may be implemented in a card or another type of assembled device. The baseband subsystem can be coupled to the radio subsystem, for example, by leads, pins, wires, or other types of connections.

In some cases, a radio subsystem in modem 112 can include one or more antennas and RF circuitry. The RF circuitry can include, for example, circuitry that filters, amplifies, or otherwise conditions analog signals, circuitry that up-converts baseband signals to RF signals, circuitry that down-converts RF signals to baseband signals, etc. Such circuitry may include, for example, filters, amplifiers, mixers, a local oscillator, etc. The radio subsystem can be configured to communicate radio frequency wireless signals on the wireless communication channels. As an example, the radio subsystem may include a radio chip, an RF front end, and one or more antennas. A radio subsystem may include additional or different components. In some implementations, the radio subsystem can be or may include the radio electronics (e.g., RF front end, radio chip, or analogous components) from a conventional modem, for example, from a Wi-Fi modem, pico base station modem, etc. In some implementations, the antenna includes multiple antennas.

In some cases, a baseband subsystem in modem 112 can include, for example, digital electronics configured to process digital baseband data. As an example, the baseband subsystem may include a baseband chip. A baseband subsystem may include additional or different components. In some cases, the baseband subsystem may include a digital signal processor (DSP) device or another type of processor device. In some cases, the baseband system includes digital processing logic to operate the radio subsystem, to communicate wireless network traffic through the radio subsystem, to detect motion based on motion detection signals received through the radio subsystem or to perform other types of processes. For instance, the baseband subsystem may include one or more chips, chipsets, or other types of devices that are configured to encode signals and deliver the encoded signals to the radio subsystem for transmission, or to identify and analyze data encoded in signals from the radio subsystem (e.g., by decoding the signals according to a wireless communication standard, by processing the signals according to a motion detection process, or otherwise).

In some instances, the radio subsystem in modem 112 receives baseband signals from the baseband subsystem, up-converts the baseband signals to RF signals, and wirelessly transmits the RF signals (e.g., through an antenna). In some instances, the radio subsystem in modem 112 wirelessly receives RF signals (e.g., through an antenna), down-converts the RF to baseband signals, and sends the baseband signals to the baseband subsystem. The signals exchanged between the radio subsystem and the baseband subsystem may be digital or analog signals. In some examples, the baseband subsystem includes conversion circuitry (e.g., a digital-to-analog converter, an analog-to-digital converter) and exchanges analog signals with the radio subsystem. In some examples, the radio subsystem includes conversion circuitry (e.g., a digital-to-analog converter, an analog-to-digital converter) and exchanges digital signals with the baseband subsystem.

In some cases, the baseband subsystem of modem 112 can communicate wireless network traffic (e.g., data packets) in the wireless communication network through the radio subsystem on one or more network traffic channels. The baseband subsystem of modem 112 may also transmit or receive (or both) signals (e.g., motion probe signals or motion detection signals) through the radio subsystem on a dedicated wireless communication channel. In some instances, the baseband subsystem generates motion probe signals for transmission, for example, to probe a space for motion. In some instances, the baseband subsystem processes received motion detection signals (signals based on motion probe signals transmitted through the space), for example, to detect motion of an object in a space.

Processor 114 can execute instructions, for example, to generate output data based on data inputs. The instructions can include programs, codes, scripts, or other types of data stored in memory. Additionally, or alternatively, the instructions can be encoded as pre-programmed or re-programmable logic circuits, logic gates, or other types of hardware or firmware components. Processor 114 may be or include a general-purpose microprocessor, as a specialized co-processor or another type of data processing apparatus. In some cases, processor 114 performs high level operation of the wireless communication device 102C. For example, processor 114 may be configured to execute or interpret software, scripts, programs, functions, executables, or other instructions stored in memory 116. In some implementations, processor 114 may be included in modem 112.

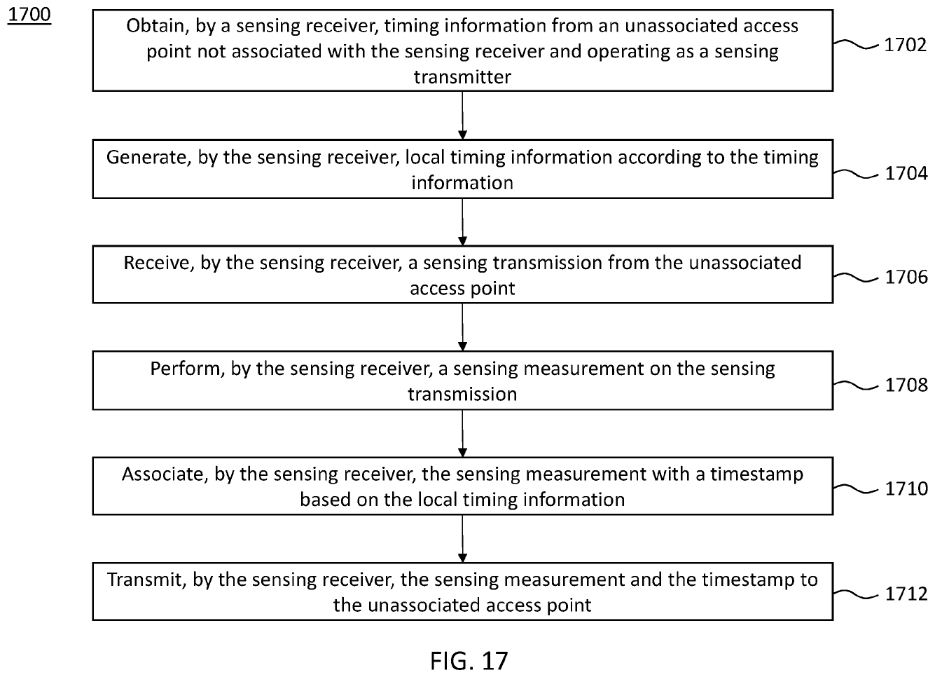

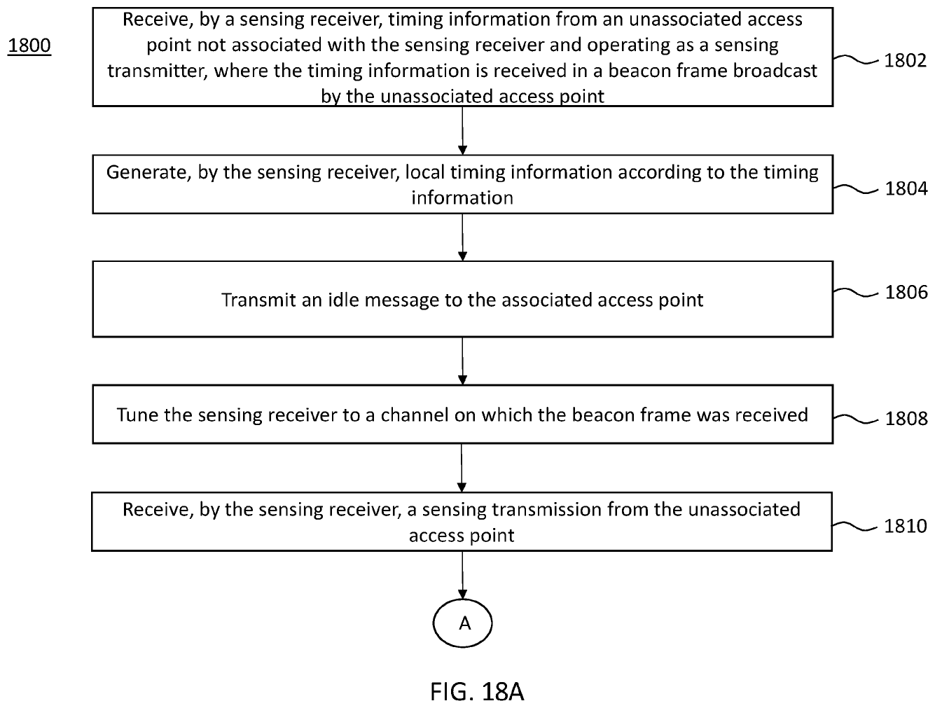

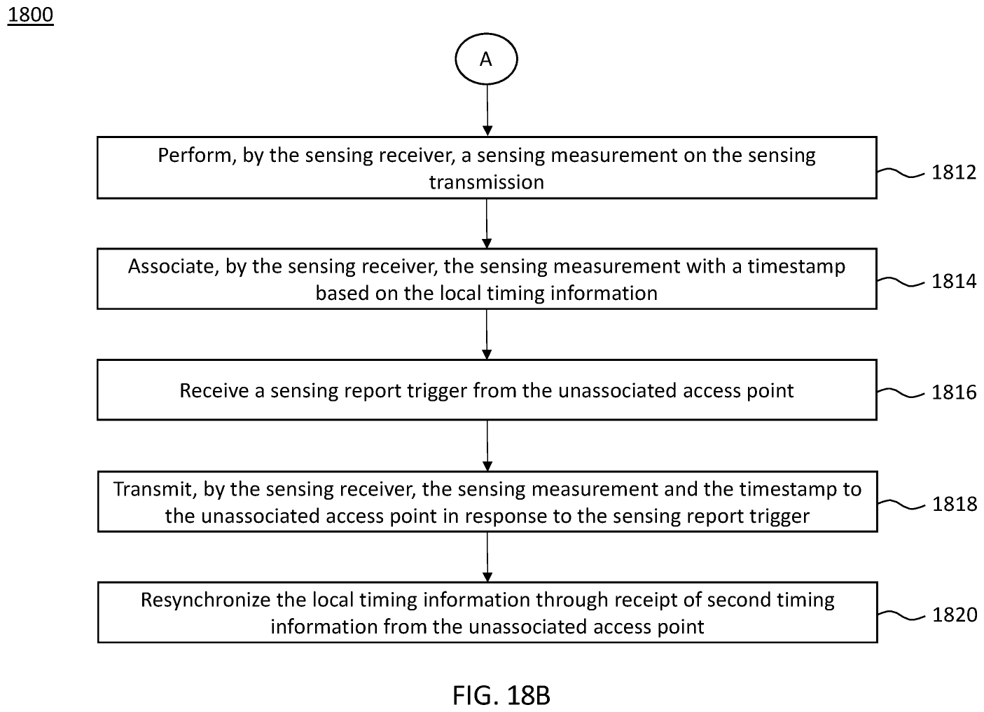

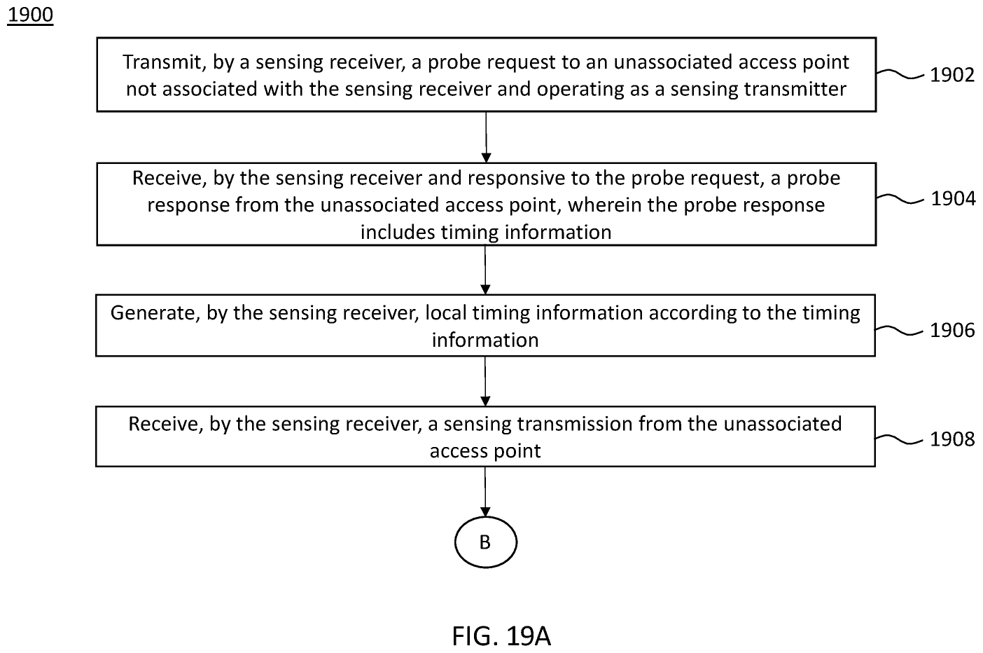

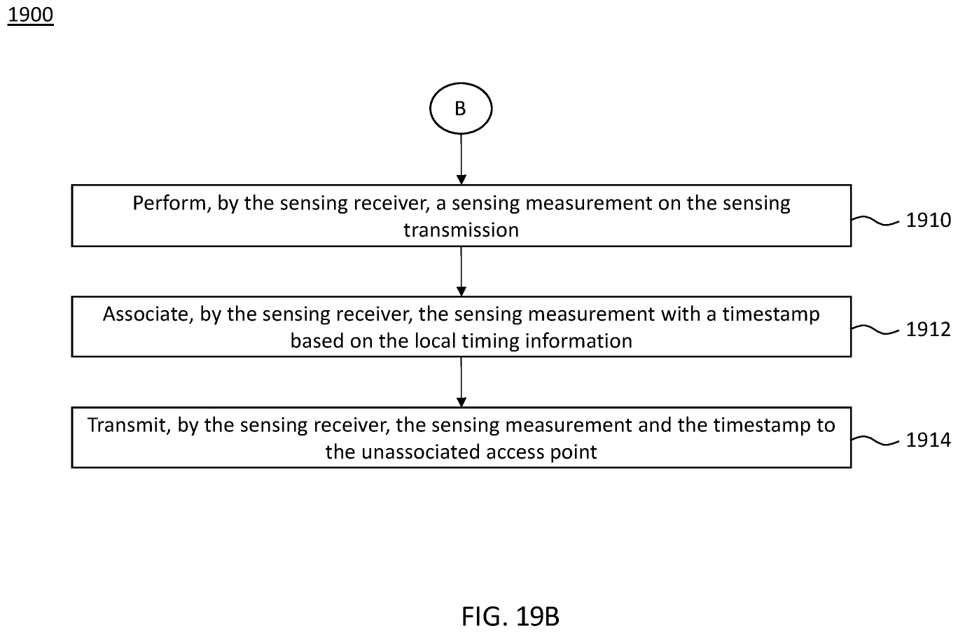

Memory 116 can include computer-readable storage media, for example, a volatile memory device, a non-volatile memory device, or both. Memory 116 can include one or more read-only memory devices, random-access memory devices, buffer memory devices, or a combination of these and other types of memory devices. In some instances, one or more components of the memory can be integrated or otherwise associated with another component of wireless communication device 102C. Memory 116 may store instructions that are executable by processor 114. For example, the instructions may include instructions for time-aligning signals using an interference buffer and a motion detection buffer, such as through one or more of the operations of the example process of FIG. 17, FIG. 18A, FIG. 18B, FIG. 19A, and FIG. 19B.

Power unit 118 provides power to the other components of wireless communication device 102C. For example, the other components may operate based on electrical power provided by power unit 118 through a voltage bus or other connection. In some implementations, power unit 118 includes a battery or a battery system, for example, a rechargeable battery. In some implementations, power unit 118 includes an adapter (e.g., an alternating current (AC) adapter) that receives an external power signal (from an external source) and coverts the external power signal to an internal power signal conditioned for a component of wireless communication device 102C. Power unit 118 may include other components or operate in another manner.

In the example shown in FIG. 1, wireless communication devices 102A, 102B transmit wireless signals (e.g., according to a wireless network standard, a motion detection protocol, or otherwise). For instance, wireless communication devices 102A, 102B may broadcast wireless motion probe signals (e.g., reference signals, beacon signals, status signals, etc.), or they may send wireless signals addressed to other devices (e.g., a user equipment, a client device, a server, etc.), and the other devices (not shown) as well as wireless communication device 102C may receive the wireless signals transmitted by wireless communication devices 102A, 102B. In some cases, the wireless signals transmitted by wireless communication devices 102A, 102B are repeated periodically, for example, according to a wireless communication standard or otherwise.

In the example shown, wireless communication device 102C processes the wireless signals from wireless communication devices 102A, 102B to detect motion of an object in a space accessed by the wireless signals, to determine a location of the detected motion, or both. For example, wireless communication device 102C may perform one or more operations of the example process described below with respect to FIG. 17, FIG. 18A, FIG. 18B, FIG. 19A, and FIG. 19B, or another type of process for detecting motion or determining a location of detected motion. The space accessed by the wireless signals can be an indoor or outdoor space, which may include, for example, one or more fully or partially enclosed areas, an open area without enclosure, etc. The space can be or can include an interior of a room, multiple rooms, a building, or the like. In some cases, the wireless communication system 100 can be modified, for instance, such that wireless communication device 102C can transmit wireless signals and wireless communication devices 102A, 102B can processes the wireless signals from wireless communication device 102C to detect motion or determine a location of detected motion.

The wireless signals used for motion detection can include, for example, a beacon signal (e.g., Bluetooth Beacons, Wi-Fi Beacons, other wireless beacon signals), another standard signal generated for other purposes according to a wireless network standard, or non-standard signals (e.g., random signals, reference signals, etc.) generated for motion detection or other purposes. In examples, motion detection may be carried out by analyzing one or more training fields carried by the wireless signals or by analyzing other data carried by the signal. In some examples data will be added for the express purpose of motion detection or the data used will nominally be for another purpose and reused or repurposed for motion detection. In some examples, the wireless signals propagate through an object (e.g., a wall) before or after interacting with a moving object, which may allow the moving object's movement to be detected without an optical line-of-sight between the moving object and the transmission or receiving hardware. Based on the received signals, wireless communication device 102C may generate motion detection data. In some instances, wireless communication device 102C may communicate the motion detection data to another device or system, such as a security system, which may include a control center for monitoring movement within a space, such as a room, building, outdoor area, etc.

In some implementations, wireless communication devices 102A, 102B can be modified to transmit motion probe signals (which may include, e.g., a reference signal, beacon signal, or another signal used to probe a space for motion) on a separate wireless communication channel (e.g., a frequency channel or coded channel) from wireless network traffic signals. For example, the modulation applied to the payload of a motion probe signal and the type of data or data structure in the payload may be known by wireless communication device 102C, which may reduce the amount of processing that wireless communication device 102C performs for motion sensing. The header may include additional information such as, for example, an indication of whether motion was detected by another device in communication system 100, an indication of the modulation type, an identification of the device transmitting the signal, etc.

In the example shown in FIG. 1, wireless communication system 100 is a wireless mesh network, with wireless communication links between each of wireless communication devices 102. In the example shown, the wireless communication link between wireless communication device 102C and wireless communication device 102A can be used to probe motion detection field 110A, the wireless communication link between wireless communication device 102C and wireless communication device 102B can be used to probe motion detection field 110B, and the wireless communication link between wireless communication device 102A and wireless communication device 102B can be used to probe motion detection field 110C. In some instances, each wireless communication device 102 detects motion in motion detection fields 110 accessed by that device by processing received signals that are based on wireless signals transmitted by wireless communication devices 102 through motion detection fields 110. For example, when person 106 shown in FIG. 1 moves in motion detection field 110A and motion detection field 110C, wireless communication devices 102 may detect the motion based on signals they received that are based on wireless signals transmitted through respective motion detection fields 110. For instance, wireless communication device 102A can detect motion of person 106 in motion detection fields 110A, 110C, wireless communication device 102B can detect motion of person 106 in motion detection field 110C, and wireless communication device 102C can detect motion of person 106 in motion detection field 110A.

In some instances, motion detection fields 110 can include, for example, air, solid materials, liquids, or another medium through which wireless electromagnetic signals may propagate. In the example shown in FIG. 1, motion detection field 110A provides a wireless communication channel between wireless communication device 102A and wireless communication device 102C, motion detection field 110B provides a wireless communication channel between wireless communication device 102B and wireless communication device 102C, and motion detection field 110C provides a wireless communication channel between wireless communication device 102A and wireless communication device 102B. In some aspects of operation, wireless signals transmitted on a wireless communication channel (separate from or shared with the wireless communication channel for network traffic) are used to detect movement of an object in a space. The objects can be any type of static or moveable object and can be living or inanimate. For example, the object can be a human (e.g., person 106 shown in FIG. 1), an animal, an inorganic object, or another device, apparatus, or assembly, an object that defines all or part of the boundary of a space (e.g., a wall, door, window, etc.), or another type of object. In some implementations, motion information from the wireless communication devices may be analyzed to determine a location of the detected motion. For example, as described further below, one of wireless communication devices 102 (or another device communicably coupled to wireless communications devices 102) may determine that the detected motion is nearby a particular wireless communication device.

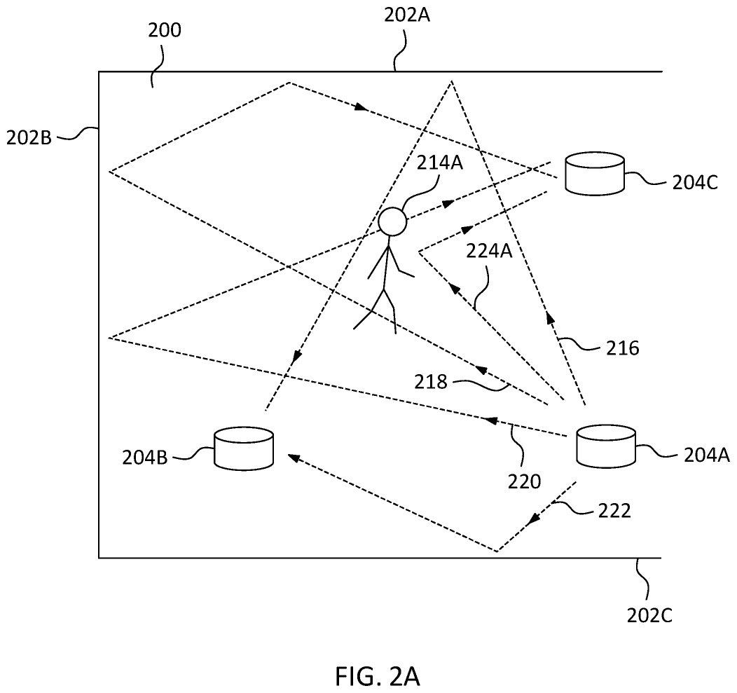

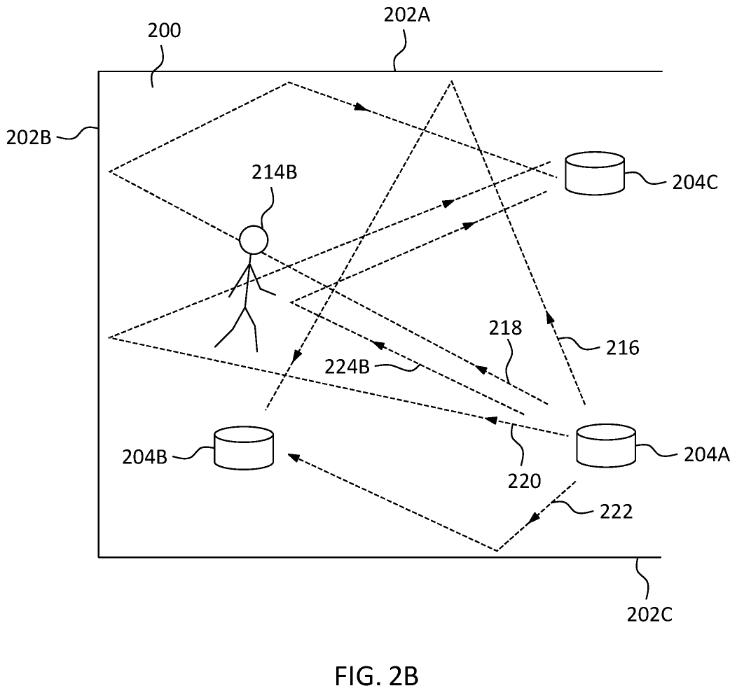

FIG. 2A and FIG. 2B are diagrams showing example wireless signals communicated between wireless communication devices 204A, 204B, 204C. Wireless communication devices 204A, 204B, 204C can be, for example, wireless communication devices 102A, 102B, 102C shown in FIG. 1, or other types of wireless communication devices. Wireless communication devices 204A, 204B, 204C transmit wireless signals through space 200. Space 200 can be completely or partially enclosed or open at one or more boundaries. In an example, space 200 may be a sensing space. Space 200 can be or can include an interior of a room, multiple rooms, a building, an indoor area, outdoor area, or the like. First wall 202A, second wall 202B, and third wall 202C at least partially enclose space 200 in the example shown.

In the example shown in FIG. 2A and FIG. 2B, wireless communication device 204A is operable to transmit wireless signals repeatedly (e.g., periodically, intermittently, at scheduled, unscheduled or random intervals, etc.). Wireless communication devices 204B, 204C are operable to receive signals based on those transmitted by wireless communication device 204A. Wireless communication devices 204B, 204C each have a modem (e.g., modem 112 shown in FIG. 1) that is configured to process received signals to detect motion of an object in space 200.

As shown, an object is in first position 214A in FIG. 2A, and the object has moved to second position 214B in FIG. 2B. In FIG. 2A and FIG. 2B, the moving object in space 200 is represented as a human, but the moving object can be another type of object. For example, the moving object can be an animal, an inorganic object (e.g., a system, device, apparatus, or assembly), an object that defines all or part of the boundary of space 200 (e.g., a wall, door, window, etc.), or another type of object.

As shown in FIG. 2A and FIG. 2B, multiple example paths of the wireless signals transmitted from wireless communication device 204A are illustrated by dashed lines. Along first signal path 216, the wireless signal is transmitted from wireless communication device 204A and reflected off first wall 202A toward the wireless communication device 204B. Along second signal path 218, the wireless signal is transmitted from the wireless communication device 204A and reflected off second wall 202B and first wall 202A toward wireless communication device 204C. Along third signal path 220, the wireless signal is transmitted from the wireless communication device 204A and reflected off second wall 202B toward wireless communication device 204C. Along fourth signal path 222, the wireless signal is transmitted from the wireless communication device 204A and reflected off third wall 202C toward the wireless communication device 204B.

In FIG. 2A, along fifth signal path 224A, the wireless signal is transmitted from wireless communication device 204A and reflected off the object at first position 214A toward wireless communication device 204C. Between FIG. 2A and FIG. 2B, a surface of the object moves from first position 214A to second position 214B in space 200 (e.g., some distance away from first position 214A). In FIG. 2B, along sixth signal path 224B, the wireless signal is transmitted from wireless communication device 204A and reflected off the object at second position 214B toward wireless communication device 204C. Sixth signal path 224B depicted in FIG. 2B is longer than fifth signal path 224A depicted in FIG. 2A due to the movement of the object from first position 214A to second position 214B. In some examples, a signal path can be added, removed, or otherwise modified due to movement of an object in a space.

The example wireless signals shown in FIG. 2A and FIG. 2B may experience attenuation, frequency shifts, phase shifts, or other effects through their respective paths and may have portions that propagate in another direction, for example, through the first, second and third walls 202A, 202B, and 202C. In some examples, the wireless signals are radio frequency (RF) signals. The wireless signals may include other types of signals.

In the example shown in FIG. 2A and FIG. 2B, wireless communication device 204A can repeatedly transmit a wireless signal. In particular, FIG. 2A shows the wireless signal being transmitted from wireless communication device 204A at a first time, and FIG. 2B shows the same wireless signal being transmitted from wireless communication device 204A at a second, later time. The transmitted signal can be transmitted continuously, periodically, at random or intermittent times or the like, or a combination thereof. The transmitted signal can have a number of frequency components in a frequency bandwidth. The transmitted signal can be transmitted from wireless communication device 204A in an omnidirectional manner, in a directional manner or otherwise. In the example shown, the wireless signals traverse multiple respective paths in space 200, and the signal along each path may become attenuated due to path losses, scattering, reflection, or the like and may have a phase or frequency offset.

As shown in FIG. 2A and FIG. 2B, the signals from first to sixth paths 216, 218, 220, 222, 224A, and 224B combine at wireless communication device 204C and wireless communication device 204B to form received signals. Because of the effects of the multiple paths in space 200 on the transmitted signal, space 200 may be represented as a transfer function (e.g., a filter) in which the transmitted signal is input and the received signal is output. When an object moves in space 200, the attenuation or phase offset affected upon a signal in a signal path can change, and hence, the transfer function of space 200 can change. Assuming the same wireless signal is transmitted from wireless communication device 204A, if the transfer function of space 200 changes, the output of that transfer function—the received signal—will also change. A change in the received signal can be used to detect movement of an object.

Mathematically, a transmitted signal f(t) transmitted from the first wireless communication device 204A may be described according to Equation (1):

$$f ( t ) = {\sum }_{n = - ∞}^{∞} {c}_{n} {e}^{j {ω}_{n} t} \qquad ( 1 )$$

Where ωₙ represents the frequency of nth frequency component of the transmitted signal, cₙ represents the complex coefficient of the nth frequency component, and t represents time. With the f(t) being transmitted from the first wireless communication device 204A, an output signal rₖ(t) from a path, k, may be described according to Equation (2):

$${r}_{k} ( t ) = {\sum }_{n = - ∞}^{∞} {α}_{n , k} {c}_{n} {e}^{j ( {ω}_{n} t + {ϕ}_{n , k} )} \qquad ( 2 )$$

Where α_{n,k} represents an attenuation factor (or channel response; e.g., due to scattering, reflection, and path losses) for the nth frequency component along k, and ϕ_{n,k} represents the phase of the signal for nth frequency component along k. Then, the received signal, R, at a wireless communication device can be described as the summation of all output signals rₖ(t) from all paths to the wireless communication device, which is shown in Equation (3):

$$R = {\sum }_{k} {r}_{k} ( t ) \qquad ( 3 )$$

Substituting Equation (2) into Equation (3) renders the following Equation (4):

$$R = {\sum }_{k} {\sum }_{n = - ∞}^{∞} ( {α}_{n , k} {e}^{j {ϕ}_{n , k}} ) {c}_{n} {e}^{j {ω}_{n} t} \qquad ( 4 )$$

R at a wireless communication device can then be analyzed. R at a wireless communication device can be transformed to the frequency domain, for example, using a fast Fourier transform (FFT) or another type of algorithm. The transformed signal can represent R as a series of n complex values, one for each of the respective frequency components (at the n frequencies ωₙ). For a frequency component at frequency on, a complex value, Hₙ, may be represented as follows in Equation (5):

$${H}_{n} = {\sum }_{k} {c}_{n} {α}_{n , k} {e}^{j {ϕ}_{n , k}} \qquad ( 5 )$$

Hₙ for a given ωₙ indicates a relative magnitude and phase offset of the received signal at ωₙ. When an object moves in the space, Hₙ changes due to α_{n,k} of the space changing. Accordingly, a change detected in the channel response can be indicative of movement of an object within the communication channel. In some instances, noise, interference, or other phenomena can influence the channel response detected by the receiver, and the motion detection system can reduce or isolate such influences to improve the accuracy and quality of motion detection capabilities. In some implementations, the overall channel response can be represented as follows in Equation (6):

$${h}_{ch} = {\sum }_{k} {\sum }_{n = - ∞}^{∞} {α}_{n , k} \qquad ( 6 )$$

In some instances, the channel response, h_{ch}, for a space can be determined, for example, based on the mathematical theory of estimation. For instance, a reference signal, R_{ef}, can be modified with candidate h_{ch}, and then a maximum likelihood approach can be used to select the candidate channel which gives best match to the received signal (R_{cvd}). In some cases, an estimated received signal (\hat{R}_{cvd}) is obtained from the convolution of R_{ef} with the candidate h_{ch}, and then the channel coefficients of h_{ch} are varied to minimize the squared error of \hat{R}_{cvd}. This can be mathematically illustrated as follows in Equation (7):

$${R}_{cvd} = {R}_{ef} ⊗ {h}_{ch} = {\sum }_{k = - m}^{m} {R}_{ef} ( n - k ) {h}_{ch} ( k ) \qquad ( 7 )$$

with the optimization criterion as in Equation (8):

$${min}_{{h}_{ch}} \{ \sum {( {\hat{R}}_{cvd} - {R}_{cvd} )}^{2} \} \qquad ( 8 )$$

The minimizing, or optimizing, process can utilize an adaptive filtering technique, such as least mean squares (LMS), recursive least squares (RLS), batch least squares (BLS), etc. The channel response can be a finite impulse response (FIR) filter, infinite impulse response (IIR) filter, or the like. As shown in the equation above, the received signal can be considered as a convolution of the reference signal and the channel response. The convolution operation means that the channel coefficients possess a degree of correlation with each of the delayed replicas of the reference signal. The convolution operation as shown in the equation above, therefore shows that the received signal appears at different delay points, each delayed replica being weighted by the channel coefficient.

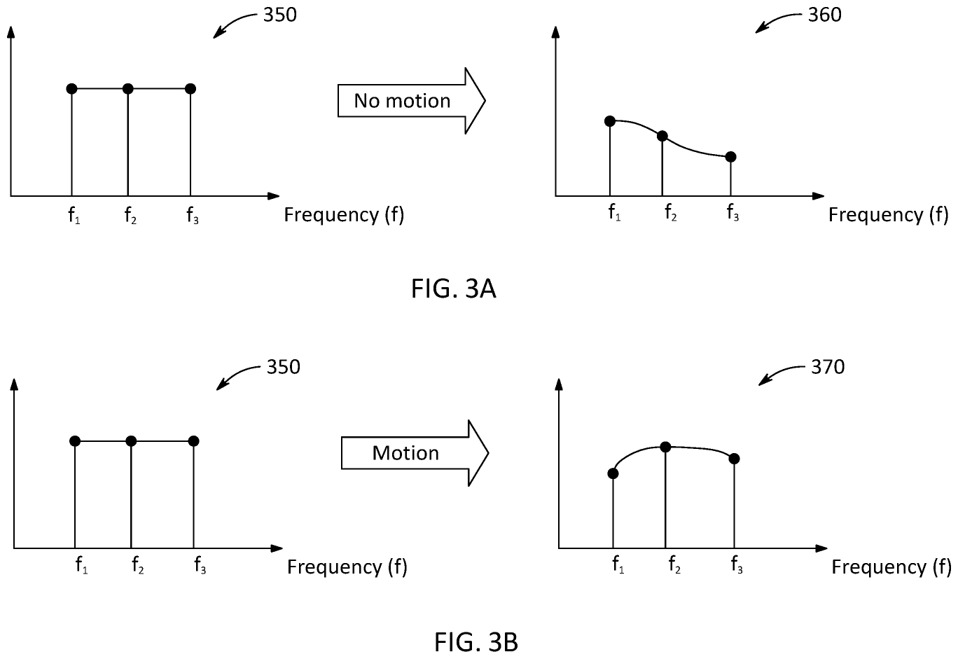

FIG. 3A and FIG. 3B are plots showing examples of channel responses 360, 370 computed from the wireless signals communicated between wireless communication devices 204A, 204B, 204C in FIG. 2A and FIG. 2B. FIG. 3A and FIG. 3B also show frequency domain representation 350 of an initial wireless signal transmitted by wireless communication device 204A. In the examples shown, channel response 360 in FIG. 3A represents the signals received by wireless communication device 204B when there is no motion in space 200, and channel response 370 in FIG. 3B represents the signals received by wireless communication device 204B in FIG. 2B after the object has moved in space 200.

In the example shown in FIG. 3A and FIG. 3B, for illustration purposes, wireless communication device 204A transmits a signal that has a flat frequency profile (the magnitude of each frequency component, f₁, f₂ and f₃ is the same), as shown in frequency domain representation 350. Because of the interaction of the signal with space 200 (and the objects therein), the signals received at wireless communication device 204B that are based on the signal sent from wireless communication device 204A are different from the transmitted signal. In this example, where the transmitted signal has a flat frequency profile, the received signal represents the channel response of space 200. As shown in FIG. 3A and FIG. 3B, channel responses 360, 370 are different from frequency domain representation 350 of the transmitted signal. When motion occurs in space 200, a variation in the channel response will also occur. For example, as shown in FIG. 3B, channel response 370 that is associated with motion of object in space 200 varies from channel response 360 that is associated with no motion in space

Furthermore, as an object moves within space 200, the channel response may vary from channel response 370. In some cases, space 200 can be divided into distinct regions and the channel responses associated with each region may share one or more characteristics (e.g., shape), as described below. Thus, motion of an object within different distinct regions can be distinguished, and the location of detected motion can be determined based on an analysis of channel responses.

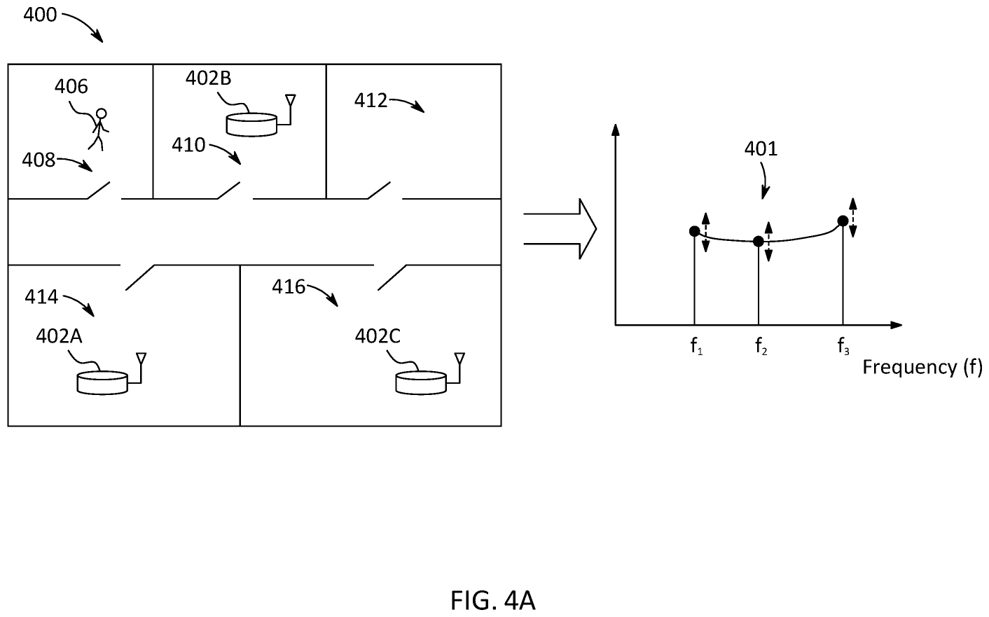

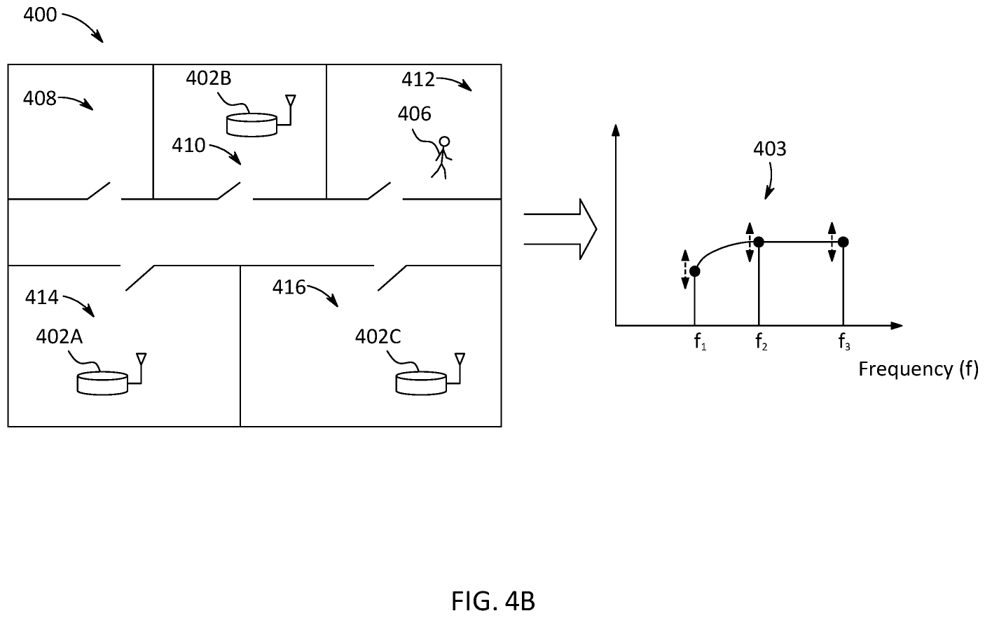

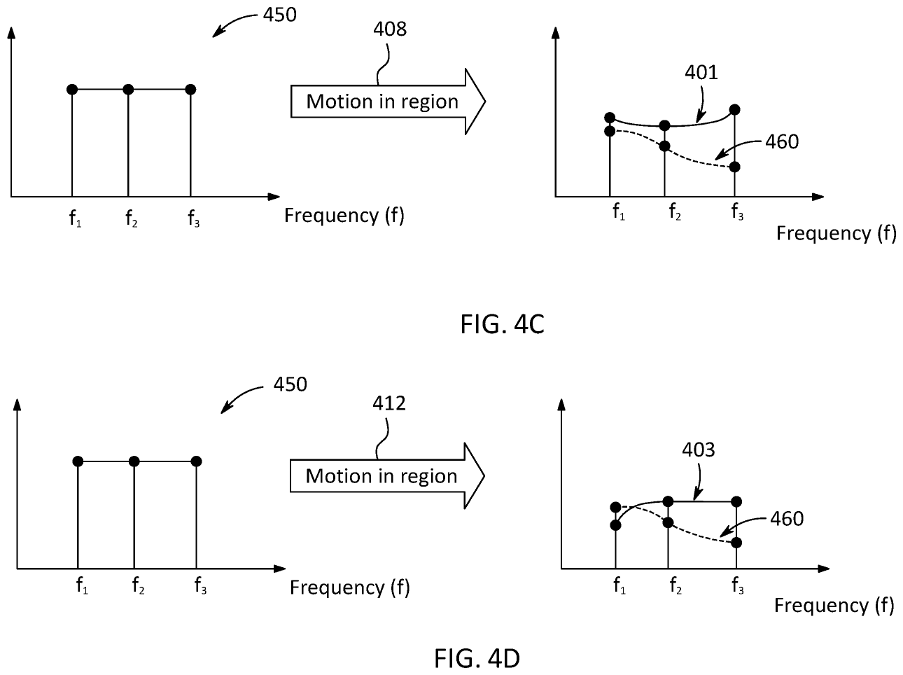

FIG. 4A and FIG. 4B are diagrams showing example channel responses 401, 403 associated with motion of object 406 in distinct regions 408, 412 of space 400. In the examples shown, space 400 is a building, and space 400 is divided into a plurality of distinct regions-first region 408, second region 410, third region 412, fourth region 414, and fifth region 416. Space 400 may include additional or fewer regions, in some instances. As shown in FIG. 4A and FIG. 4B, the regions within space 400 may be defined by walls between rooms. In addition, the regions may be defined by ceilings between floors of a building. For example, space 400 may include additional floors with additional rooms. In addition, in some instances, the plurality of regions of a space can be or include a number of floors in a multistory building, a number of rooms in the building, or a number of rooms on a particular floor of the building. In the example shown in FIG. 4A, an object located in first region 408 is represented as person 406, but the moving object can be another type of object, such as an animal or an inorganic object.

In the example shown, wireless communication device 402A is located in fourth region 414 of space 400, wireless communication device 402B is located in second region 410 of space 400, and wireless communication device 402C is located in fifth region 416 of space 400. Wireless communication devices 402 can operate in the same or similar manner as wireless communication devices 102 of FIG. 1. For instance, wireless communication devices 402 may be configured to transmit and receive wireless signals and detect whether motion has occurred in space 400 based on the received signals. As an example, wireless communication devices 402 may periodically or repeatedly transmit motion probe signals through space 400, and receive signals based on the motion probe signals. Wireless communication devices 402 can analyze the received signals to detect whether an object has moved in space 400, such as, for example, by analyzing channel responses associated with space 400 based on the received signals. In addition, in some implementations, wireless communication devices 402 can analyze the received signals to identify a location of detected motion within space 400. For example, wireless communication devices 402 can analyze characteristics of the channel response to determine whether the channel responses share the same or similar characteristics to channel responses known to be associated with first to fifth regions 408, 410, 412, 414, 416 of space 400.

In the examples shown, one (or more) of wireless communication devices 402 repeatedly transmits a motion probe signal (e.g., a reference signal) through space 400. The motion probe signals may have a flat frequency profile in some instances, wherein the magnitude of f₁, f₂ and f₃ is the same or nearly the same. For example, the motion probe signals may have a frequency response similar to frequency domain representation 350 shown in FIG. 3A and FIG. 3B. The motion probe signals may have a different frequency profile in some instances. Because of the interaction of the reference signal with space 400 (and the objects therein), the signals received at another wireless communication device 402 that are based on the motion probe signal transmitted from the other wireless communication device 402 are different from the transmitted reference signal.

Based on the received signals, wireless communication devices 402 can determine a channel response for space 400. When motion occurs in distinct regions within the space, distinct characteristics may be seen in the channel responses. For example, while the channel responses may differ slightly for motion within the same region of space 400, the channel responses associated with motion in distinct regions may generally share the same shape or other characteristics. For instance, channel response 401 of FIG. 4A represents an example channel response associated with motion of object 406 in first region 408 of space 400, while channel response 403 of FIG. 4B represents an example channel response associated with motion of object 406 in third region 412 of space 400. Channel responses 401, 403 are associated with signals received by the same wireless communication device 402 in space 400.

FIG. 4C and FIG. 4D are plots showing channel responses 401, 403 of FIG. 4A and FIG. 4B overlaid on channel response 460 associated with no motion occurring in space 400. When motion occurs in space 400, a variation in the channel response will occur relative to channel response 460 associated with no motion, and thus, motion of an object in space 400 can be detected by analyzing variations in the channel responses. In addition, a relative location of the detected motion within space 400 can be identified. For example, the shape of channel responses associated with motion can be compared with reference information (e.g., using a trained artificial intelligence (AI) model) to categorize the motion as having occurred within a distinct region of space 400.

When there is no motion in space 400 (e.g., when object 406 is not present), wireless communication device 402 may compute channel response 460 associated with no motion. Slight variations may occur in the channel response due to a number of factors; however, multiple channel responses 460 associated with different periods of time may share one or more characteristics. In the example shown, channel response 460 associated with no motion has a decreasing frequency profile (the magnitude of each of f₁, f₂ and f₃ is less than the previous). The profile of channel response 460 may differ in some instances (e.g., based on different room layouts or placement of wireless communication devices 402).

When motion occurs in space 400, a variation in the channel response will occur. For instance, in the examples shown in FIG. 4C and FIG. 4D, channel response 401 associated with motion of object 406 in first region 408 differs from channel response 460 associated with no motion and channel response 403 associated with motion of object 406 in third region 412 differs from channel response 460 associated with no motion. Channel response 401 has a concave-parabolic frequency profile (the magnitude of the middle frequency component, f₂, is less than the outer frequency components f₁ and f₃), while channel response 403 has a convex-asymptotic frequency profile (the magnitude of the middle frequency component f₂ is greater than the outer frequency components, f₁ and f₃). The profiles of channel responses 401, 403 may differ in some instances (e.g., based on different room layouts or placement of the wireless communication devices 402).

Analyzing channel responses may be considered similar to analyzing a digital filter. A channel response may be formed through the reflections of objects in a space as well as reflections created by a moving or static human. When a reflector (e.g., a human) moves, it changes the channel response. This may translate to a change in equivalent taps of a digital filter, which can be thought of as having poles and zeros (poles amplify the frequency components of a channel response and appear as peaks or high points in the response, while zeros attenuate the frequency components of a channel response and appear as troughs, low points, or nulls in the response). A changing digital filter can be characterized by the locations of its peaks and troughs, and a channel response may be characterized similarly by its peaks and troughs. For example, in some implementations, analyzing nulls and peaks in the frequency components of a channel response (e.g., by marking their location on the frequency axis and their magnitude), motion can be detected.

In some implementations, a time series aggregation can be used to detect motion. A time series aggregation may be performed by observing the features of a channel response over a moving window and aggregating the windowed result by using statistical measures (e.g., mean, variance, principal components, etc.). During instances of motion, the characteristic digital-filter features would be displaced in location and flip-flop between some values due to the continuous change in the scattering scene. That is, an equivalent digital filter exhibits a range of values for its peaks and nulls (due to the motion). By looking this range of values, unique profiles (in examples profiles may also be referred to as signatures) may be identified for distinct regions within a space.

In some implementations, an AI model may be used to process data. AI models may be of a variety of types, for example linear regression models, logistic regression models, linear discriminant analysis models, decision tree models, naïve bayes models, K-nearest neighbors models, learning vector quantization models, support vector machines, bagging and random forest models, and deep neural networks. In general, all AI models aim to learn a function which provides the most precise correlation between input values and output values and are trained using historic sets of inputs and outputs that are known to be correlated. In examples, artificial intelligence may also be referred to as machine learning.

In some implementations, the profiles of the channel responses associated with motion in distinct regions of space 400 can be learned. For example, machine learning may be used to categorize channel response characteristics with motion of an object within distinct regions of a space. In some cases, a user associated with wireless communication devices 402 (e.g., an owner or other occupier of space 400) can assist with the learning process. For instance, referring to the examples shown in FIG. 4A and FIG. 4B, the user can move in each of first to fifth regions 408, 410, 412, 414, 416 during a learning phase and may indicate (e.g., through a user interface on a mobile computing device) that he/she is moving in one of the particular regions in space 400. For example, while the user is moving through first region 408 (e.g., as shown in FIG. 4A) the user may indicate on a mobile computing device that he/she is in first region 408 (and may name the region as “bedroom”, “living room”, “kitchen”, or another type of room of a building, as appropriate). Channel responses may be obtained as the user moves through the region, and the channel responses may be “tagged” with the user's indicated location (region). The user may repeat the same process for the other regions of space 400. The term “tagged” as used herein may refer to marking and identifying channel responses with the user's indicated location or any other information.

The tagged channel responses can then be processed (e.g., by machine learning software) to identify unique characteristics of the channel responses associated with motion in the distinct regions. Once identified, the identified unique characteristics may be used to determine a location of detected motion for newly computed channel responses. For example, an AI model may be trained using the tagged channel responses, and once trained, newly computed channel responses can be input to the AI model, and the AI model can output a location of the detected motion. For example, in some cases, mean, range, and absolute values are input to an AI model. In some instances, magnitude and phase of the complex channel response itself may be input as well. These values allow the AI model to design arbitrary front-end filters to pick up the features that are most relevant to making accurate predictions with respect to motion in distinct regions of a space. In some implementations, the AI model is trained by performing a stochastic gradient descent. For instance, channel response variations that are most active during a certain zone may be monitored during the training, and the specific channel variations may be weighted heavily (by training and adapting the weights in the first layer to correlate with those shapes, trends, etc.). The weighted channel variations may be used to create a metric that activates when a user is present in a certain region.

For extracted features like channel response nulls and peaks, a time-series (of the nulls/peaks) may be created using an aggregation within a moving window, taking a snapshot of few features in the past and present, and using that aggregated value as input to the network. Thus, the network, while adapting its weights, will be trying to aggregate values in a certain region to cluster them, which can be done by creating a logistic classifier based decision surfaces. The decision surfaces divide different clusters, and subsequent layers can form categories based on a single cluster or a combination of clusters.

In some implementations, an AI model includes two or more layers of inference. The first layer acts as a logistic classifier which can divide different concentrations of values into separate clusters, while the second layer combines some of these clusters together to create a category for a distinct region. Additionally, subsequent layers can help in extending the distinct regions over more than two categories of clusters. For example, a fully-connected AI model may include an input layer corresponding to the number of features tracked, a middle layer corresponding to the number of effective clusters (through iterating between choices), and a final layer corresponding to different regions. Where complete channel response information is input to the AI model, the first layer may act as a shape filter that can correlate certain shapes. Thus, the first layer may lock to a certain shape, the second layer may generate a measure of variation happening in those shapes, and third and subsequent layers may create a combination of those variations and map them to different regions within the space. The output of different layers may then be combined through a fusing layer.

### B. Wi-Fi Sensing System Example Methods and Apparatus

Section B describes systems and methods that are useful for a wireless sensing system configured to send sensing transmissions and make sensing measurements.

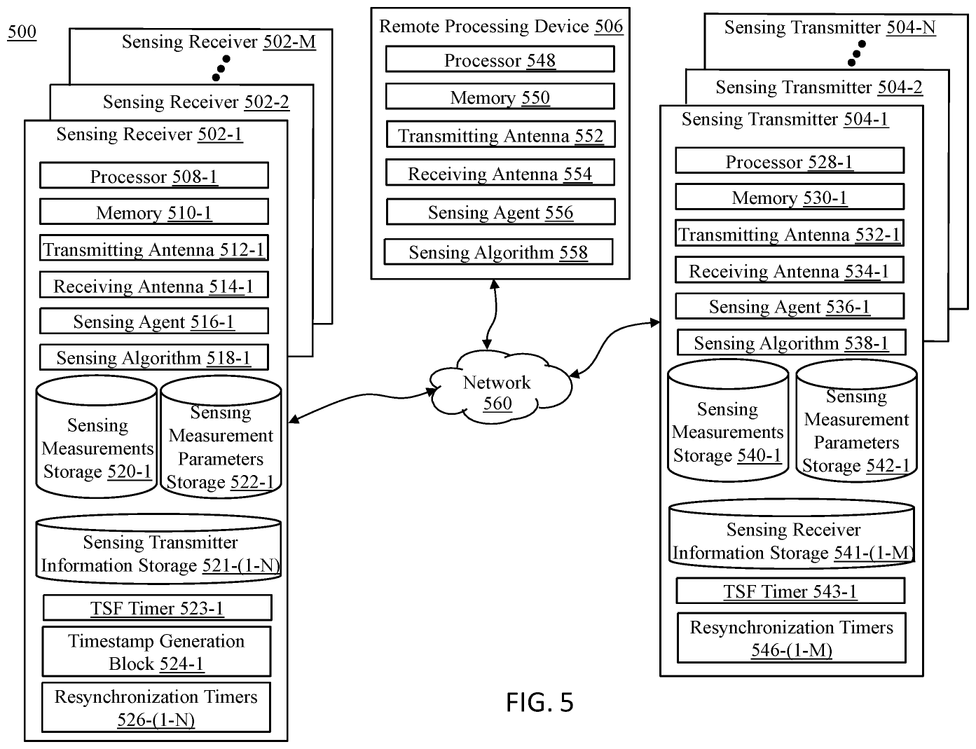

FIG. 5 depicts an implementation of some of an architecture of an implementation of system 500 for Wi-Fi sensing, according to some embodiments.

System 500 may include a plurality of networking devices. In an implementation, the plurality of networking devices may include plurality of sensing receivers 502-(1-M), plurality of sensing transmitters 504-(1-N), and remote processing device 506. In examples, plurality of sensing receivers 502-(1-M) and plurality of sensing transmitters 504-(1-N) may belong to more than one basic service set (BSS). Further, system 500 may include network 560 enabling communication between the system components for information exchange. System 500 may be an example or instance of wireless communication system 100, and network 560 may be an example or instance of wireless network or cellular network, details of which are provided with reference to FIG. 1 and its accompanying description. In some embodiments, one or more of plurality of sensing transmitters 504-(1-N) may not be associated (i.e., may be unassociated) with one or more of plurality of sensing receivers 502-(1-M). In examples, plurality of sensing receivers 502-(1-M) may include at least first sensing receiver 502-1 and second sensing receiver 502-2. Similarly, plurality of sensing transmitters 504-(1-N) may include at least first sensing transmitter 504-1 and second sensing transmitter 504-2.

For ease of explanation and understanding, the description provided below is with reference to first sensing receiver 502-1 and first sensing transmitter 504-1, however, the description is equally applicable to remaining sensing receivers 502-(2-M) and remaining sensing transmitters 504-(2-N).

According to an embodiment, first sensing receiver 502-1 may be configured to receive a sensing transmission from sensing transmitter 504-1 and perform one or more measurements (for example, channel representation information (CRI) such as channel state information (CSI) or time domain channel representation information (TD-CRI)) useful for Wi-Fi sensing. These measurements may be known as sensing measurements. The sensing measurements may be processed to achieve a sensing goal of system 500, such as detecting motions or gestures. In an embodiment, one or more of plurality of sensing receivers 502-(1-M) may be an AP. In some embodiments, one or more of plurality of sensing receivers 502-(1-M) may take a role of sensing initiator and/or sensing responder. In an embodiment, first sensing receiver 502-1 may be a non-AP station (STA). In some embodiments, first sensing transmitter 504-1 may be an access point (AP). In an example, first sensing receiver 502-1 may be an out of BSS (OBSS) STA (i.e., a STA that is not associated with, and therefore not time synchronized to, an OBSS AP, such as sensing transmitter 504-1).

According to an implementation, first sensing receiver 502-1 may be implemented by a device, such as wireless communication device 102 shown in FIG. 1. In some implementations, first sensing receiver 502-1 may be implemented by a device, such as wireless communication device 204 shown in FIG. 2A and FIG. 2B. Further, first sensing receiver 502-1 may be implemented by a device, such as wireless communication device 402 shown in FIG. 4A and FIG. 4B. In an implementation, one or more of plurality of sensing receivers 502-(1-M) may coordinate and control communication among plurality of sensing transmitters 504-(1-N). According to an implementation, one or more of plurality of sensing receivers 502-(1-M) may be enabled to control a sensing measurement session comprising one or more sensing measurement instances to ensure that required sensing transmissions are made at a required times and to ensure an accurate determination of one or more sensing measurements. In some embodiments, one or more of plurality of sensing receivers 502-(1-M) may process sensing measurements to achieve the sensing goal of system 500. In an embodiment, one or more of plurality of sensing receivers 502-(1-M) may be a STA. In an embodiment, one or more of plurality of sensing receivers 502-(1-M) may be an AP. In some embodiments, first sensing receiver 502-1 may be any computing device, such as a desktop computer, a laptop, a tablet computer, a mobile device, a personal digital assistant (PDA), or any other computing device. In some embodiments, first sensing receiver 502-1 may process sensing measurements to achieve a sensing result of system 500. In some embodiments, first sensing receiver 502-1 may be configured to transmit sensing measurements to sensing transmitters 504-1, and sensing transmitter 504-1 may be configured to process the sensing measurements to achieve a sensing result of system 500.

Referring again to FIG. 5, in some embodiments, first sensing transmitter 504-1 may be configured to send one or more sensing transmissions to one or more of plurality of sensing receivers 502-(1-M) based on which one or more sensing measurements (for example, channel state information) may be performed for Wi-Fi sensing. In an embodiment, first sensing transmitter 504-1 may be an AP. In some embodiments, first sensing transmitter 504-1 may be a STA, for example, where first sensing receiver 502-1 is an AP. In an example, first sensing transmitter 504-1 may be an OBSS AP (i.e., an AP that is not associated with, and therefore not time synchronized to, an OBSS STA such as sensing receiver 502-1).

According to an implementation, first sensing transmitter 504-1 may be implemented by a device, such as wireless communication device 102 shown in FIG. 1. In some implementations, first sensing transmitter 504-1 may be implemented by a device, such as wireless communication device 204 shown in FIG. 2A and FIG. 2B. Further, first sensing transmitter 504-1 may be implemented by a device, such as wireless communication device 402 shown in FIG. 4A and FIG. 4B. In some embodiments, first sensing transmitter 504-1 may be any computing device, such as a desktop computer, a laptop, a tablet computer, a mobile device, a PDA, or any other computing device. In some implementations, communication between first sensing receiver 502-1 and first sensing transmitter 504-1 may happen via station management entity (SME) and MAC layer management entity (MLME) protocols.

In some embodiments, remote processing device 506 may be configured to receive sensing measurements from one or more of plurality of sensing receivers 502-(1-M) and process the sensing measurements. In an example, remote processing device 506 may process and analyze sensing measurements to identify one or more features of interest. According to some implementations, remote processing device 506 may include/execute a sensing algorithm. In an embodiment, remote processing device 506 may be a STA. In some embodiments, remote processing device 506 may be an AP. According to an implementation, remote processing device 506 may be implemented by a device, such as wireless communication device 102 shown in FIG. 1. In some implementations, remote processing device 506 may be implemented by a device, such as wireless communication device 204 shown in FIG. 2A and FIG. 2B. Further, remote processing device 506 may be implemented by a device, such as wireless communication device 402 shown in FIG. 4A and FIG. 4B. In some embodiments, remote processing device 506 may be any computing device, such as a desktop computer, a laptop, a tablet computer, a mobile device, a personal digital assistant (PDA) or any other computing device. In embodiments, remote processing device 506 may take a role of sensing initiator where a sensing algorithm determines a Wi-Fi sensing session and the sensing measurements required to fulfill the measurement campaign. In an example, remote processing device 506 may communicate sensing measurement parameters and/or transmission parameters required to initiate a Wi-Fi sensing session to one or more of plurality of sensing receivers 502-(1-M) and/or to one or more of plurality of sensing transmitters 504-(1-N) to coordinate and control sensing transmissions for performing sensing measurements.

Referring to FIG. 5, in more detail, first sensing receiver 502-1 (which is an example of one or more of plurality of sensing receivers 502-(1-M)) may include processor 508-1 and memory 510-1. For example, processor 508-1 and memory 510-1 of first sensing receiver 502-1 may be processor 114 and memory 116, respectively, as shown in FIG. 1. In an embodiment, first sensing receiver 502-1 may further include transmitting antenna(s) 512-1, receiving antenna(s) 514-1, and sensing agent 516-1. In some embodiments, an antenna may be used to both transmit and receive signals in a half-duplex format. When the antenna is transmitting, it may be referred to as transmitting antenna 512-1, and when the antenna is receiving, it may be referred to as receiving antenna 514-1. It is understood by a person of normal skill in the art that the same antenna may be transmitting antenna 512-1 in some instances and receiving antenna 514-1 in other instances. In the case of an antenna array, one or more antenna elements may be used to transmit or receive a signal, for example, in a beamforming environment. In some examples, a group of antenna elements used to transmit a composite signal may be referred to as transmitting antenna 512-1, and a group of antenna elements used to receive a composite signal may be referred to as receiving antenna 514-1. In some examples, each antenna is equipped with its own transmission and receive paths, which may be alternately switched to connect to the antenna depending on whether the antenna is operating as transmitting antenna 512-1 or receiving antenna 514-1.

In an implementation, sensing agent 516-1 may be responsible for causing sensing receiver 502-1 to receive sensing transmissions and associated sensing measurement parameters and/or transmission parameters, to calculate sensing measurements. In examples, sensing agent 516-1 may be responsible for processing sensing measurements to fulfill a sensing goal. In some implementations, receiving sensing transmissions and optionally associated sensing measurement parameters and/or transmission parameters, and calculating sensing measurements may be carried out by sensing agent 516-1 running in the medium access control (MAC) layer of sensing receiver 502-1 and processing sensing measurements to fulfill a sensing goal may be carried out by an algorithm running in the application layer of sensing receiver 502-1, for example sensing algorithm 518-1. In examples, a sensing algorithm 518-1 running in the application layer of sensing receiver 502-1 may be known as a Wi-Fi sensing agent, a sensing application, or sensing algorithm. In examples, sensing algorithm 518-1 may include and/or execute sensing agent 516-1. According to some implementations, sensing agent 516-1 may include and/or execute sensing algorithm 518-1. In some implementations, sensing agent 516-1 running in the MAC layer of sensing receiver 502-1 and sensing algorithm 518-1 running in the application layer of sensing receiver 502-1 may run separately on processor 508-1. In an implementation, sensing agent 516-1 may pass one or more of sensing measurement parameters, transmission parameters, or physical layer parameters (e.g., such as channel representation information, examples of which are CSI and TD-CRI) between the MAC layer of sensing receiver 502-1 and the application layer of sensing receiver 502-1. In an example, sensing agent 516-1 in the MAC layer or sensing algorithm 518-1 in the application layer may operate on physical layer parameters, for example to detect one or more features of interest. In examples, sensing algorithm 518-1 may form services or features, which may be presented to an end-user. According to an implementation, communication between the MAC layer of sensing receiver 502-1 and other layers or components of sensing receiver 502-1 (including the application layer) may take place based on communication interfaces, such as an MLME interface and a data interface. In examples, sensing agent 516-1 may be configured to determine a number and timing of sensing transmissions and sensing measurements for the purpose of Wi-Fi sensing. In some implementations, sensing agent 516-1 may be configured to transmit sensing measurements to plurality of sensing transmitters 504-(1-N) and/or remote processing device 506 for further processing. In an implementation, sensing agent 516-1 may be configured to cause at least one transmitting antenna of transmitting antenna(s) 512-1 to transmit messages to one or more of plurality of sensing transmitters 504-(1-N) or to remote processing device 506. Further, sensing agent 516-1 may be configured to receive, via at least one receiving antenna of receiving antennas(s) 514-1, messages from one or more of plurality of sensing transmitters 504-(1-N) or from remote processing device 506. In an example, sensing agent 516-1 may be configured to make sensing measurements based on sensing transmissions received from one or more of plurality of sensing transmitters 504-(1-N).

In examples, sensing receiver 502-1 may include timestamp generation block 524-1. In an implementation, timestamp generation block 524-1 may be coupled to processor 508-1 and memory 510-1. In some embodiments, timestamp generation block 524-1 amongst other units, may include routines, programs, objects, components, data structures, etc., which may perform particular tasks or implement particular abstract data types. Timestamp generation block 524-1 may also be implemented as, signal processor(s), state machine(s), logic circuitries, and/or any other device or component that manipulate signals based on operational instructions.

In some embodiments, timestamp generation block 524-1 may be implemented in hardware, instructions executed by a processing unit, or by a combination thereof. The processing unit may comprise a computer, a processor, a state machine, a logic array or any other suitable devices capable of processing instructions. The processing unit may be a general-purpose processor that executes instructions to cause the general-purpose processor to perform the required tasks or, the processing unit may be dedicated to performing the required functions. In some embodiments, timestamp generation block 524-1 may be machine-readable instructions that, when executed by a processor/processing unit, perform any of desired functionalities. The machine-readable instructions may be stored on an electronic memory device, hard disk, optical disk or other machine-readable storage medium or non-transitory medium. In an implementation, the machine-readable instructions may also be downloaded to the storage medium via a network connection. In an example, machine-readable instructions may be stored in memory 510-1.

Referring again to FIG. 5, first sensing receiver 502-1 may include TSF timer 523-1 (also referred to as an OBSS STA TSF timer). In an implementation, TSF timer 523-1 may be a local timer/clock in first sensing receiver 502-1. In an example, TSF timer 523-1 may be based on a 1 MHz clock and may tick in time units (TU), where 1 TU is equal to 1.024 microseconds. In examples, TSF timer 523-1 may be represented by an 8-octet (64 bit) register [63:0] that is incremented every microseconds.

According to an implementation, first sensing receiver 502-1 may further include sensing transmitter information storage 521-1 and sensing measurements storage 520-1. In an implementation, sensing transmitter information storage 521-1 may store information related to plurality of sensing transmitters 504-(1-N). In examples, sensing transmitter information storage 521-1 may store information related to TSF timers associated with one or more of one or more of plurality of sensing transmitters 504-(1-N). First sensing receiver 502-1 may further include resynchronization timers 526-(1-N) associated with one or more of one or more of plurality of sensing transmitters 504-(1-N). In an example, sensing transmitter information storage 521-1 may store local timing information. In some examples, sensing transmitter information storage 521-1 may store timer offset value. In an implementation, sensing measurements storage 520-1 may store sensing measurements computed by first sensing receiver 502-1 based on sensing transmissions received from one or more of plurality of sensing transmitters 504-(1-N). Information stored in sensing transmitter information storage 521-1 and sensing measurements storage 520-1 may be periodically or dynamically updated as required. In some embodiments, sensing receiver 502-1 may include sensing measurement parameters storage 522-1. In an implementation, sensing measurement parameters storage 522-1 may store sensing measurement parameters and/or transmission parameters applicable to one or more sensing measurement setups. In an implementation, sensing measurement parameters storage 522-1 may store sensing measurement parameters and/or transmission parameters applicable to one or more sensing measurement sessions. In an implementation, sensing measurement parameters storage 522-1 may store sensing measurement parameters and/or transmission parameters applicable to one or more sensing measurement instances. In an example, sensing measurement parameters and/or transmission parameters stored in sensing measurement parameters storage 522-1 may be periodically or dynamically updated as required. In an implementation, sensing transmitter information storage 521-(1-N), may store information for one or more of plurality of sensing transmitters 504-(1-N) from which sensing receiver 502-1 is receiving sensing transmissions from. Information stored in sensing transmitter information storage 521-(1-N) may be periodically or dynamically updated as required. In an implementation, sensing transmitter information storage 521-(1-N) may include any type or form of storage, such as a database or a file system coupled to memory 510-1. In some embodiments, sensing measurements storage 520-1, and/or sensing measurement parameters storage 522-1 may include any type or form of storage, such as a database or a file system coupled to memory 510-1.

Referring again to FIG. 5, first sensing transmitter 504-1 may include processor 528-1 and memory 530-1. For example, processor 528-1 and memory 530-1 of first sensing transmitter 504-1 may be processor 114 and memory 116, respectively, as shown in FIG. 1. In an embodiment, first sensing transmitter 504-1 may further include transmitting antenna(s) 532-1, receiving antenna(s) 534-1, and sensing agent 536-1. In an implementation, sensing agent 536-1 may be a block that passes physical layer parameters from the MAC of first sensing transmitter 504-1 to application layer programs. Sensing agent 536-1 may be configured to cause at least one transmitting antenna of transmitting antenna(s) 532-1 and at least one receiving antenna of receiving antennas(s) 534-1 to exchange messages with one or more of plurality of sensing receivers 502-(1-M).

In an implementation, sensing agent 536-1 may be responsible for causing sensing transmitter 504-1 to send sensing transmissions and, in examples, receive associated sensing measurements from one or more of plurality of sensing receivers 502-(1-M). In examples, sensing agent 536-1 may be responsible for processing sensing measurements to fulfill a sensing goal. In some implementations, sensing agent 536-1 may run in the medium access control (MAC) layer of sensing transmitter 504-1 and processing sensing measurements to fulfill a sensing goal may be carried out by sensing algorithm 538-1, which in examples may run in the application layer of sensing transmitter 504-1. In examples, sensing algorithm 538-1 running in the application layer of sensing transmitter 504-1 may be known as a Wi-Fi sensing agent, a sensing application, or a sensing algorithm. In examples, sensing algorithm 538-1 may include and/or execute sensing agent 536-1. According to some implementations, sensing agent 536-1 may include and/or execute sensing algorithm 538-1. In some implementations, sensing agent 536-1 may run in the MAC layer of sensing transmitter 504-1 and sensing algorithm 538-1 may run in the application layer of sensing transmitter 504-1. In some implementations, sensing agent 536-1 of sensing transmitter 504-1 and sensing algorithm 538-1 may run separately on processor 528-1. In an implementation, sensing agent 536-1 may pass sensing measurement parameters, transmission parameters, or physical layer parameters between the MAC layer of sensing transmitter 504-1 and the application layer of sensing transmitter 504-1. In an example, sensing agent 536-1 in the MAC layer or sensing algorithm 538-1 in the application layer may control physical layer parameters, for example physical layer parameters used to generate one or more sensing transmissions. In examples, sensing algorithm 538-1 may form services or features, which may be presented to an end-user. According to an implementation, communication between the MAC layer of sensing transmitter 504-1 and other layers or components of sensing transmitter 504-1 (including the application layer) may take place based on communication interfaces, such as an MLME interface and a data interface. In examples, sensing agent 536-1 may be configured to determine a number and timing of sensing transmissions for the purpose of Wi-Fi sensing. In some implementations, sensing agent 536-1 may be configured to cause sensing transmitter 504-1 to transmit sensing transmissions to one or more of plurality of sensing receivers 502-(1-M). In an implementation, sensing agent 536-1 may be configured to cause at least one transmitting antenna of transmitting antenna(s) 532-1 to transmit messages to one or more of plurality of sensing receivers 502-(1-M) or to remote processing device 506. Further, sensing agent 536-1 may be configured to receive, via at least one receiving antenna of receiving antennas(s) 534-1, messages from one or more of plurality of sensing receivers 502-(1-M) or from remote processing device 506.

In some embodiments, an antenna may be used to both transmit and receive in a half-duplex format. When the antenna is transmitting, it may be referred to as transmitting antenna 512-1/532-1, and when the antenna is receiving, it may be referred to as receiving antenna 514-1/534-1. It is understood by a person of normal skill in the art that the same antenna may be transmitting antenna 512-1/532-1 in some instances and receiving antenna 514-1/534-1 in other instances. In the case of an antenna array, one or more antenna elements may be used to transmit or receive a signal, for example, in a beamforming environment. In some examples, a group of antenna elements used to transmit a composite signal may be referred to as transmitting antenna 512-1/532-1, and a group of antenna elements used to receive a composite signal may be referred to as receiving antenna 514-1/534-1. In some examples, each antenna is equipped with its own transmission and receive paths, which may be alternately switched to connect to the antenna depending on whether the antenna is operating as transmitting antenna 512-1/532-1 or receiving antenna 514-1/534-1.

Referring again to FIG. 5, first sensing transmitter 504-1 may include TSF timer 543-1. In an implementation, TSF timer 543-1 (also referred to as an OBSS AP TSF timer) may be a local timer/clock in first sensing transmitter 504-1. In an example, TSF timer 543-1 may be based on a 1 MHz clock and may tick in TU, where 1 TU is equal to 1.024 microseconds. In examples, TSF timer 543-1 may be represented by an 8-octet (64 bit) register [63:0] that is incremented every microseconds. In an embodiment, first sensing transmitter 504-1 may include plurality of resynchronization timers 546-(1-M) corresponding to plurality of sensing receivers 502-(1-M). In an example, first resynchronization timer 546-1 may correspond to first sensing receiver 502-1, second resynchronization timer 546-2 may correspond to second sensing receiver 502-2, and so on. According to an implementation, first sensing transmitter 504-1 may further include sensing receiver information storage 541-(1-M). In an implementation, sensing receiver information storage 541-(1-M) may store information for one or more of plurality of sensing receivers 502-(1-M) that it is sending sensing transmissions to. Information stored in sensing receiver information storage 541-(1-M) may be periodically or dynamically updated as required. In an implementation, sensing receiver information storage 541-(1-M) may include any type or form of storage, such as a database or a file system coupled to memory 530-1.

In some embodiments, sensing transmitter 504-1 may include sensing measurement parameters storage 542-1. In an implementation, sensing measurement parameters storage 542-1 may store sensing measurement parameters and/or transmission parameters applicable to one or more sensing measurement sessions. In an implementation, sensing measurement parameters storage 542-1 may store sensing measurement parameters and/or transmission parameters applicable to one or more sensing measurement setups. In an implementation, sensing measurement parameters storage 542-1 may store sensing measurement parameters and/or transmission parameters applicable to one or more sensing measurement instances. In an example, sensing measurement parameters and/or transmission parameters stored in sensing measurement parameters storage 542-1 may be periodically or dynamically updated as required. In an implementation, sensing measurements storage 540-1 and sensing measurement parameters storage 542-1 may include any type or form of storage, such as a database or a file system or coupled to memory 530-1.

Referring again to FIG. 5, remote processing device 506 may include processor 548 and memory 550. For example, processor 548 and memory 550 of remote processing device 506 may be processor 114 and memory 116, respectively, as shown in FIG. 1. In an embodiment, remote processing device 506 may further include transmitting antenna(s) 552, receiving antenna(s) 554, sensing agent 556, and sensing algorithm, 558. In some embodiments, an antenna may be used to both transmit and receive signals in a half-duplex format. When the antenna is transmitting, it may be referred to as transmitting antenna 552, and when the antenna is receiving, it may be referred to as receiving antenna 554. It is understood by a person of normal skill in the art that the same antenna may be transmitting antenna 552 in some instances and receiving antenna 554 in other instances. In the case of an antenna array, one or more antenna elements may be used to transmit or receive a signal, for example, in a beamforming environment. In some examples, a group of antenna elements used to transmit a composite signal may be referred to as transmitting antenna 552, and a group of antenna elements used to receive a composite signal may be referred to as receiving antenna 554. In some examples, each antenna is equipped with its own transmission and receive paths, which may be alternately switched to connect to the antenna depending on whether the antenna is operating as transmitting antenna 552 or receiving antenna 554.

In an implementation, sensing agent 556 may be responsible for determining sensing measurement parameters and/or transmission parameters for one or more sensing measurement setups. In examples, sensing agent 556 may receive sensing measurement parameters and/or transmission parameters for one or more sensing measurement setups from sensing algorithm 558. In an example, sensing agent 556 may receive sensing measurements from one or more of plurality of sensing receivers 502-(1-M) and may process the sensing measurements to fulfill a sensing goal. In an example, sensing agent 556 may receive channel representation information (such as CSI or TD-CRI) from one or more of plurality of sensing receivers 502-(1-M) and may process the channel representation information to fulfill a sensing goal. In implementations, sensing agent 556 may receive sensing measurements or channel representation information and may provide the received sensing measurements or channel representation information to sensing algorithm 558, and sensing algorithm 558 may receive the sensing measurements or channel representation information from sensing agent 556 and may process the information to fulfill a sensing goal.

In some implementations, receiving sensing measurements may be carried out by an algorithm running in the medium access control (MAC) layer of remote processing device 506 and processing sensing measurements to fulfill a sensing goal may be carried out by an algorithm running in the application layer of remote processing device 506. In examples, the algorithm running in the application layer of remote processing device 506 may be known as a Wi-Fi sensing agent, a sensing application, or sensing algorithm. In some implementations, the algorithm running in the MAC layer of remote processing device 506 and the algorithm running in the application layer of remote processing device 506 may run separately on processor 548. In an implementation, sensing agent 556 may pass physical layer parameters (e.g., such as channel representation information, examples of which are CSI and TD-CRI) from the MAC layer of remote processing device 506 to the application layer of remote processing device 506 and may use the physical layer parameters to detect one or more features of interest. In an example, the application layer may operate on the physical layer parameters and form services or features, which may be presented to an end-user. According to an implementation, communication between the MAC layer of remote processing device 506 and other layers or components of remote processing device 506 may take place based on communication interfaces, such as an MLME interface and a data interface. According to some implementations, sensing agent 556 may include/execute a sensing algorithm 558. In an implementation, sensing agent 556 may process and analyze sensing measurements using sensing algorithm 558 and identify one or more features of interest. Further, sensing agent 556 may be configured to determine a number and timing of sensing transmissions and sensing measurements for the purpose of Wi-Fi sensing. In some implementations, sensing agent 556 may be configured to cause one or more of plurality of sensing transmitters 504-(1-N) to transmit sensing measurements to one or more of plurality of sensing transmitters 502-(1-M).

Referring back to FIG. 5, according to one or more implementations, Wi-Fi sensing system 500 may participate in a sensing session. In examples, a sensing session is an agreement between a sensing initiator and a sensing responder to participate in a WLAN sensing procedure (also known as a Wi-Fi sensing procedure.) In examples, sensing measurement parameters associated with a sensing session may be determined by a sensing initiator and may be exchanged between the sensing initiator and a sensing responder. In examples, sensing initiator may be sensing transmitter 504-1 and sensing responder may be sensing receiver 502-1. In examples, sensing initiator may be sensing receiver 502-1 and sensing responder may be sensing transmitter 504-1. In examples, sensing initiator may be remote processing device 506, and both sensing transmitter 504-1 and sensing receiver 502-1 are sensing responders. In examples, sensing transmitter 504-1 may participate in multiple sensing sessions either as a sensing initiator or as a sensing responder. In examples, sensing receiver 502-1 may participate in multiple sensing sessions either as a sensing initiator or as a sensing responder. In examples, remote processing device may participate in multiple sensing sessions as a sensing initiator.

According to one or more implementations, communications in network 560 may be governed by one or more of the 802.11 family of standards developed by IEEE. Some example IEEE standards may include IEEE 802.11-2020, IEEE 802.11ax-2021, IEEE 802.11me, IEEE 802.11az, and IEEE 802.11be. IEEE 802.11-2020 and IEEE 802.11ax-2021 are fully-ratified standards whilst IEEE 802.11me reflects an ongoing maintenance update to the IEEE 802.11-2020 standard and IEEE 802.11be defines the next generation of standard. IEEE 802.11az is an extension of the IEEE 802.11-2020 and IEEE 802.11ax-2021 standards, adding new functionality. In some implementations, communications may be governed by other standards (other or additional IEEE standards or other types of standards). In some embodiments, parts of network 560 which are not required by system 500 to be governed by one or more of the 802.11 family of standards may be implemented by an instance of any type of network, including wireless network or cellular network. Further, IEEE 802.11ax included OFDMA, which allows sensing receiver 502 to simultaneously transmit data to all participating devices, such as plurality of sensing transmitters 504-(1-N), and vice versa using a single transmission opportunity (TXOP). The efficiency of OFDMA depends on how sensing receiver 502 schedules channel resources (interchangeably referred to as RUs) among plurality of sensing transmitters 504-(1-N) and configures transmission parameters. According to an implementation, system 500 may be an OFDMA enabled system.

### C. Systems and Methods for Time Synchronization of Sensing Measurements Made Out of BSS

The present disclosure generally relates to systems and methods for Wi-Fi sensing. In particular, the present disclosure relates to systems and methods for time synchronization of sensing measurements made out of basic service set (OBSS).

A Wi-Fi sensing system may be configured to detect features of interest in a sensing space. The Wi-Fi sensing system may be a network of Wi-Fi-enabled devices which are part of an IEEE 802.11 network (sometimes referred to as a basic service set (BSS) or extended service set (ESS)). The features of interest may include motion of objects and motion tracking, presence detection, intrusion detection, gesture recognition, fall detection, breathing rate detection, and other applications. The sensing space may refer to any physical space in which a Wi-Fi sensing system may operate and may include a place of abode, a place of work, a shopping mall, a sports hall or sports stadium, a garden, or any other physical space.

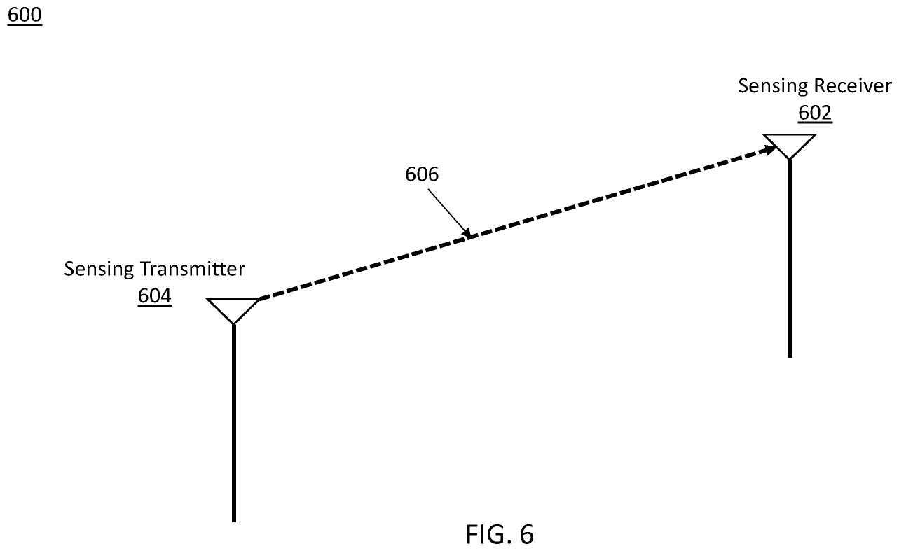

A typical Wi-Fi sensing system includes a sensing transmitter (which may be a station (STA) or an access point (AP)) and a sensing receiver (which is an AP if the sensing transmitter is a STA, and a STA if the sensing transmitter is an AP). Example representation 600 of a typical Wi-Fi sensing system is depicted in FIG. 6, according to some embodiments. As described in FIG. 6, the Wi-Fi sensing system includes sensing receiver 602 and sensing transmitter 604. Sensing receiver 602 may be an example of sensing receiver 502-1. Sensing transmitter 604 may be an example of sensing transmitter 504-1. Further, sensing transmission 606 is made from sensing transmitter 604 to sensing receiver 602 as shown in FIG. 6. Sensing receiver 602 may perform a sensing measurement on sensing transmission 606.

A timing synchronization function (TSF) is specified in IEEE 802.11 to fulfill timing synchronization amongst various devices. In examples, a TSF keeps TSF timers for all STAs in the same BSS synchronized. A STA maintains a local TSF timer which is synchronized with an AP TSF timer of the AP with which the STA is associated. Referring to FIG. 5, sensing receivers 502-(1-M) maintain corresponding local TSF timers 523-(1-M), which are incremented according to oscillators of sensing receivers 502-(1-M), such as local crystal oscillators or voltage controlled oscillators.

According to an implementation, pre-association security negotiation (PASN) may be a robust security network (RSN) association authentication protocol in scenarios where it relies on the existence of a pairwise master key security association (PMKSA) for an authentication and key management (AKM). PASN was introduced in IEEE 802.11az and allowed a pre-association encrypted exchange between a STA and an AP.

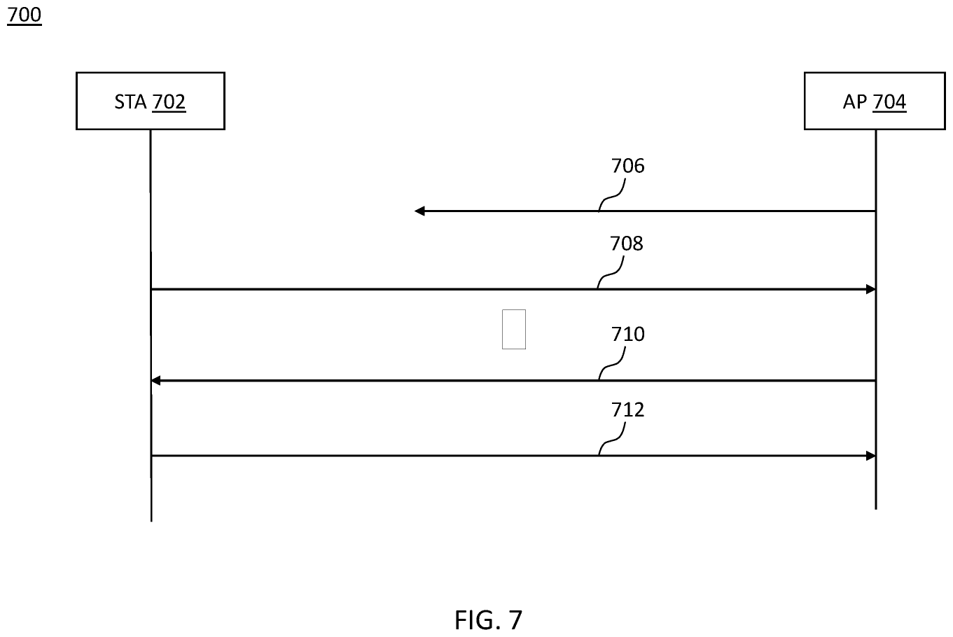

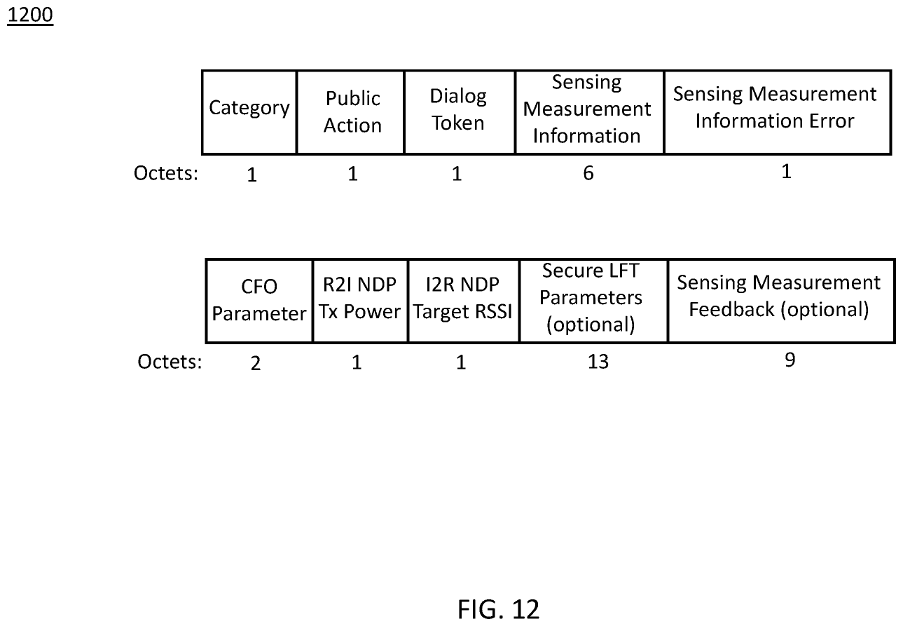

FIG. 7 depicts process 700 for PASN authentication, according to some embodiments. FIG. 7 is a reproduction of FIG. 12-55a from Draft P802.11az_D4.1. In FIG. 7, STA 702 may be a supplicant and AP 704 may be an authenticator. In an implementation, AP 704 may indicate that it is capable of performing PASN authentication by including the PASN AKM as part of the RSN element (RSNE) included in beacon frames and probe response frames.

At step 706 of process 700, AP 704 may send Beacon (RSNE (PASN AKM, Base AKM), [RSNXE]). At step 708 of process 700, STA 702 may send 802.11 Authentication (1, PASN, RSNE (Base AKM, PMKID [0 . . . n]), [RSNXE], S-Ephemeral Pub, PASN Parameters, Base AKM Data-1) to AP 704. At step 710 of process 700, AP 704 may send 802.11 Authentication (2, PASN, RSNE (Base AKM, PMKID [0 . . . n]), [RSNXE], A-Ephemeral Pub, PASN Parameters, Base AKM Data-2, MIC) to STA 702. At step 712 of process 700, STA 702 may send 802.11 Authentication (3, Base AKM Data-3, MIC) to AP 704.

In an implementation, three PASN frames may be constructed, namely a first PASN frame, a second PASN frame, and a third PASN frame. The first PASN frame may be sent from a STA to an AP. If the STA initiates PASN authentication, then the STA may first select the authentication parameters and may then compose an RSNE. The STA may send the first PASN frame to the AP. Upon receiving the first PASN frame, the AP may begin the construction of the second PASN frame and when complete, the AP may send the second PASN frame to the STA. Upon receiving the second PASN frame, the STA may begin the construction of the third PASN frame and when complete, the STA may send the third PASN frame to the AP and then install the temporal key derived using the MLME-SETKEYS.request primitive. The AP may install the temporal key derived using the MLME-SETKEYS.request primitive. Currently, PASN procedures may be used for ranging of unassociated STAs (as described in Draft P802.11az_D4.1).

According to an implementation, an out of BSS (OBSS) scenario may refer to a scenario where an AP (also referred to as OBSS AP which is an example of sensing transmitter 504-1) and a STA (also referred to as OBSS STA which is an example of sensing receiver 502-1) are not associated with one another. In examples, in the OBSS scenario, a TSF timer of the OBSS AP (543-1) and a TSF timer of the OBSS STA (523-1) may not be time aligned. As a result, the OBSS AP 504-1 and the OBSS STA 502-1 may be time unsynchronized.

In an implementation, if a sensing initiator is a sensing transmitter (i.e., an AP, such as sensing transmitter 504-1), then sensing transmitter may send a sensing transmission to a sensing receiver (i.e., an STA such as sensing receiver 502-1) and sensing receiver 502-1 may perform a sensing measurement on the sensing transmission. In some examples, sensing receiver 502-1 may be required to associate a timestamp with the sensing measurement and then to report the timestamped sensing measurement back to sensing transmitter 504-1. In scenarios where sensing receiver 502-1 is an OBSS STA and sensing transmitter 504-1 is an OBSS AP, a local clock of the sensing receiver (also referred to as an OBSS STA TSF timer which is an example of TSF timer 523-1) may not be synchronized to a local clock of the sensing transmitter (also referred to as an OBSS AP TSF timer which is an example of TSF timer 543-1). Furthermore, if there are more than one OBSS STA (such as sensing receivers 502-(1-M) which are in different BSSs then there may be more than one OBSS STA sensing receivers TSF timer (for example, of 523-(1-M) that is not synchronized with the OBSS AP TSF timer 543-1 of sensing transmitter 504-1.

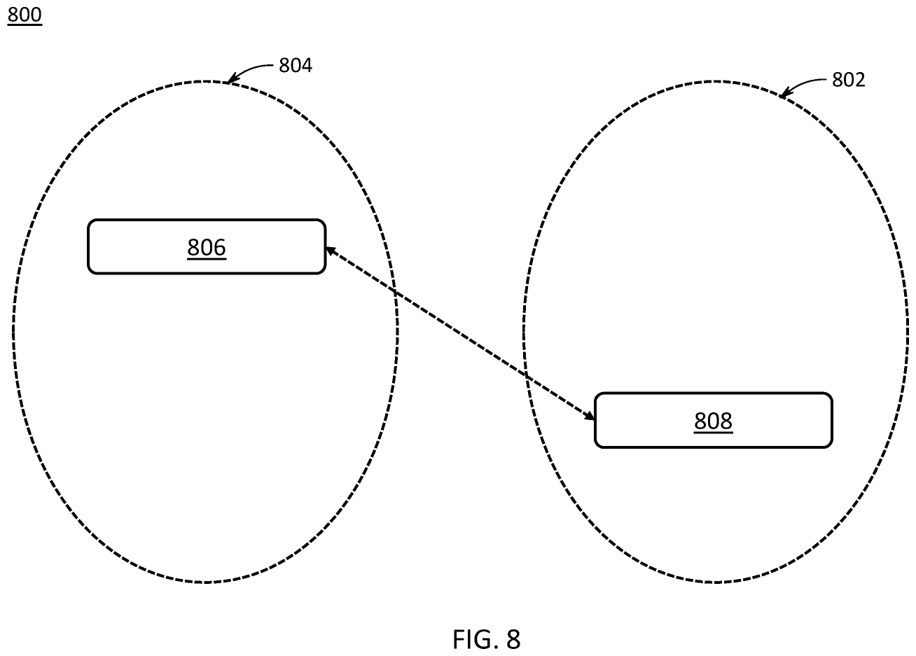

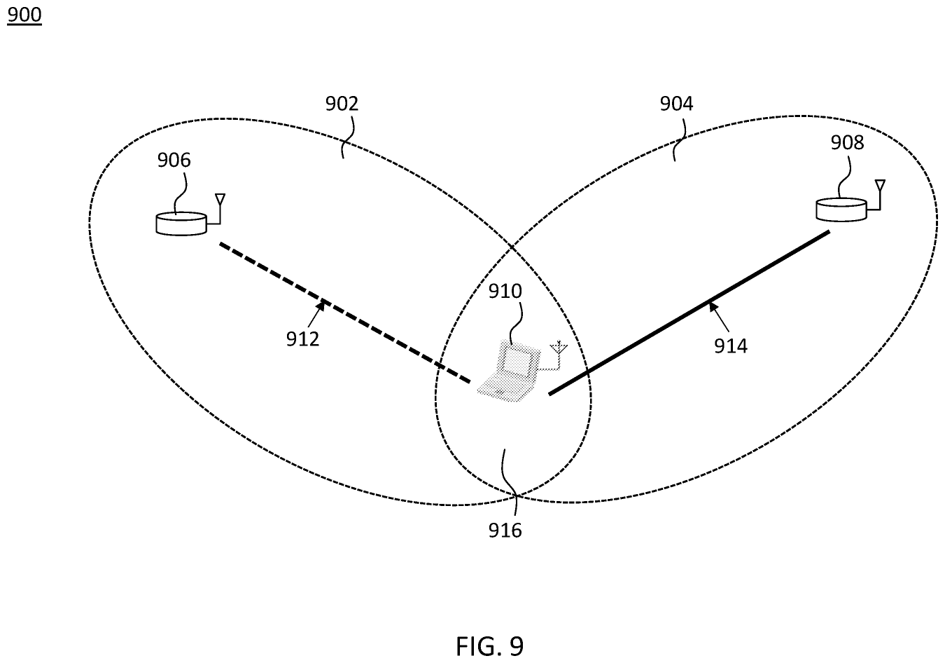

FIG. 8 depicts example 800 of a TSF timer unsynchronized situation, according to some embodiments. Sensing receiver 502-1 which is an OBSS STA is depicted in FIG. 8 as 802, and sensing transmitter 504-1 which is an OBSS AP is depicted in FIG. 8 as 804. As described in FIG. 8, TSF timer 543-1 which is depicted in FIG. 8 as 806 of OBSS AP 804 (sensing transmitter 504-1) and TSF timer 523-1 which is depicted in FIG. 9 as 808 of unassociated OBSS STA 802 (sensing receiver 502-1) are unsynchronized. Additionally, when OBSS STA 802 (sensing receiver 502-1) is required to receive a sensing transmission from OBSS AP 804 (sensing transmitter 504-1), then in some scenarios, OBSS STA 802 (sensing receiver 502-1) may change channels to receive the sensing transmission. As OBSS STA 802 (sensing receiver 502-1) and OBSS AP 804 (sensing transmitter 504-1) may not be synchronized, there may be a margin for error in the timing of the channel change, the sensing transmission reception, and channel change back (to the original channel). Therefore, a robust time synchronization mechanism between an OBSS STA (sensing receiver 502-1) and an OBSS AP (sensing transmitter 504-1) is required.

The present disclosure describes a solution for an OBSS STA (which is an example of sensing receiver 502-1) where the OBSS STA is not associated with, and therefore not time synchronized to, an OBSS AP (which is an example of sensing transmitter 504-1) to create and maintain a local version of a clock/timer of the OBSS AP (for example, TSF timer 543-1 of sensing transmitter 504-1). The local version of the TSF timer 543-1 for sensing transmitter 504-1 may be stored by sensing receiver 502-1 in sensing transmitter information storage 521-1 which may be configured to store information related to sensing transmitter 504-1. The local version of the TSF timer 543-1 may be referred to as an OBSS STA-AP TSF Timer for sensing transmitter 504-1. Maintaining the OBSS STA-AP TSF Timer for sensing transmitter 504-1 which is the OBSS AP enables sensing receiver 502-1 which is the OBSS STA to participate as sensing receiver 502-1 in a sensing session with the OBSS AP which is sensing transmitter 504-1. In examples, the OBSS STA (sensing receiver 502-1) makes a sensing measurement on a sensing transmission from the OBSS AP (sensing transmitter 504-1) and applies a timestamp to the sensing measurement based on the OBSS STA-AP TSF Timer for sensing transmitter 504-1, rather than the TSF timer 523-1 of the OBSS STA which is sensing receiver 502-1. As a result, the sensing measurement calculated by the OBSS STA (sensing receiver 502-1) has an accurate time reference with respect to the OBSS AP (sensing transmitter 504-1).

For ease of explanation and understanding, the description provided below is with reference to first sensing receiver 502-1 and first sensing transmitter 504-1, however, the description is equally applicable to remaining sensing receivers 502-(2-M) and remaining sensing transmitters 504-(2-N).

According to an implementation, first sensing receiver 502-1 (which is an OBSS STA) may obtain timing information from an unassociated access point (sensing transmitter 504-1) not associated with first sensing receiver 502-1 and operating as a sensing transmitter. In an example, the timing information may be an access point TSF timer of the unassociated access point, that is TSF Timer 543-1 of sensing transmitter 504-1. Further, the timing information may be received in a beacon frame broadcast by the sensing transmitter 504-1. In examples, sensing transmitter 504-1 may be referred to as an OBSS AP. Further, the timing information may be TSF timer 538-1 (also referred to as OBSS AP TSF timer).

In some implementations, sensing agent 516-1 or sensing algorithm 518-1 may determine a timer offset value according to a difference between the TSF timer 538-1 of sensing transmitter 504-1 and TSF timer 523-1 of sensing receiver 502-1. TSF timer 532-1 may also referred to as OBSS STA TSF timer of first sensing receiver 502-1. Further, timestamp generation block 524-1 of sensing receiver 502-1 may be configured to determine a timestamp by combining TSF timer 523-1 with the timer offset value.

In an implementation, sensing agent 516-1 or sensing algorithm 518-1 may generate local timing information according to the timing information. In an example, the local timing information may be a local version of the OBSS AP TSF timer 543-1. In some examples, the local timing information may be a timer offset value determined according to the difference between the timing information and TSF timer 523-1. In examples, the timing information may be stored as the local timing information. In an example, the local timing information associated with TSF timer 543-1 of sensing transmitter 504-1 may be stored in sensing transmitter information storage 521-1.

According to an implementation, first sensing transmitter 504-1 may broadcast a beacon frame, for example, every 100 ms. The format of the beacon frame is described in Draft P802.11REVmd_D5.0 section 9.3.3.2-“Beacon frame format”. In an example, first information field of the beacon frame may be a timestamp field. The timestamp field may represent the TSF timer 543-1 of sensing transmitter 504-1. In an implementation, first sensing receiver 502-1 may receive the beacon frame which announces first sensing transmitter 504-1.

In some embodiments, first sensing receiver 502-1 may obtain additional timing information (for example, TSF timers 543-(2-N) from a plurality of additional unassociated access points (for example, from one or more of remaining sensing transmitters 504-(2-N)) and generate additional local timing information according to the additional timing information. In examples, sensing receiver may store the additional local timing information corresponding to sensing transmitters 504-(2-N) in sensing transmitter information storage 521-(2-N). According to an implementation, one or more of remaining sensing transmitters 504-(2-N) may broadcast beacon frames. In an implementation, first sensing receiver 502-1 may receive one or more beacon frames which announce one or more of remaining sensing transmitters 504-(2-N). In an example, the one or more beacon frames of one or more of remaining sensing transmitters 504-(2-N) may include a full TSF timers 543-(2-N) (64 bits) that reflects TSF timers of one or more of remaining sensing transmitters 504-(2-N). In an implementation, first sensing receiver 502-1 may store local timing information (corresponding to TSF timers 543-(2-N)) of one or more remaining sensing transmitters 504-(2-N) received in the one or more beacon frames in sensing transmitter information storage 521-(2-N). In some implementations, first sensing receiver 502-1 may calculate and store timer offset values for the one or more remaining sensing transmitters 504-(2-N) in sensing transmitter information storage 521-(2-N).

In examples, first sensing receiver 502-1 may have stored identifiers of one or more of plurality of sensing transmitters 504-(1-N). An example of an identifier of a sensing transmitter 504-1 is a service set identifier or (SSID). In an implementation, first sensing receiver 502-1 may transmit a probe request. In an example, the probe request may include at least one identifier of the one or more of plurality of sensing transmitters 504-(1-N). Further, first sensing receiver 502-1 may receive a probe response. In an example, the probe response may include at least one response from one or more of plurality of sensing transmitters 504-(1-N) associated with the at least one identifier. In an example, a probe response from sensing transmitter 504-1 may include a TSF timer 543-1 of sensing transmitter 504-1, where the probe response is transmitter from sensing transmitter 504-1 to sensing receiver 502-1 responsive to receiving the probe request from sensing receiver 502-1 including identifier of sensing transmitter 504-1.

In some examples, the probe request may include an access point identification wildcard (such as service set identifiers (SSID) wildcard), in which case any of sensing transmitter 504-(1-N) may respond with a probe response.

In an implementation, first sensing receiver 502-1 may store local timing information associated with TSF timers 543-(1-N) of the one or more of plurality of sensing transmitters 504-(1-N) received in probe responses, in sensing transmitter information storage 521-(1-N). In some implementations, first sensing receiver 502-1 may calculate and store timer offset values for the one or more of plurality of sensing transmitters 504-(1-N) in sensing transmitter information storage 521-(1-N).

According to an implementation, by generating and storing the local timing information associated with first sensing transmitter 504-1 (i.e., the local version of TSF timer 543-1 (OBSS STA-AP TSF timer)) or by calculating the timer offset value for first sensing transmitter 504-1, first sensing receiver 502-1 completes the process of initial synchronization with first sensing transmitter 504-1. According to an implementation, first sensing receiver 502-1 may increment the local timing information according to a local clock (for example, a crystal oscillator or a voltage controlled oscillator (VCO)). In an example, first sensing receiver 502-1 may increment TSF timer 523-1 and the local timing information associated with one or more of plurality of sensing transmitters 504-(1-N) according to its VCO.

In an implementation, a synchronization flag associated with first sensing transmitter 504-1 may be set by first sensing receiver 502-1 to indicate that first sensing receiver 502-1 has valid local timing information or a valid timer offset value associated with first sensing transmitter 504-1. In examples, first sensing transmitter 504-1 may set a synchronization flag associated with first sensing receiver 502-1 when first sensing receiver 502-1 sends a first SENS-CTS-to-Self frame, which in examples indicates that first sensing receiver 502-1 has valid local timing information or a valid timer offset value associated with first sensing transmitter 504-1. In some examples, first sensing transmitter 504-1 may set a synchronization flag associated with first sensing receiver 502-1 when first sensing receiver 502-1 sends a first sensing measurement report with an associated timestamp, which in examples indicates that first sensing receiver 502-1 has valid local timing information or a valid timer offset value associated with first sensing transmitter 504-1. In examples, upon setting a synchronization flag associated with first sensing receiver 502-1, sensing transmitter 504-1 may start resynchronization timer 546-1 associated with first sensing receiver 502-1. In examples, resynchronization timer 546-1 associated with first sensing receiver 502-1 may indicate to first sensing transmitter 504-1 when a resynchronization task for first sensing receiver 502-1 is required. A resynchronization task for first sensing receiver 502-1 may involve sending a portion or all of TSF timer 543-1 to sensing receiver 502-1.

According to an implementation, upon completion of the process of initial synchronization with first sensing transmitter 504-1, first sensing receiver 502-1 may start resynchronization timer 526-1 associated with local timing information or a timer offset of first sensing transmitter 504-1. In examples, resynchronization timer 526-1 associated with local timing information or a timer offset of first sensing transmitter 504-1 may indicate to first sensing receiver 502-1 when a resynchronization task for first sensing transmitter 504-1 should run. A resynchronization task is the process of updating the local timing information for sensing transmitter 504-1 with information associated with TSF timer 543-1 of sensing transmitter 504-1.

According to an implementation, upon completion of the process of initial synchronization with first sensing transmitter 504-1 and considering a scenario where first sensing receiver 502-1 is not associated with any other sensing transmitter 502-(2-N), first sensing receiver 502-1 may tune first sensing receiver 502-1 to a channel on which the beacon frame was received from sensing transmitter 502-1 for further communications from first sensing transmitter 504-1 (for example, pre-association security negotiation (PASN) or sensing measurement exchanges). Sensing receiver 502-1 may using local timing information associated with sensing transmitter 504-1 to determine when to power up the receiver circuitry of sensing receiver 502-1 and receive transmissions from sensing transmitter 504-1, for example to minimize unnecessary time spent with receiver circuitry powered on, which may for example consume battery power.

In some scenarios, first sensing receiver 502-1 may be associated with second sensing transmitter 504-2 operating on the same channel on which the beacon frame was received from first sensing transmitter 504-1. In an example, sensing transmitter 504-2 may be any device other than first sensing transmitter 504-1 (i.e., from amongst remaining sensing transmitters 504-(2-N), examples of which are second sensing transmitter 504-2 or third sensing transmitter 504-3, etc.). Further, in some scenarios, first sensing receiver 502-1 may be associated with one of plurality of sensing transmitters 504-(1-N) operating on a different channel than the channel on which the beacon frame was received from first sensing transmitter 504-1.

FIG. 9 depicts example 900 of communications between a STA 910 which is an example of sensing receiver 502-1, an associated access point 908 (sensing transmitter 504-2) of BSS 904, and an unassociated access point 906 (sensing transmitter 504-1) of BSS 902 on a same channel, according to some embodiments. In an example, STA 910 and the unassociated access point 906 may be in different BSSs, and STA 910 and the associated access point 908 may be in a same BSS. In an example, STA 910 may be first sensing receiver 502-1, the unassociated access point may be first sensing transmitter 504-1, and the associated access point may be second sensing transmitter 504-2. STA 910 may hereinafter be referred to as OBSS STA, the unassociated access point 906 may hereinafter be referred to as OBSS AP1, and the associated access point 908 may hereinafter be referred to as BSS AP2. As described in FIG. 9, there are two BSSs, namely, first BSS 902 and second BSS 904. First BSS 902 includes OBSS AP1 906 and second BSS 904 includes BSS AP2 908 and OBSS STA 910. Further, OBSS AP1 906 and OBSS STA 910 may participate in sensing measurement exchange 912 (also referred to as OBSS sensing measurement exchange). Also, BSS AP2 908 and OBSS STA 910 may have communication link 914 (also referred to as associated communication channel) established therebetween. In an implementation, communication between OBSS AP1 906 and OBSS STA 910, and communication between BSS AP2 908 and OBSS STA 910 may occur on frequency channel “f₁” and there may be coverage overlapping area 916 between OBSS AP1 906 and OBSS STA 910. In an example, the channel of BSS AP2 908 is the same as the channel of a beacon frame of OBSS AP1 906. According to an implementation, OBSS STA 910 may receive a beacon frame of OBSS AP1 906 on the same channel as a beacon frame of BSS AP2 908, e.g., “f₁” and may stay tuned to the channel for further communications from OBSS AP1 906 (e.g., PASN or sensing measurement exchanges). In some implementations, communication between OBSS AP1 906 and OBSS STA 910 may occur on frequency channel “f₁”, and communication between BSS AP2 908 and OBSS STA 910 may occur on a different frequency channel (for example, “f₂”). In an example, the channel of BSS AP2 908 may be different than the channel of the beacon frame of OBSS AP1 906.

According to an implementation, to enable OBSS STA 910 to receive a beacon frame of OBSS AP1 906 on the channel of OBSS AP1 906 and stay tuned to the channel of OBSS AP1 906 for further communications (e.g., PASN or sensing measurement exchanges), OBSS STA 910 may periodically move to an idle status. In examples, OBSS STA 910 may indicate to BSS AP2 908 that it is entering into a sleep mode, and BSS AP2 908 may temporarily initiate buffering of communication data for OBSS STA 910 from BSS AP2 908. Further, in examples, OBSS STA 910 may buffer communication data for sending to BSS AP2 908 when OBSS STA 910 tunes back to the associated communication channel with BSS AP2 908.

In examples, a mechanism to enable OBSS STA 910 to periodically move to an idle status may be provided at an application layer. Further, in examples, a mechanism to enable OBSS STA 910 to periodically move to an idle status may be provided at a MAC layer. In an example, the mechanism may be sent to OBSS STA 910 by the relevant station management entity (SME) of BSS AP2 908 in advance, for example upon association. In examples, OBSS STA 910 may periodically move to an idle status using the same or similar mechanisms already specified in IEEE 802.11 standards to provide the same or similar functionality. In an implementation, when OBSS AP1 906 in an idle status, OBSS STA 910 may scan for the beacon frame of OBSS AP1 906 and then tune to the channel of the beacon frame of OBSS AP1 906.

For ease of explanation and understanding, the description provided is in the context of first sensing transmitter 504-1 with first sensing receiver 502-1, however first sensing receiver 502-1 may interact with remaining sensing transmitters 504-(2-N) (for example, with second sensing transmitter 504-2, third sensing transmitter 504-3, etc.), with no loss of generality. In examples, first sensing transmitter 504-1 may interact with remaining sensing receivers 502-(2-M) (for example, with second sensing receiver 502-2, third sensing receiver 502-3, etc.). According to some embodiments, one or more of channels of plurality of sensing receivers 502-(1-M) may be different from the channel of the beacon frame of OBSS AP1 906. In examples, remaining sensing receivers 502-(2-M) may also be in interaction with first sensing transmitter 504-1.

Referring back to FIG. 5, in an implementation, first sensing receiver 502-1 may transmit an idle message to the associated access point which may be second sensing transmitter 504-2. Further, first sensing receiver 502-1 may tune first sensing receiver 502-1 to the channel on which the beacon frame was received, for example from first unassociated access point 504-1. In an implementation, first sensing receiver 502-1 may receive a sensing transmission from first sensing transmitter 504-1. Further, first sensing receiver 502-1 may perform a sensing measurement on the sensing transmission. In an implementation, first sensing receiver 502-1 may associate the sensing measurement with the timestamp (which is the same timestamp generated by timestamp generation block 524-1) based on the local timing information associated with sensing transmitter 504-1, which may be retrieved for example from sensing transmitter information storage 521-(1-N). First sensing receiver 502-1 may then transmit the sensing measurement and the timestamp to first sensing transmitter 504-1. In an implementation, first sensing receiver 502-1 may transmit the sensing measurement in response to receiving a sensing report trigger from first sensing transmitter 504-1.

In examples, when resynchronization timer 526-1 associated with first sensing transmitter 504-1 expires, sensing agent 516-1 or sensing algorithm 518-1 may clear a synchronization flag associated with first sensing transmitter 504-1. In some implementations, first sensing receiver 502-1 may resynchronize local timing information associated with sensing transmitter 504-1 after expiration of resynchronization timer 526-1 associated with first sensing transmitter 504-1, or when synchronization flag associated with first sensing transmitter 504-1 is cleared. In a similar manner as described above, first sensing receiver 502-1 may obtain second timing information from first sensing transmitter 504-1. In examples, a time interval of resynchronization timer 526-1 may be determined according to a measurement of timing drift between TSF timer 523-1 of first sensing receiver 502-1 and TSF timer 543-1 of first sensing transmitter 504-1.

According to an implementation, prior to receiving the sensing transmission, first sensing receiver 502-1 may initiate a PASN procedure with first sensing transmitter 504-1. In examples, this establishes security keys necessary for first sensing receiver 502-1 to receive and decode messages in a sensing measurement exchange, as well as for first sensing receiver 502-1 to encode and send messages in the sensing measurement exchange. The PASN procedure is explained in Section 12.12 of Draft P802.11az_D4.1. In an implementation, first sensing transmitter 504-1 may indicate that it is capable of performing PASN authentication by including an indication in a beacon frame or a probe response (which are the same beacon frame and probe response from which first sensing receiver 502-1 obtains TSF timer 543-1 of sensing transmitter 504-1).

In some embodiments, the bbeacon frame or the probe response may be sent without a PASN procedure if there are no following sensing measurement exchanges. In examples, the beacon frame or the probe response may be a part of the PASN procedure, and the PASN procedure may complete the authentication and negotiate security keys which allows first sensing receiver 502-1 to decode an NDPA frame from first sensing transmitter 504-1. In examples, after first sensing receiver 502-1 obtains the TSF timer 543-1 from the beacon frame or the probe response from sensing transmitter 504-1, first sensing receiver 502-1 may initiate and complete the PASN procedure. Once the PASN procedure has been completed, first sensing receiver 502-1 and first sensing transmitter 504-1 may participate in a sensing measurement exchange.

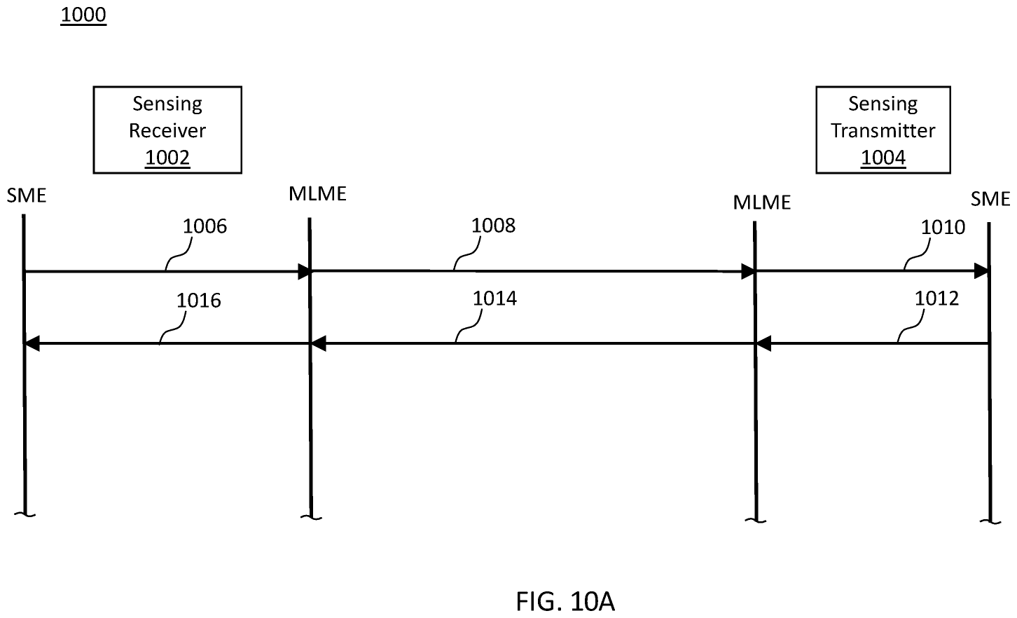

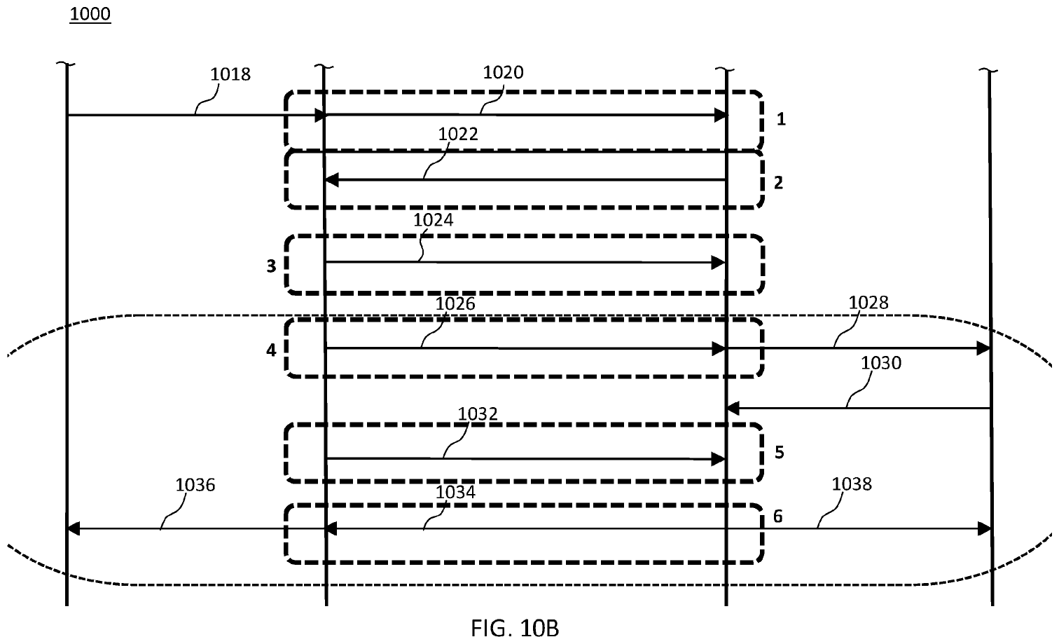

FIG. 10A and FIG. 10B depicts a trigger based measurement instance 1000 of a Wi-Fi sensing procedure, according to some embodiments. FIG. 10A and FIG. 10B are reproduction of FIG. 6-28a on Draft P802.11bf_D0.01. In FIG. 10A and FIG. 10B, sensing receiver 1002 and sensing transmitter 1004 may perform sensing measurement exchanges. At step 1006 of process 1000, in some implementations, SME of sensing receiver 1002 may send MLME-SENSMSMTSETUP.request primitive to MLME of sensing receiver 1002. At step 1008 of process 1000, in some implementations, MLME of sensing receiver 1002 may send SENS Measurement Setup Request frame to MLME of sensing transmitter 1004. At step 1010 of process 1000, in some implementations, MLME of sensing transmitter 1004 may send MLME-SENSMSTSETUP.indication primitive to SME of sensing transmitter 1004. At step 1012 of process 1000, in some implementations, SME of sensing transmitter 1004 may send MLME-SENSMSTSETUP.response primitive to MLME of sensing transmitter 1004. At step 1014 of process 1000, in some implementations, MLME of sensing transmitter 1004 may send SENS Measurement Setup Response frame to MLME of sensing receiver 1002. At step 1016 of process 1000, in some implementations, MLME of sensing receiver 1002 may send MLME-SENSMSTSETUP.confirm primitive to SME of sensing receiver 1002. At step 1018 of process 1000, in some implementations, SME of sensing receiver 1002 may send MLME-SENSTBMSMTRQ.request primitive to MLME of sensing receiver 1002. At step 1020 of process 1000, in some implementations, MLME of sensing receiver 1002 may send SENS Poll frame to MLME of sensing transmitter 1004. At step 1022 of process 1000, in some implementations, MLME of sensing transmitter 1004 may send SENS CTS-to-self to MLME of sensing transmitter 1004. At step 1024 of process 1000, in some implementations, MLME of sensing receiver 1002 may send SENS NDPA frame to MLME of sensing transmitter 1004. At step 1026 of process 1000, in some implementations, MLME of sensing receiver 1002 may send SENS NDP to MLME of sensing transmitter 1004. At step 1028 of process 1000, in some implementations, MLME of sensing transmitter 1004 may send MLME-SENSTBREPORT.indication primitive to SME of sensing transmitter 1004. At step 1030 of process 1000, in some implementations, SME of sensing transmitter 1004 may send MLME-SENSTBREPORTRQ.request primitive to MLME of sensing transmitter 1004. At step 1032 of process 1000, in some implementations, MLME of sensing receiver 1002 may send SENS Report Trigger frame to MLME of sensing transmitter 1004. At step 1034 of process 1000, in some implementations, MLME of sensing transmitter 1004 may send Sensing Measurement Report frame to MLME of sensing receiver 1002. At step 1036 of process 1000, in some implementations, MLME of sensing receiver 1002 may send MLME-SENSTBMSMTRQ.confirm primitive to SME of sensing receiver 1002. At step 1038 of process 1000, in some implementations, MLME of sensing transmitter 1004 may send MLME-SENSTBREPORTRQ.confirm primitive to SME of sensing transmitter 1004. In FIG. 10A and FIG. 10B, the sensing measurement exchanges are numbered 1 through 6.

Examples by which the time synchronization of sensing measurements made out of BSS are described in detail below.

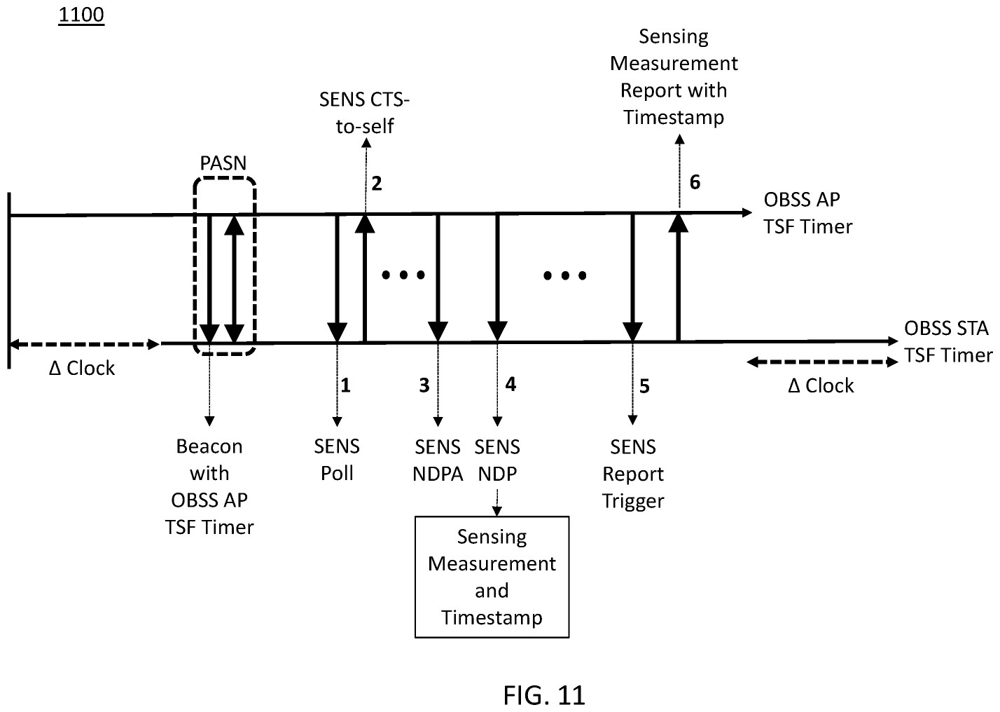

FIG. 11 depicts example 1100 of a trigger based OBSS sensing measurement exchange, according to some embodiments. In an example, an OBSS STA may be a sensing receiver (for example, first sensing receiver 502-1) and an OBSS AP may be a sensing transmitter (for example, first sensing transmitter 504-1). In examples, the OBSS STA may make a sensing measurement on a sensing transmission from the OBSS AP. Further, the OBSS STA may timestamp the sensing measurement with the local timing information associated with the OBSS AP, also referred to as a local version of the OBSS AP TSF timer (the OBSS STA-AP TSF timer) or with an adjusted OBSS STA TSF timer. The OBSS STA may then send the sensing measurement report comprising the sensing measurement and the timestamp to the OBSS AP.

In examples, a new Trigger frame type is defined, which may be referred to as the SENS Poll as illustrated in FIG. 11. In examples, the SENS Poll may enable the OBSS AP to determine which OBSS STAs will participate in the OBSS sensing measurement exchange. In examples, the SENS Poll trigger frame may reuse aspects of the Ranging Trigger frame (poll). In examples, the SENS Poll trigger frame is defined by a new Trigger Type subfield value, which may use one of the reserved Trigger Type subfield values (i.e., a new Trigger Type subfield value is defined). In examples, any Trigger Type subfield value not already used for a trigger frame variant may be used. In examples, the Trigger Type subfield value for a SENS Poll trigger frame is Type 9, as illustrated in Table 1 below.

TABLE 1
New trigger type subfield of the common
info field (of the trigger frame)

| Trigger | |
|---|---|
| Type | |
| subfield | |
| value | Trigger frame variant |
| 0 | Basic |
| 1 | Beamforming Report Poll (BFRP) |
| 2 | MU-BAR |
| 3 | MU-RTS |
| 4 | Buffer Status Report Poll (BSRP) |
| 5 | GCR MU-BAR |
| 6 | Bandwidth Query Report Poll (BQRP) |
| 7 | NDP Feedback Report Poll (NRFP) |
| 8 | Ranging |
| 9 | SENS Poll |
| 10-15 | Reserved |

In examples, in the SENS Poll trigger frame, the OBSS AP may include a ranging session identification (RSID) assigned to address each OBSS STA that the OBSS AP may require to participate in the sensing session. In examples, the OBSS AP may address one or more OBSS STAs for which a PASN procedure has successfully been completed. In examples, the OBSS AP may assign a resource unit (RU) allocation to each addressed OBSS STA in the SENS Poll trigger frame.

In examples, the OBSS STA may have an availability window to receive the SENS Poll trigger frame from the OBSS AP. In examples, an RSID may be assigned to the OBSS STA and if the OBSS STA chooses to participate in the sensing measurement exchange, then the OBSS STA may respond to the SENS Poll trigger frame. In examples, in response to the SENS Poll trigger frame, the OBSS STA may respond to the OBSS AP with a CTS-to-self frame. In examples, in the sensing measurement exchange polling phase, the response from the OBSS STA to the OBSS AP may be referred to as a SENS CTS-to-self frame. In examples, the OBSS STA may send the SENS CTS-to-self frame in the RU allocation provided to the OBSS STA by the OBSS AP in the SENS Poll trigger frame. In examples, the OBSS STA may report its MAC address to the OBSS AP (for example, as described in the Ranging Polling Phase in Draft P802.11az_D4.1). In examples, the OBSS AP may create an RSID-MAC element which may be used to identify the OBSS STA.

Further, in examples, the OBSS AP may send a SENS NDPA frame to announce to the OBSS STA that a SENS NDP will follow, on which the OBSS STA may make a sensing measurement. In examples, the SENS NDPA frame may be unicast or broadcast. In examples, the OBSS AP may send a SENS NDP frame to all OBSS STAs which responded to the SENS Poll trigger frame. Further, the OBSS STAs may make sensing measurements on the SENS NDP. In examples, the SENS NDPA frame and/or the SENS NDP frame may be sent in the same channel as SENS Poll trigger frame. In examples, the SENS NDPA frame and/or the SENS NDP frame may be sent in a different channel which may have been selected by the OBSS AP and the OBSS STA, for example, during the Polling Phase. In an example, the SENS NDP may have a same or similar structure to a Ranging NDP. The OBSS STA may make a sensing measurement on the SENS NDP and may associate a timestamp with the sensing measurement, where the timestamp is based on the OBSS STA-AP TSF timer or the adjusted OBSS STA TSF timer. In examples, the OBSS AP may send more than one SENS NDPA/SENS NDP frame combination to the OBSS STA. The OBSS STA may make a sensing measurement on each SENS NDP it receives and associates a timestamp with each sensing measurement.

In examples, the OBSS AP may send a sensing report trigger frame to the OBSS STA. In response to receiving the sensing report trigger frame, the OBSS STA may send a sensing measurement report frame to the OBSS AP, which includes one or more sensing measurements with their associated timestamps. In examples, a timestamp included with a sensing measurement may be 64 bits or 8 octets long. The sensing measurement report frame may be defined as a management frame or as a data frame. In examples, the sensing measurement report frame may be transferred from the OBSS STA to the OBSS AP using any valid data transfer TXOP. In an example, the sensing measurement report frame may include a truncated timestamp of less than 64 bits. In examples, one or more of the least significant bits (LSBs) of the 64 bit timestamp may be truncated. In some examples, one or more of the most significant bits (MSBs) of the 64 bit timestamp may be truncated. In an example, the timestamp may include 8 LSBs, 16 LSBs, 24 LSBs, 32 LSBs, 40 LSBs, 48 LSBs, or 56 LBSs. In FIG. 11, the sensing measurement report may be defined similarly as the I2R LMR Feedback (e.g., OBSS STA to OBSS AP location measurement report feedback, as described in Draft P802.11az_D4.1).

FIG. 12 depicts format 1200 of a sensing measurement report frame, according to some embodiments. FIG. 12 is a reproduction of FIG. 9-909aa of Draft P802.11az_D4.1). An immediate measurement subfield may be defined that may be similar as the immediate I2R Feedback subfield, and which indicates that the sensing measurement results from the current sensing measurement exchange may be reported immediately by setting it to 1 (from the current sensing measurement) or delayed by setting it to 0 (from the previous sensing measurements) (as described in Draft P802.11az_D4.1) respectively.

Referring back to FIG. 11, in examples, a time offset between the OBSS AP TSF timer (for example, TSF timer 543-1) and the OBSS STA TSF timer (for example, TSF timer 523-1) is shown as A Clock in FIG. 11. Both the OBSS AP TSF timer and the OBSS STA TSF timer may be incremented with each system timing unit (abbreviated to TU), however, the clock at the OBSS AP and the clock at the OBSS STA may have different clock drifts (within an allowable tolerance), such that the TU for the OBSS AP TSF timer and the TU for the OBSS STA TSF timer may be slightly different, resulting in drift between the OBSS AP TSF timer and the OBSS STA TSF timer. In examples, when the OBSS STA receives the beacon frame or the probe response from the OBSS AP including the full OBSS AP TSF timer, the OBSS STA may set its local timing information (local version of the OBSS AP TSF timer (OBSS STA-AP TSF timer)) to the received OBSS AP TSF timer or may calculate a timer offset value as the difference between the OBSS AP TSF timer and the OBSS STA TSF timer. In an example, the received OBSS AP TSF timer 543-1 may include the full 8-octet TSF value.

In example, assuming that TO is the OBSS AP TSF timer when the beacon frame (or the probe response) is broadcast, while T0′ is the OBSS STA TSF timer when the beacon frame (or the probe response) from the OBSS AP is received at the OBSS STA. In examples, a timer offset (T_{offset}) may be defined as the difference between the OBSS AP TSF timer received in the beacon frame or the probe response and the OBSS STA TSF timer when the OBSS STA receives the beacon frame or the probe response. In examples, let T_{flight} represent the time of flight which is the transmission time from the OBSS AP to the OBSS STA, and let T_{proc} represent the OBSS STA processing time, which is time between when a signal is received by the OBSS STA and when the signal is processed by the OBSS STA for a frame. The timer offset (T_{offset}) between the OBSS STA TSF timer and the OBSS AP TSF timer may be mathematically represented as:

$$Timer Offset = T {0}^{′} - T 0 = Δ Clock + {T}_{flight} + {T}_{proc} \qquad ( 8 )$$

In examples, a sensing measurement may be timestamped with an adjusted OBSS STA TSF timer, calculated as follows:

$$Adjusted OBSS STA TSF Timer = OBSS STA TSF Timer - Timer Offset \qquad ( 9 )$$

In an example, the timer offset value may be stored at the OBSS STA. In examples, the size of the timer offset may vary up to 64 bits (which is the size of the TSF timer 543-1) In examples, the timer offset may be stored as an 8 bit value, a 16 bit value, a 24 bit value, a 32 bit value, a 40 bit value, a 48 bit value, or a 56 bit value.

In examples, local timing information (a local version of the OBSS AP TSF Timer (OBSS STA-AP TSF Timer)) may be stored at the OBSS STA. In an example, two methods of representing the OBSS STA-AP TSF Timer in 64 bits are shown below in Table 2 and Table 3 provided below. Table 2 divides the lower two octets into three parts-bits 0 to 5, bits 6 to 21, and bits 22 to 31. A partial TSF utilizing bits 6-21 ([21:6] in notation) is standardized in IEEE 802.11 as a Partial TSF field. For ease of representation, local timing information, also referred to as OBSS STA-AP TSF timer is abbreviated to OSA-TSF in Tables 2 and 3.

TABLE 2
Initial OBSS STA-AP TSF timer via beacon frame

Bits

| [63:48] | [47:32] | [31:22] | [21:6] | [5:0] |
|---|---|---|---|---|
| OSA-TSF | OSA-TSF | OSA-TSF | OSA-TSF | OSA-TSF |
| [63:48] | [47:32] | [31:22] | [21:6] | [5:0] |

TABLE 3
Initial OBSS STA-AP TSF timer via beacon frame
Bits

| [63:48] | [47:32] | [31:16] | [15:0] |
|---|---|---|---|
| OSA-TSF | OSA-TSF | OSA-TSF | OSA-TSF |
| [63:48] | [47:32] | [31:16] | [15:0] |
| T0′[63:48] | T0′[47:32] | T0′[31:16] | T0′[15:0] |
| (T0′-T0) | (T0′-T0) | (T0′-T0) | (T0′-T0) |
| [63:48] | [47:32] | [31:16] | [15:0] |

In examples, a sensing measurement may be timestamped with local timing information (also referred to as the OBSS STA-AP TSF timer.) The OBSS STA-AP TSF timer may be incremented in the same way that the OBSS STA TSF timer (523-1) is incremented.

In an implementation, more than one OBSS STA may maintain OBSS STA-AP TSF timers or timer offsets and may timestamp their respective sensing measurements with their local timing information (OBSS STA-AP TSF timer) or adjusted OBSS STA TSF timer (which is a combination of the timer offset value and TSF timer 523-1. In examples, the OBSS STA-AP TSF timers or adjusted OBSS STA TSF timers maintained by all OBSS STAs may be same within a tolerance, which allows the OBSS AP to combine sensing measurements from multiple OBSS STAs. In an example, after the initial synchronization of the OBSS STA-AP TSF timer with the OBSS AP TSF timer by the beacon frame (or probe response), or the initial calculation of the timer offset value, there may be a time drift of the OBSS STA-AP TSF timer or adjusted OBSS STA TSF timer due to the difference in the OBSS AP oscillator and the OBSS STA oscillator. In examples, this may result in inaccuracy in the timestamp associated with the sensing measurement. In an example, the time drift of the STA oscillator may be around +/−100 parts per million (ppm), or +/−100 ppm, and the time drift of the AP oscillator may also be around +/−100 ppm. In examples, because of the time drift, the OBS STA-AP TSF timer may need to be periodically resynchronized with the OBSS AP TSF timer. In some examples, the timer offset value needs to be recalculated.

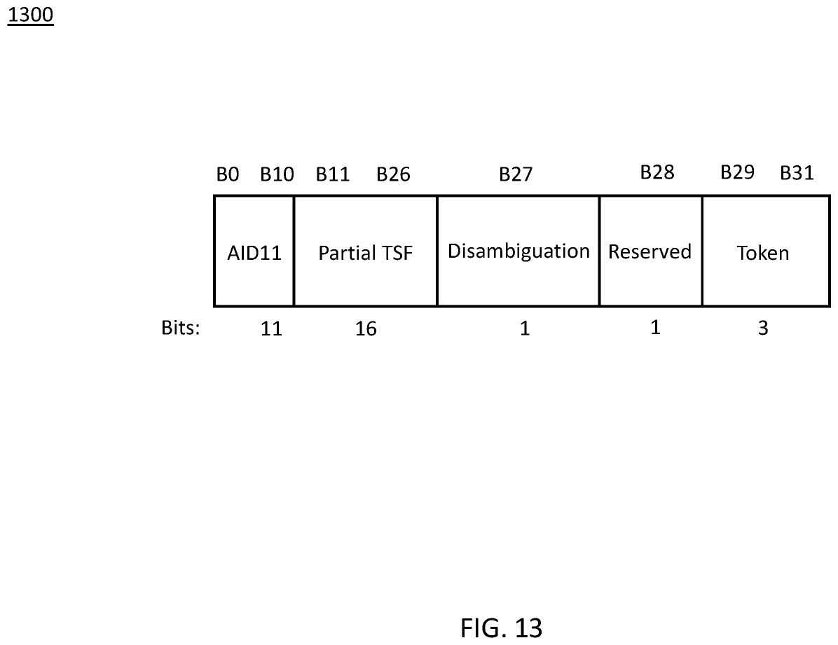

In examples, the resynchronization of the OBSS STA-AP TSF timer with the OBSS AP TSF timer may be achieved using a SENS NDPA frame that includes a Partial TSF subfield in a STA Info field. In examples, the Partial TSF is a 16 bit field which occurs after the AID11 field in the SENS NDPA frame. Example 1300 of SENS NDPA STA Info field showing the Partial TSF is depicted in FIG. 13.

In examples, the STA Info field with AID11 subfield set equal to 2044 is present in SENS NDPA frames which carry the Partial TSF subfield. In examples, the Partial TSF subfield includes 16 bits of the OBSS AP TSF timer 543-1. In an example, the Partial TSF carries bits [21:6] of the OBSS AP TSF timer 543-1. Other 16 bit ranges of the OBSS AP TSF timer may be carried in the SENS NDPA. In an example, if there was no time drift between the AP oscillator and the STA oscillator, then the Partial TSF should be equal to same bit range of the local timing information, i.e., the OBSS STA-AP TSF timer, however, as previously described, both the OBSS AP oscillator and the OBSS STA oscillator may drift with respect to each other. In examples, when the OBSS AP determines that a resynchronization task for one or more OBSS STAs should be run, then the OBSS AP may send a SENS NDPA with a STA Info field including the Partial TSF subfield. In examples, when the OBSS AP determines that the resynchronization task for one or more OBSS STAs should be run, then the OBSS AP may send a SENS NDPA with the Partial TSF subfield including 16 bits of the full OBSS AP TSF timer. In examples, the bit window of Partial TSF field of the OBSS AP TSF timer sent in the SENS NDPA may be preconfigured. In examples, the bit window of Partial TSF field of the OBSS AP TSF timer sent in the SENS NDPA may be greater than 16 bits in length. In some examples, the bit window of Partial TSF field of the OBSS AP TSF timer sent in the SENS NDPA may extract different portions of the 64 bits of the OBSS AP TSF timer. In examples, the Partial TSF field may represent a windowed version of the OBSS AP TSF timer.

In examples, the windowed version of the OBSS AP TSF timer sent in the Partial TSF field may overwrite the equivalent part of the OBSS STA-AP TSF timer (e.g., Partial TSF [21:6] overwrites OBSS STA-AP TSF timer [21:6]) thereby resynchronizing the local timing information. In an example, the windowed bit range of the OBSS AP TSF timer that is captured in the Partial TSF may be used to determine the maximum accuracy of the time synchronization between the OBSS STA-AP TSF timer and the OBSS AP TSF timer, as well as a minimum resynchronization time.

In an example, where the Partial TSF field includes bits [21:6], the Partial TSF field is used to update the timer offset at the OBSS STA. In an example, the timer offset may be updated based on Equation (10) provided below.

$$Timer Offset ( recalculated ) = Timer Offset + [ Adjusted OBSS STA TSF Timer [ 21 : 6 ] - Partial TSF [ 21 : 6 ] ] \qquad ( 10 )$$

In examples, the OBSS AP may determine that a resynchronization task for the OBSS STA should be run if a resynchronization timer (such as resynchronization timer 546-1 associated the OBSS STA which in examples is sensing receiver 502-1) reaches a certain value (if resynchronization timer 546-1 for the OBSS STA counts up from zero) or reaches zero (if resynchronization timer 546-1 for the OBSS STA counts down from a certain value). In examples, if a resynchronization timer 526-1 for the OBSS AP in the OBSS STA expires, the OBSS STA will not send any sensing measurement report frames to the OBSS AP until the OBSS STA is able to resynchronize the OBSS STA-AP TSF timer or recalculate the timer offset value, for example until the OBSS STA receives a SENS NDPA from the OBSS AP, where the SENS NDPA includes the Partial TSF field.

In an example, when the resynchronization timer in the OBSS STA for the OBSS AP expires, the OBSS STA may clear the synchronization flag for that OBSS AP. In examples, the OBSS STA may not send any sensing measurement report frames to the OBSS AP when the synchronization flag is not set, that is when the synchronization flag is cleared. In examples, when the OBSS STA resynchronizes the OBSS STA-AP TSF timer or recalculates the timer offset value (for example when the OBSS STA receives a SENS NDPA from the OBSS AP, where the SENS NDPA includes the Partial TSF field), the OBSS STA may set the synchronization flag for that OBSS AP.

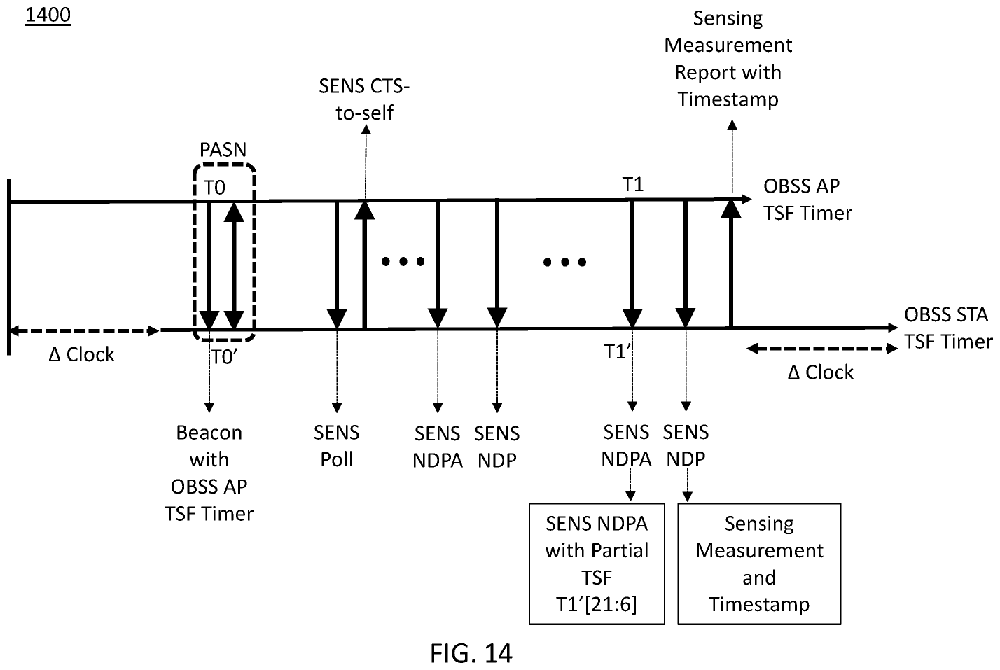

In examples, when the resynchronization timer in the OBSS STA for the OBSS AP is running (indicating that the OBSS STA is synchronized with the OBSS AP), or when the synchronization flag for that OBSS AP is set, any scheduled event (e.g., a channel change) that relates to the OBSS AP uses the local timing information for the OBSS AP, that is the OBSS STA-AP TSF timer or the adjusted OBSS STA TSF timer for that OBSS AP, as a time reference. As described above, a portion of the OBSS AP TSF timer at T1 may be sent in the SENS NDPA frame from the OBSS AP to the OBSS STA using the Partial TSF. In examples, 16 bits [21:6] of the OBSS AP TSF timer at T1 may be sent to the OBSS STA in the SENS NDPA frame with Partial TSF field. This is illustrated in FIG. 14. FIG. 14 depicts example 1400 of SENS NDPA STA Info field with Partial TSF in a sensing measurement exchange, according to some embodiments.

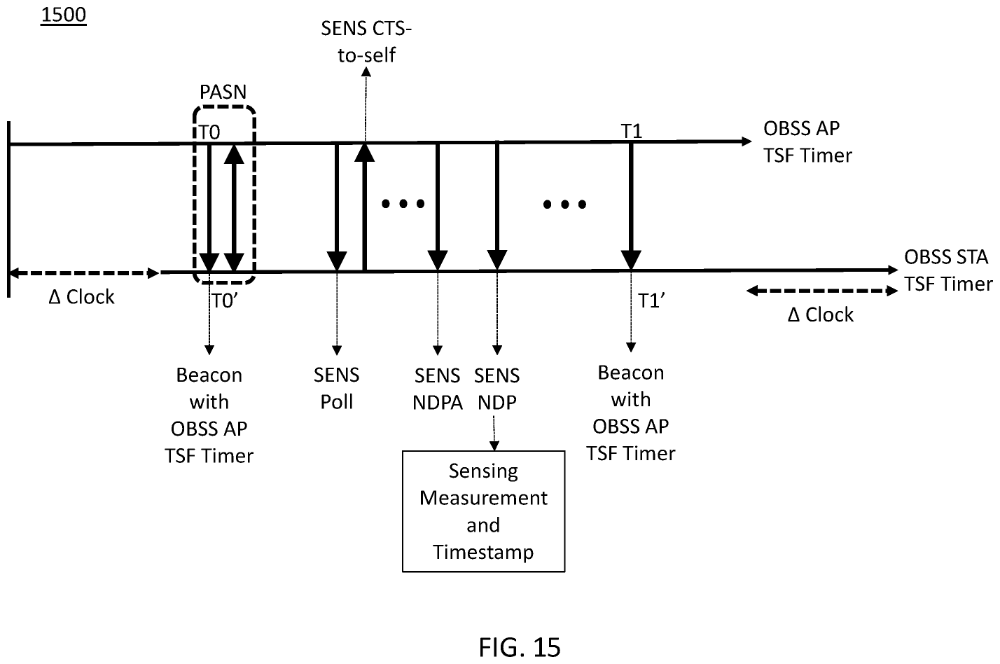

In examples, the maximum time period between resynchronization events is calculated by the OBSS AP based on the OBSS STA TSF timer drift, which may be bounded by the required precision of the clock reference for the OBSS STA. In examples, both the OBSS AP and the OBSS STA clock references (and therefore TSF timer values) may drift at around +/−100 ppm. In examples, the OBSS STA may measure the TSF timer drift (TSF_{drift}) by calculating the timer offset (T_{offset}) for two different beacon frame broadcasts by the OBSS AP, for example at T0 and T1 (resulting in T_{offset}0 and T_{offset}1). This is illustrated in FIG. 15. FIG. 15 depicts example 1500 of trigger based OBSS sensing measurement exchange, according to some embodiments. In examples, the TSF timer drift (TSF_{drift}) for the OBSS AP may be determined as follows:

$$T {0}^{′} - T 0 = {T}_{offset} 0 \qquad ( 11 )$$

$$T {1}^{′} - T 1 = {T}_{offset} 1 \qquad ( 12 )$$

$${TSF}_{drift} = {T}_{offset} 1 - {T}_{offset} 0 \qquad ( 13 )$$

In examples, the rate of drift may be calculated as follows:

$$\frac{d ( {TSF}_{drift} )}{dt} = \frac{{TSF}_{drift}}{OBSS STA TSF Timer ( T 1 ) - OBSS STA TSF Timer ( T 0 )} \qquad ( 14 )$$

In examples, a synchronization time may expire when TSF_{drift} exceeds a specified threshold.

In examples, the OBSS AP may include a Partial TSF field in every SENS NDPA frame. In examples, the OBSS STA may determine when to apply a Partial TSF field received in a SENS NDPA frame from the OBSS AP to the OBSS STA-AP TSF timer for the OBSS AP, or to recalculate the timer offset value for that OBSS AP, for example depending on TSF_{drift}, for example as calculated above, or on the expiration of a resynchronization timer for that OBSS AP.

In examples, the window applied to the TSF timer to derive the Partial TSF may be adjusted to make updates to the OBSS STA-AP TSF timer or to the timer offset value more or less precise as shown in Table 4 provided below. The greater the precision, the more frequently a resynchronization algorithm may need to be run. The resynchronization algorithm may be adjusted dynamically based on, for example, a measure of channel occupancy of system 500.

TABLE 4
Different locations of the partial TSF (16 bits)

| Location | Wraparound | |
|---|---|---|
| of 16 bits | Time (s) | Time Unit (us) |
| [15:0] | 0.065535 | 1 |
| [21:6] | 4.19 | 64 |
| [25:10] | 67 | 1024 |
| [31:16] | 4294.9 | 65536 |
| [47:32] | 281470681 | 4294967296 |
| [63:48] | 18446462598732 | 281474976710656 |

Referring again to FIG. 14, the Partial TSF of NDPA is 16 bits [21:6], so the wraparound time may be around 4.19 s, the time unit is 2⁶ μs=64 us and the accuracy of (T1′-T1)[21:6] is also around 64 μs. In examples, the resolution of the OBSS STA-AP TSF timer or the timer offset value may not be larger than the resolution of the Partial TSF field. For example, if the Partial TSF field includes bits [21:6] of the OBSS AP TSF timer, the resolution of the OBSS STA-AP TSF timer or the timer offset value may not be no more than 64 μs.

A period t of the resynchronization of the OBSS STA-AP TSF timer or the timer offset value (given a maximum clock drift of x) may be defined as below:

$$x * t <= 64 μs \qquad ( 15 )$$

$$t <= 64 μs / x \qquad ( 16 )$$

In examples, the maximum x is around +/−100 μs/s, therefore the resynchronization period is defined by:

$$t < = 64 μs / ( 100 μs / s ) = 0.64 s \qquad ( 17 )$$

The period of the resynchronization of x should be less than 0.64 s, which is decided by the bit location of the Partial TSF of SENS NPDA frame. The Partial TSF is an optional element/field of the SENS NDPA, therefore the OBSS STA may still use a SENS NDPA without a Partial TSF field in a sensing measurement exchange, if the OBSS AP addresses the OBSS STA in a separate STA Info field.

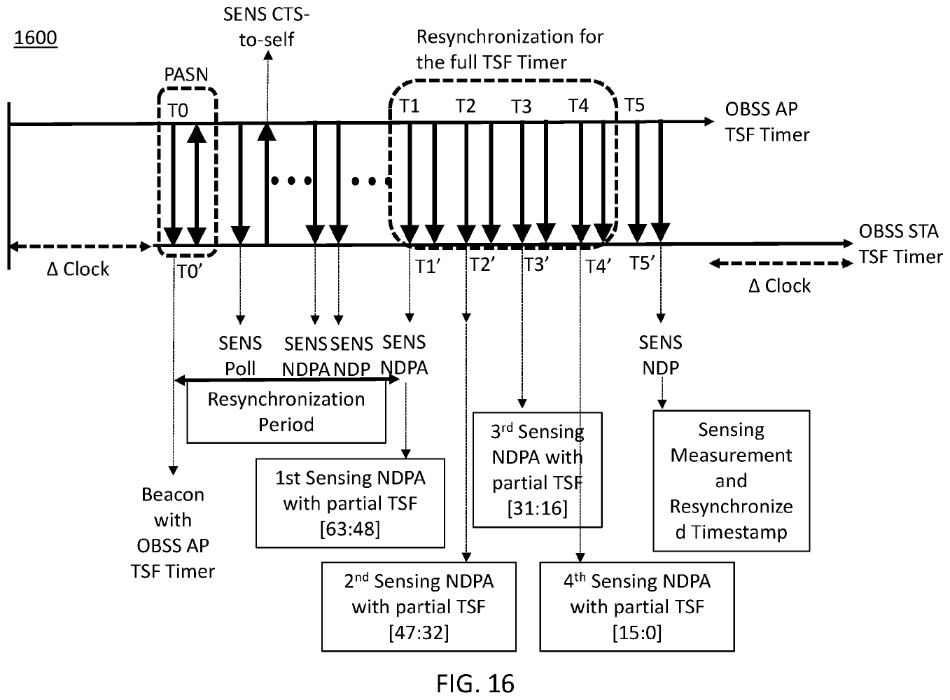

In some examples, the partial TSF of SENS NDPA may be used to resynchronize the full OBSS STA-AP TSF timer. This is illustrated in FIG. 16. FIG. 16 depicts example 1600 of full TSF timer synchronization using Partial TSF fields, according to some embodiments.

In an example, the location of the Partial TSF of the SENS NDPA may be configurable from the higher 16 bits [63:48] to the lower 16 bits [15:0] for the first four SENS NDPA frames. In examples, the first four NDPA frames may be used to resynchronize the full OBSS STA-AP TSF timer, by replacing each 16 bit segment of OBSS STA-AP TSF timer with 16 bits in the Partial TSF of each of four subsequent SENS NDPA frames. From beacon frame, OBSS STA-AP TSF timer could be as shown in Table 5 provided below. For ease of representation, OBSS STA-AP TSF timer is abbreviated to OSA-TSF in Table 5.

TABLE 5
Initial OBSS STA-AP TSF timer via beacon frame
Bits

| [63:48] | [47:32] | [31:16] | [15:0] |
|---|---|---|---|
| OSA-TSF | OSA-TSF | OSA-TSF | OSA-TSF |
| [63:48] | [47:32] | [31:16] | [15:0] |

After the first SENS NDPA frame with the Partial TSF [63:48], the most significant 16 bits of the OBSS STA-AP TSF timer may be resynchronized as shown in Table 6 provided below. For ease of representation, OBSS STA-AP TSF timer is abbreviated to OSA-TSF in Table 6.

TABLE 6
OBSS STA-AP TSF timer after the first SENS NDPA frame

| Bits | [63:48] | [47:32] | [31:16] | [15:0] |
|---|---|---|---|---|
| SENS | Partial TSF | OSA-TSF | OSA-TSF | OSA-TSF |
| NDPA T1 | [63:48] | [47:32] | [31:16] | [15:0] |

After the second SENS NDPA frame with the Partial TSF [47:32], the next most significant 16 bits [47:32] of the OBSS STA-AP TSF timer are resynchronized as shown in Table 7 below. For ease of representation, OBSS STA-AP TSF timer is abbreviated to OSA-TSF in Table 7.

TABLE 7
OBSS STA-AP TSF timer after the second SENS NDPA frame

| Bits | [63:48] | [47:32] | [31:16] | [15:0] |
|---|---|---|---|---|
| SENS | Partial TSF | OSA- TSF | OSA-TSF | OSA-TSF |
| NDPA T1 | [63:48] | [47:32] | [31:16] | [15:0] |
| SENS | Partial TSF | Partial TSF | OSA-TSF | OSA-TSF |
| NDPA T2 | [63:48] | [47:32] | [31:16] | [15:0] |

After the third SENS NDPA frame with the Partial TSF [31:16], the next most significant 16 bits [31:16] of the OBSS STA-AP TSF timer are resynchronized as shown in Table 8 below.

TABLE 8
Time offset of the third SENS NDPA frame

| Bits | [63:48] | [47:32] | [31:16] | [15:0] |
|---|---|---|---|---|
| SENS | Partial TSF | OSA- TSF | OSA-TSF | OSA-TSF |
| NDPA T1 | [63:48] | [47:32] | [31:16] | [15:0] |
| SENS | Partial TSF | Partial TSF | OSA-TSF | OSA-TSF |
| NDPA T2 | [63:48] | [47:32] | [31:16] | [15:0] |
| SENS | Partial TSF | Partial TSF | Partial TSF | OSA-TSF |
| NDPA T3 | [63:48] | [47:32] | [31:16] | [15:0] |

After the fourth SENS NDPA frame with the Partial TSF [15:0], the LSB [15:0] of the OBSS STA-AP TSF timer are resynchronized as shown in Table 9 below.

TABLE 9
Time offset of the fourth SENS NDPA frame

| Bits | [63:48] | [47:32] | [31:16] | [15:0] |
|---|---|---|---|---|
| SENS | Partial TSF | OSA- TSF | OSA-TSF | OSA-TSF |
| NDPA T1 | [63:48] | [47:32] | [31:16] | [15:0] |
| SENS | Partial TSF | Partial TSF | OSA-TSF | OSA-TSF |
| NDPA T2 | [63:48] | [47:32] | [31:16] | [15:0] |
| SENS | Partial TSF | Partial TSF | Partial TSF | OSA-TSF |
| NDPA T3 | [63:48] | [47:32] | [31:16] | [15:0] |
| SENS | Partial TSF | Partial TSF | Partial TSF | Partial TSF |
| NDPA T4 | [63:48] | [47:32] | [31:16] | [15:0] |

After the resynchronization using the first four SENS NDPA frames with Partial TSF as described above, the OBSS STA may perform a sensing measurement on an NDP that arrives after the fourth SENS NDPA, as at that point the OBSS STA-AP TSF timer is fully resynchronized. In an example, a sensing measurement could be done on the NDP following fifth SENS NDPA frame with an updated OBSS STA-AP TSF timer.

FIG. 17 depicts flowchart 1700 for transmitting, by a sensing receiver, a sensing measurement and a timestamp to an unassociated access point, according to some embodiments.

In a brief overview of an implementation of flowchart 1700, at step 1702, networking device operating as a sensing receiver (for example, first sensing receiver 502-1) may obtain timing information from an unassociated access point not associated with the sensing receiver and operating as a sensing transmitter (for example, first sensing transmitter 504-1). At step 1704, networking device operating as the sensing receiver may generate local timing information according to the timing information. At step 1706, networking device operating as the sensing receiver may receive a sensing transmission from the unassociated access point. At step 1708, networking device operating as the sensing receiver may perform a sensing measurement on the sensing transmission. At step 1710, networking device operating as the sensing receiver may associate the sensing measurement with a timestamp based on the local timing information. At step 1712, networking device operating as the sensing receiver may transmit the sensing measurement and the timestamp to the unassociated access point.

Step 1702 includes obtaining, by a sensing receiver, timing information from an unassociated access point not associated with the sensing receiver and operating as a sensing transmitter. In an example, the unassociated access point may be a first unassociated access point. According to an implementation, networking device operating as first sensing receiver 502-1 may be configured to obtain timing information from first sensing transmitter 504-1. In an example, the timing information may be an access point TSF timer (for example, TSF timer 538-1) of first sensing transmitter 504-1. Further, in examples, the timing information may be stored as the local timing information.

Step 1704 includes generating, by the sensing receiver, local timing information according to the timing information. According to an implementation, networking device operating as first sensing receiver 502-1 may be configured to generate local timing information according to the timing information. In an example, the local timing information may be a timer offset value determined according to a difference between the timing information and a sensing receiver TSF timer (for example, TSF timer 520-1) and the timestamp is determined by combining the sensing receiver TSF timer value with the timer offset value. In some embodiments, first sensing receiver 502-1 may obtain additional timing information from a plurality of additional unassociated access points (for example, one or more of remaining sensing transmitters 504-(2-N), examples of which are second sensing transmitter 504-2, second sensing transmitter 504-3, etc.). Further, first sensing receiver 502-1 may generate additional local timing information according to the additional timing information. In an example, the local timing information is maintained and incremented at first sensing receiver 502-1. In some examples, the local timing information is incremented at first sensing receiver 502-1 according to a local clock.

Step 1706 includes receiving, by the sensing receiver, a sensing transmission from the unassociated access point. According to an implementation, networking device operating as first sensing receiver 502-1 may be configured to receive a sensing transmission from first sensing transmitter 504-1. In an implementation, prior to receiving the sensing transmission, first sensing receiver 502-1 may initiate a PASN procedure with first sensing transmitter 504-1.

Step 1708 includes performing, by the sensing receiver, a sensing measurement on the sensing transmission. According to an implementation, networking device operating as first sensing receiver 502-1 may be configured to perform a sensing measurement on the sensing transmission.

Step 1710 includes associating, by the sensing receiver, the sensing measurement with a timestamp based on the local timing information. According to an implementation, networking device operating as first sensing receiver 502-1 may be configured to associate the sensing measurement with a timestamp based on the local timing information.

Step 1712 includes transmitting, by the sensing receiver, the sensing measurement and the timestamp to the unassociated access point. According to an implementation, networking device operating as first sensing receiver 502-1 may be configured to transmit the sensing measurement and the timestamp to first sensing transmitter 504-1.

FIG. 18A and FIG. 18B depict flowchart 1800 for resynchronizing local timing information through receipt of second timing information from an unassociated access point, according to some embodiments.

In a brief overview of an implementation of flowchart 1800, at step 1802, networking device operating as a sensing receiver (for example, first sensing receiver 502-1) may receive timing information from an unassociated access point not associated with the sensing receiver and operating as a sensing transmitter (for example, first sensing transmitter 504-1), where the timing information is received in a beacon frame broadcast by the unassociated access point. At step 1804, networking device operating as the sensing receiver may generate, by the sensing receiver, local timing information according to the timing information. At step 1806, networking device operating as the sensing receiver may transmit an idle message to the associated access point. At step 1808, networking device operating as the sensing receiver may tune the sensing receiver to a channel on which the beacon frame was received. At step 1810, networking device operating as the sensing receiver may receive a sensing transmission from the unassociated access point. At step 1812, networking device operating as the sensing receiver may perform a sensing measurement on the sensing transmission. At step 1814, networking device operating as the sensing receiver may associate the sensing measurement with a timestamp based on the local timing information. At step 1816, networking device operating as the sensing receiver may receive a sensing report trigger from the unassociated access point. At step 1818, networking device operating as the sensing receiver may transmit the sensing measurement and the timestamp to the unassociated access point in response to the sensing report trigger. At step 1820, networking device operating as the sensing receiver may resynchronize the local timing information through receipt of second timing information from the unassociated access point.

Step 1802 includes receiving, by a sensing receiver, timing information from an unassociated access point not associated with the sensing receiver and operating as a sensing transmitter, where the timing information is received in a beacon frame broadcast by the unassociated access point. In an example, the unassociated access point may be a first unassociated access point. According to an implementation, networking device operating as first sensing receiver 502-1 may be configured to receive timing information from first sensing transmitter 504-1, where the timing information is received in a beacon frame broadcast by first sensing transmitter 504-1. In an example, the timing information may be an access point TSF timer (for example, TSF timer 538-1) of first sensing transmitter 504-1. Further, in examples, the timing information may be stored as the local timing information. In some embodiments, first sensing receiver 502-1 may be associated with an associated access point operating on the same channel on which the beacon frame was received from the unassociated access point (for example, first sensing transmitter 504-1). In an example, the associated access point may be any device other than first sensing transmitter 504-1 (i.e., from amongst remaining sensing transmitters 504-(2-N), examples of which are second sensing transmitter 504-2 or third sensing transmitter 504-3, etc.).

Step 1804 includes generating, by the sensing receiver, local timing information according to the timing information. According to an implementation, networking device operating as first sensing receiver 502-1 may be configured to generate local timing information according to the timing information. In some embodiments, first sensing receiver 502-1 may obtain additional timing information from a plurality of additional unassociated access points (for example, one or more of remaining sensing transmitters 504-(2-N), examples of which are second sensing transmitter 504-2, second sensing transmitter 504-3, etc.). Further, first sensing receiver 502-1 may generate additional local timing information according to the additional timing information. In an example, the local timing information is maintained and incremented at first sensing receiver 502-1. In some examples, the local timing information is incremented at first sensing receiver 502-1 according to a local clock.

Step 1806 includes transmitting an idle message to the associated access point. According to an implementation, networking device operating as first sensing receiver 502-1 may be configured to transmit an idle message to first sensing transmitter 504-1.

Step 1808 includes tuning the sensing receiver to a channel on which the beacon frame was received. According to an implementation, networking device operating as first sensing receiver 502-1 may be configured to tune the sensing receiver to a channel on which the beacon frame was received.

Step 1810 includes receiving, by the sensing receiver, a sensing transmission from the unassociated access point. According to an implementation, networking device operating as first sensing receiver 502-1 may be configured to receive a sensing transmission from first sensing transmitter 504-1. In an implementation, prior to receiving the sensing transmission, first sensing receiver 502-1 may initiate a PASN procedure with first sensing transmitter 504-1.

Step 1812 includes performing, by the sensing receiver, a sensing measurement on the sensing transmission. According to an implementation, networking device operating as first sensing receiver 502-1 may be configured to perform a sensing measurement on the sensing transmission.

Step 1814 includes associating, by the sensing receiver, the sensing measurement with a timestamp based on the local timing information. According to an implementation, networking device operating as first sensing receiver 502-1 may be configured to associate the sensing measurement with a timestamp based on the local timing information.

Step 1816 includes receiving a sensing report trigger from the unassociated access point. According to an implementation, networking device operating as first sensing receiver 502-1 may be configured to receive a sensing report trigger from the unassociated access point.

Step 1818 includes transmitting, by the sensing receiver, the sensing measurement and the timestamp to the unassociated access point in response to the sensing report trigger. According to an implementation, networking device operating as first sensing receiver 502-1 may be configured to transmit the sensing measurement and the timestamp to first sensing transmitter 504-1 in response to the sensing report trigger.

Step 1820 includes resynchronizing the local timing information through receipt of second timing information from the unassociated access point. According to an implementation, networking device operating as first sensing receiver 502-1 may be configured to resynchronize the local timing information through receipt of another timing information (i.e., second timing information) from first sensing transmitter 504-1. In an example, resynchronizing the local timing information may be performed after expiration of a resynchronization timer. In examples, a time interval of the resynchronization timer is determined according to a measurement of timing drift between first sensing transmitter 504-1 and first sensing receiver 502-1.

FIG. 19A and FIG. 19B depict another flowchart 1900 for transmitting, by a sensing receiver, a sensing measurement and a timestamp to an unassociated access point, according to some embodiments.

In a brief overview of an implementation of flowchart 1900, at step 1902, networking device operating as a sensing receiver (for example, first sensing receiver 502-1) may transmit a probe request to an unassociated access point not associated with the sensing receiver and operating as a sensing transmitter (for example, first sensing transmitter 504-1). At step 1904, responsive to the probe request, networking device operating as the sensing receiver may receive a probe response from the unassociated access point, wherein the probe response includes timing information. At step 1906, networking device operating as the sensing receiver may generate local timing information according to the timing information. At step 1908, networking device operating as the sensing receiver may receive a sensing transmission from the unassociated access point. At step 1910, networking device operating as the sensing receiver may perform a sensing measurement on the sensing transmission. At step 1912, networking device operating as the sensing receiver may associate the sensing measurement with a timestamp based on the local timing information. At step 1914, networking device operating as the sensing receiver may transmit the sensing measurement and the timestamp to the unassociated access point.

Step 1902 includes transmitting, by a sensing receiver, a probe request to an unassociated access point not associated with the sensing receiver and operating as a sensing transmitter. In an example, the unassociated access point may be a first unassociated access point. According to an implementation, networking device operating as first sensing receiver 502-1 may be configured to transmit a probe request to first sensing transmitter 504-1.

Step 1904 includes receiving, by the sensing receiver and responsive to the probe request, a probe response from the unassociated access point, wherein the probe response includes timing information. According to an implementation, networking device operating as first sensing receiver 502-1 may be configured to receive a probe response from first sensing transmitter 504-1, responsive to the probe request, where the probe response includes timing information. In an example, the timing information may be an access point TSF timer (for example, TSF timer 538-1) of first sensing transmitter 504-1. Further, in examples, the timing information may be stored as the local timing information. In an example, the probe request may include at least one access point identification and the probe response may include at least one response from an access point associated with the at least one access point identification. In some examples, the probe request includes an access point identification wildcard and the probe response includes at least one response from an access point.

Step 1906 includes generating, by the sensing receiver, local timing information according to the timing information. According to an implementation, networking device operating as first sensing receiver 502-1 may be configured to generate local timing information according to the timing information. In some embodiments, first sensing receiver 502-1 may obtain additional timing information from a plurality of additional unassociated access points (for example, one or more of remaining sensing transmitters 504-(2-N), examples of which are second sensing transmitter 504-2, second sensing transmitter 504-3, etc.). Further, first sensing receiver 502-1 may generate additional local timing information according to the additional timing information. In an example, the local timing information is maintained and incremented at first sensing receiver 502-1. In some examples, the local timing information is incremented at first sensing receiver 502-1 according to a local clock.

Step 1908 includes receiving, by the sensing receiver, a sensing transmission from the unassociated access point. According to an implementation, networking device operating as first sensing receiver 502-1 may be configured to receive a sensing transmission from first sensing transmitter 504-1. In an implementation, prior to receiving the sensing transmission, first sensing receiver 502-1 may initiate a PASN procedure with first sensing transmitter 504-1.

Step 1910 includes performing, by the sensing receiver, a sensing measurement on the sensing transmission. According to an implementation, networking device operating as first sensing receiver 502-1 may be configured to perform a sensing measurement on the sensing transmission.

Step 1912 includes associating, by the sensing receiver, the sensing measurement with a timestamp based on the local timing information. According to an implementation, networking device operating as first sensing receiver 502-1 may be configured to associate the sensing measurement with a timestamp based on the local timing information.

Step 1914 includes transmitting, by the sensing receiver, the sensing measurement and the timestamp to the unassociated access point. According to an implementation, networking device operating as first sensing receiver 502-1 may be configured to transmit the sensing measurement and the timestamp to first sensing transmitter 504-1.

Additional embodiments consistent with the disclosure include at least the following.

Embodiment 1 is a method for Wi-Fi sensing carried out by a networking device configured to operate as a sensing receiver and including at least one processor configured to execute instructions. The method includes: obtaining, by the sensing receiver, timing information from an unassociated access point not associated with the sensing receiver and operating as a sensing transmitter; generating, by the sensing receiver, local timing information according to the timing information; receiving, by the sensing receiver, a sensing transmission from the unassociated access point; performing, by the sensing receiver, a sensing measurement on the sensing transmission; associating, by the sensing receiver, the sensing measurement with a timestamp based on the local timing information; and transmitting, by the sensing receiver, the sensing measurement and the timestamp to the unassociated access point.

Embodiment 2 is the method of embodiment 1, wherein the timing information is an access point TSF timer of the unassociated access point.

Embodiment 3 is the method of embodiment 2, wherein the timing information is stored as the local timing information.

Embodiment 4 is the method of embodiment 2 or 3, wherein the local timing information is a timer offset value determined according to a difference between the timing information and a sensing receiver TSF timer and the timestamp is determined by combining the sensing receiver TSF timer value with the timer offset value.

Embodiment 5 is the method of any of embodiments 1-4, wherein the unassociated access point is a first unassociated access point, the method further comprising: obtaining, by the sensing receiver, additional timing information from a plurality of additional unassociated access points; and generating, by the sensing receiver, additional local timing information according to the additional timing information.

Embodiment 6 is the method of any of embodiments 1-5, wherein the timing information is received in a beacon frame broadcast by the unassociated access point.

Embodiment 7 is the method of embodiment 6, wherein receiving the sensing transmission further comprises tuning the sensing receiver to a channel on which the beacon frame was received.

Embodiment 8 is the method of embodiment 6 or 7, wherein the sensing receiver is associated with an associated access point operating on the same channel on which the beacon frame was received from the unassociated access point.

Embodiment 9 is the method of embodiment 7 or 8, wherein the method further comprises transmitting an idle message to the associated access point.

Embodiment 10 is the method of any of embodiments 1-9, wherein the method further comprises: transmitting, by the sensing receiver, a probe request; and receiving, by the sensing receiver, a probe response containing the timing information responsive to the probe request.

Embodiment 11 is the method of embodiment 10, wherein the probe request includes at least one access point identification and the probe response includes at least one response from an access point associated with the at least one access point identification.

Embodiment 12 is the method of embodiment 10 or 11, wherein the probe request includes an access point identification wildcard and the probe response includes at least one response from an access point.

Embodiment 13 is the method of any of embodiments 3-12, wherein the local timing information is maintained and incremented at the sensing receiver.

Embodiment 14 is the method of embodiment 13, wherein local timing information is incremented at the sensing receiver according to a local clock.

Embodiment 15 is the method of any of embodiments 1-14, wherein prior to receiving the sensing transmission, the sensing receiver initiates a PASN procedure with the sensing transmitter.

Embodiment 16 is the method of any of embodiments 1-15, wherein the sensing receiver transmits the sensing measurement in response to receiving a sensing report trigger.

Embodiment 17 is the method of any of embodiments 1-16, further comprising resynchronizing the local timing information through receipt of second timing information from the unassociated access point.

Embodiment 18 is the method of embodiment 17, wherein resynchronizing the local timing information is performed after expiration of a resynchronization timer.

Embodiment 19 is the method of embodiment 17 or 18, wherein a time interval of the resynchronization timer is determined according to a measurement of timing drift between the unassociated access point and the sensing receiver.

Embodiment 20 is the method of any of embodiments 1-19, further comprising resynchronizing the local timing information through receipt of a portion of second timing information from the unassociated access point.

Embodiment 21 is a system for Wi-Fi sensing, the system comprising: a networking device configured to operate as a sensing receiver and including at least one processor configured to execute instructions for: obtaining, by the sensing receiver, timing information from an unassociated access point not associated with the sensing receiver and operating as a sensing transmitter; generating, by the sensing receiver, local timing information according to the timing information; receiving, by the sensing receiver, a sensing transmission from the unassociated access point; performing, by the sensing receiver, a sensing measurement on the sensing transmission; associating, by the sensing receiver, the sensing measurement with a timestamp based on the local timing information; and transmitting, by the sensing receiver, the sensing measurement and the timestamp to the unassociated access point.

Embodiment 22 is the system of embodiment 21, wherein the timing information is an access point TSF timer of the unassociated access point.

Embodiment 23 is the system of embodiment 22, wherein the timing information is stored as the local timing information.

Embodiment 24 is the system of embodiment 22 or 23, wherein the local timing information is a timer offset value determined according to a difference between the timing information and a sensing receiver TSF timer and the timestamp is determined by combining the sensing receiver TSF timer value with the timer offset value.

Embodiment 25 is the system of any of embodiments 21-24, wherein the unassociated access point is a first unassociated access point, the system further comprising: obtaining, by the sensing receiver, additional timing information from a plurality of additional unassociated access points; and generating, by the sensing receiver, additional local timing information according to the additional timing information.

Embodiment 26 is the system of any of embodiments 21-25, wherein the timing information is received in a beacon frame broadcast by the unassociated access point.

Embodiment 27 is the system of embodiment 26, wherein receiving the sensing transmission further comprises tuning the sensing receiver to a channel on which the beacon frame was received.

Embodiment 28 is the system of embodiment 26 or 27, wherein the sensing receiver is associated with an associated access point operating on the same channel on which the beacon frame was received from the unassociated access point.

Embodiment 29 is the system of embodiment 27 or 28, wherein the system further comprises transmitting an idle message to the associated access point.

Embodiment 30 is the system of any of embodiments 21-29, wherein the instructions are further configured for: transmitting, by the sensing receiver, a probe request; and receiving, by the sensing receiver, a probe response containing the timing information responsive to the probe request.

Embodiment 31 is the system of embodiment 30, wherein the probe request includes at least one access point identification and the probe response includes at least one response from an access point associated with the at least one access point identification.

Embodiment 32 is the system of embodiment 30 or 31, wherein the probe request includes an access point identification wildcard and the probe response includes at least one response from an access point.

Embodiment 33 is the system of any of embodiments 23-32, wherein the local timing information is maintained and incremented at the sensing receiver.

Embodiment 34 is the system of embodiment 33, wherein local timing information is incremented at the sensing receiver according to a local clock.

Embodiment 35 is the system of any of embodiments 21-34, wherein prior to receiving the sensing transmission, the sensing receiver initiates a PASN procedure with the sensing transmitter.

Embodiment 36 is the system of any of embodiments 21-35, wherein the sensing receiver transmits the sensing measurement in response to receiving a sensing report trigger.

Embodiment 37 is the system of any of embodiments 21-36, further comprising resynchronizing the local timing information through receipt of second timing information from the unassociated access point.

Embodiment 38 is the system of any of embodiments 27-37, wherein resynchronizing the local timing information is performed after expiration of a resynchronization timer.

Embodiment 39 is the system of any of embodiments 27-38, wherein a time interval of the resynchronization timer is determined according to a measurement of timing drift between the unassociated access point and the sensing receiver.

Embodiment 40 is the system of any of embodiments 21-39, further comprising resynchronizing the local timing information through receipt of a portion of second timing information from the unassociated access point.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

1-40. (canceled)

41. A method for Wi-Fi sensing carried out by a sensing receiver and including at least one processor configured to execute instructions, the method comprising:
receiving, by the sensing receiver, timing information from an unassociated access point;
receiving, based on the timing information, by the sensing receiver, a first transmission announcement from the unassociated access point, the first transmission announcement including a timing information update;
receiving, by the sensing receiver, a first sensing transmission following the first transmission announcement,
updating, by the sensing receiver, the timing information based on the timing information update;
receiving, based on the updated timing information, by the sensing receiver, a second transmission announcement from the unassociated access point; and
receiving, by the sensing receiver, a second sensing transmission following the second transmission announcement.

42. The method of claim 41, wherein the timing information is an access point TSF timer of the unassociated access point.

43. The method of claim 32, wherein the timing information update is a timer offset value determined according to a difference between the timing information and a sensing receiver TSF timer.

44. The method of claim 41, wherein the unassociated access point is a first unassociated access point, the method further comprising:
receiving, by the sensing receiver, additional timing informations from a plurality of additional unassociated access points;
obtaining, by the sensing receiver, additional timing information updates from the plurality of additional unassociated access points;
updating, by the sensing receiver, the additional timing informations based on the additional timing information updates;
receiving, based on the additional timing information updates, by the sensing receiver, additional transmission announcements from the plurality of additional unassociated access points; and
receiving, by the sensing receiver, additional sensing transmissions following the additional transmission announcements.

45. The method of claim 41, wherein the timing information is received in a beacon frame broadcast by the unassociated access point.

46. The method of claim 41, wherein the sensing receiver is associated with an associated access point operating on a same channel on which the timing information update was received from the unassociated access point.

47. The method of claim 46, the method further comprising transmitting an idle message to the associated access point.

48. The method of claim 41, further comprising:
transmitting, by the sensing receiver, a probe request; and
receiving, by the sensing receiver, a probe response containing the timing information responsive to the probe request.

49. The method of claim 41, wherein the timing information is maintained and adjusted at the sensing receiver according to a local clock.

50. The method of claim 41, wherein the timing information update includes a portion of second timing information received from the unassociated access point.

51. A system for Wi-Fi sensing comprising:
a sensing receiver including at least one processor configured to execute instructions for:
receiving, by the sensing receiver, timing information from an unassociated access point;
receiving, based on timing information, by the sensing receiver, a first transmission announcement from the unassociated access point, the first transmission announcement including a timing information update;
receiving, by the sensing receiver, a first sensing transmission following the first transmission announcement;
updating, by the sensing receiver, the timing information based on the timing information update;
receiving, based on the updated timing information, by the sensing receiver, a second transmission announcement from the unassociated assess point; and
receiving, by the sensing receiver, a second sensing transmission following the second transmission announcements.

52. The system of claim 51, wherein the timing information is an access point TSF timer of the unassociated access point.

53. The system of claim 52, wherein the timing information is a timer offset value determined according to a difference between the timing information and a sensing receiver TSF timer.

54. The system of claim 51, wherein the unassociated access point is a first unassociated access point, the system being further configured to:
receiving, by the sensing receiver, additional timing informations from a plurality of additional unassociated access points;
obtain, by the sensing receiver, additional timing information updates from the plurality of additional unassociated access points;
update, by the sensing receiver, the additional timing informations based on the additional timing information updates;
receive, based on the additional timing information updates, by the sensing receiver, additional transmission announcements for the additional unassociated access points; and
receive, by the sensing receiver, additional sensing transmissions following the additional transmission announcement.

55. The system of claim 51, wherein the timing information is received in a beacon frame broadcast by the unassociated access point.

56. The system of claim 51, wherein the sensing receiver is associated with an associated access point operating on the same channel on which the timing information update was received from the unassociated access point.

57. The system of claim 56, the system further comprising transmitting an idle message to the associated access point.

58. The system of claim 51, wherein the instructions are further configured for:
transmitting, by the sensing receiver, a probe request; and
receiving, by the sensing receiver, a probe response containing the timing information responsive to the probe request.

59. The system of claim 51, wherein the timing information is maintained and adjusted at the sensing receiver according to a local clock.

60. The system of claim 51, wherein the timing information update includes a portion of second timing information received from the unassociated access point.
